(19) United States
(12) Patent Application Publication
(10) Pub. No.: US 2025/0245241 A1
(43) Pub. Date: Jul. 31, 2025

(54) METHODS FOR VISUAL DATA ANALYSIS AND INTERACTION

(71) Applicant: HANGZHOU TONGHUASHUN DATA PROCESSING CO., LTD., Hangzhou (CN)

(72) Inventors: Yujia ZHU, Hangzhou (CN); Xin MA, Hangzhou (CN); Tong LIU, Hangzhou (CN); Hao QIAN, Hangzhou (CN); Hangsheng WU, Hangzhou (CN); Luming TANG, Hangzhou (CN)

(73) Assignee: HANGZHOU TONGHUASHUN DATA PROCESSING CO., LTD., Hangzhou (CN)

(21) Appl. No.: 19/001,391

(22) Filed: Dec. 24, 2024

(30) Foreign Application Priority Data
Jan. 30, 2024 (CN) 202410127647.4
Jan. 30, 2024 (CN) 202410129716.5

(51) Int. Cl. G06F 16/26; G06F 16/901

(52) U.S. Cl. CPC G06F 16/26; G06F 16/9024

(57) ABSTRACT

The present disclosure may provide a method and a system for visual data analysis and interaction. The method includes: displaying a visualization region in a user interface, the visualization region including a set of data; generating a data graph based on the set of data; in response to receiving a first operation instruction from a user, obtaining a data processing result by processing at least a portion of the set of data based on the data graph; and in response to receiving a second operation instruction from the user, displaying the data processing result and updating a display state of the visualization region.

### CROSS-REFERENCE RELATED TO APPLICATION

This application claims priority to Chinese application No. 202410129716.5, filed on Jan. 30, 2024, and priority to Chinese application No. 202410127647.4, filed on Jan. 30, 2024, the entire contents of each of which are incorporated herein by reference.

### TECHNICAL FIELD

The present disclosure relates to the field of data analysis, and in particular, to a method for visual data analysis and interaction.

### BACKGROUND

With the development and popularization of information technology, people's work and life may be inundated with massive data. By effectively analyzing and interpreting data, valuable information can be extracted, providing significant assistance to an organization, an enterprise, and even individuals, e.g., optimizing business processes, enhancing work efficiency, and understanding market trends.

Data analysis may involve distilling features of data to help users identify correlations or patterns within the data. Data analysis may often focus on data statistics, to determine statistical information, such as maximum, minimum, and/or average values. However, the statistical information may be typically displayed at the top or bottom of a data page. When dealing with a large amount of data, relying solely on this statistical information may not be intuitive enough for users to grasp the overall situation of the data. For example, when analyzing data in a table, a common approach may be to add or replace rows at the top or bottom of the table to display the relevant analysis results. Furthermore, data analysis may usually only apply to numerical data and cannot analyze textual information.

Therefore, it may be desired to provide a method for visual data analysis and interaction that can provide more information reflecting the overall situation of the data, and improve the efficiency of the user in reading and understanding the data.

### SUMMARY

One or more embodiments of embodiments of the present disclosure provide a method for visual data analysis and interaction. The method may include: displaying a visualization region in a user interface, the visualization region including a set of data; generating a data graph based on the set of data; in response to receiving a first operation instruction from a user, obtaining a data processing result by processing at least a portion of the set of data based on the data graph; and in response to receiving a second operation instruction from the user, displaying the data processing result and updating a display state of the visualization region.

One or more embodiments of embodiments of the present disclosure provide a system for visual data analysis and interaction. The system may include: a storage device storing a set of instructions; and at least one processor configured to communicate with the storage device. When executing the set of instructions, the at least one processor may be configured to: display a visualization region in a user interface, the visualization region including a set of data; generate a data graph based on the set of data; in response to receiving a first operation instruction from a user, obtain a data processing result by processing at least a portion of the set of data based on the data graph; and in response to receiving a second operation instruction from the user, display the data processing result and updating a display state of the visualization region.

One or more embodiments of embodiments of the present disclosure provide a non-transitory computer-readable storage medium storing computer instructions. When reading the computer instructions in the storage medium, a computer may be configured to: display a visualization region in a user interface, the visualization region including a set of data; generate a data graph based on the set of data; in response to receiving a first operation instruction from a user, obtain a data processing result by processing at least a portion of the set of data based on the data graph; and in response to receiving a second operation instruction from the user, display the data processing result and updating a display state of the visualization region.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is an exemplary schematic diagram illustrating an application scenario of a system for visual data analysis and interaction according to some embodiments of the present disclosure;

FIG. 2 is a flowchart illustrating an exemplary process for visual data analysis and interaction according to some embodiments of the present disclosure;

FIG. 3 is a flowchart illustrating an exemplary process for visual data analysis according to some embodiments of the present disclosure;

FIG. 4 is a schematic diagram illustrating an exemplary user interface according to some embodiments of the present disclosure;

FIG. 5 is a schematic diagram illustrating an exemplary sub-hot zone according to some embodiments of the present disclosure;

FIG. 6A is a schematic diagram illustrating an exemplary numerical mapping graph in a first state according to some embodiments of the present disclosure;

FIG. 6B is a schematic diagram illustrating an exemplary numerical mapping graph in a second state according to some embodiments of the present disclosure;

FIG. 7A is a schematic diagram illustrating an exemplary textual mapping graph in a first state according to some embodiments of the present disclosure;

FIG. 7B is a schematic diagram illustrating an exemplary textual mapping graph in a second state according to some embodiments of the present disclosure;

FIG. 8A is a schematic illustration illustrating an exemplary position distribution of mapping segments according to some embodiments of the present disclosure;

FIG. 8B is a schematic illustration illustrating another exemplary position distribution of mapping segments according to some embodiments of the present disclosure;

FIG. 9 is a flowchart illustrating an exemplary process for displaying a data analysis result according to some embodiments of the present disclosure;

FIG. 10 is an exemplary schematic diagram illustrating a highlighted display of first target data according to some embodiments of the present disclosure;

FIG. 11 is an exemplary schematic diagram illustrating a plurality of data analysis results according to some embodiments of the present disclosure;

FIG. 12 is a schematic diagram illustrating an exemplary process for displaying intersection data according to some embodiments of the present disclosure;

FIG. 13 is a flowchart illustrating an exemplary process for displaying a data analysis result of first target data according to some embodiments of the present disclosure;

FIG. 14 is a schematic diagram illustrating an exemplary suspended display according to some embodiments of the present disclosure;

FIG. 15 is a schematic diagram illustrating an exemplary target data block according to some embodiments of the present disclosure;

FIG. 16 is a flowchart illustrating an exemplary process for visual data interaction according to some embodiments of the present disclosure;

FIG. 17 is a schematic diagram illustrating an exemplary first region and an exemplary second region according to some embodiments of the present disclosure;

FIG. 18 is a schematic diagram illustrating an exemplary time distribution graph according to some embodiments of the present disclosure;

FIG. 19 is a schematic diagram illustrating an exemplary text proportion graph according to some embodiments of the present disclosure;

FIG. 20 is a schematic diagram illustrating an exemplary numerical distribution graph according to some embodiments of the present disclosure;

FIG. 21 is a schematic diagram illustrating an exemplary placeholder graph according to some embodiments of the present disclosure;

FIG. 22A is a schematic diagram illustrating an exemplary process for displaying a data probing result of a second operation instruction according to some embodiments of the present disclosure;

FIG. 22B is a schematic diagram illustrating another exemplary process for displaying a data probing result of a second operation instruction according to some embodiments of the present disclosure;

FIG. 23A is an exemplary schematic diagram illustrating target data in a first region according to some embodiments of the present disclosure;

FIG. 23B is a schematic diagram illustrating an exemplary process for triggering a hide control to adjust a display state of a first region according to some embodiments shown in the present disclosure;

FIG. 24A is a schematic diagram illustrating an exemplary second region according to some embodiments of the present disclosure;

FIG. 24B is a schematic diagram illustrating an exemplary process for adjusting a display order of a second region according to some embodiments of the present disclosure;

FIG. 25 is a schematic diagram illustrating an exemplary range control strip according to some embodiments of the present disclosure;

FIG. 26 is a schematic diagram illustrating an exemplary preset control marker according to some embodiments of the present disclosure;

FIG. 27A is a schematic diagram illustrating an exemplary process for updating a display state of another region of a second region and a first region according to some embodiments of the present disclosure;

FIG. 27B is a schematic diagram illustrating another exemplary process for updating a display state of another region of a second region and a first region according to some embodiments of the present disclosure;

FIG. 28 is a schematic diagram illustrating an exemplary graph recommendation model according to some embodiments of the present disclosure;

FIG. 29 is a schematic diagram illustrating an exemplary part tree graph according to some embodiments of the present disclosure;

FIG. 30 is a schematic illustration illustrating an exemplary process for displaying mark information of an outlier according to some embodiments of the present disclosure;

FIG. 31 is a schematic diagram illustrating an exemplary process for displaying a reference result according to some embodiments of the present disclosure;

FIG. 32 is a schematic diagram illustrating an exemplary preset icon according to some embodiments of the present disclosure;

FIG. 33 is a schematic diagram illustrating an exemplary analysis pop-up window according to some embodiments of the present disclosure; and

FIG. 34 is an exemplary block diagram illustrating a system for visual data analysis and interaction according to some embodiments of the present disclosure.

### DETAILED DESCRIPTION

The technical solutions of the present disclosure embodiments will be more clearly described below, and the accompanying drawings need to be configured in the description of the embodiments will be briefly described below. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system”, “device”, “unit”, and/or “module” used herein are one method to distinguish different components, elements, parts, sections, or assemblies of different levels in ascending order. However, the terms may be displaced by other expressions if they may achieve the same purpose

As shown in the present disclosure and claims, unless the context clearly prompts the exception, “a”, “one”, and/or “the” is not specifically singular, and the plural may be included. It will be further understood that the terms “comprise,” “comprises,” and/or “comprising,” “include,” “includes,” and/or “including,” when used in the present disclosure, specify the presence of stated operations and elements, but do not preclude the presence or addition of one or more other operations and elements thereof.

The flowcharts are used in present disclosure to illustrate the operations performed by the system according to the embodiment of the present disclosure. It should be understood that the front or rear operation is not necessarily performed in order to accurately. Instead, the operations may be processed in reverse order or simultaneously. Moreover, one or more other operations may be added to the flowcharts. One or more operations may be removed from the flowcharts.

The traditional method of data analysis tends to be rather simplistic and rigid when presenting data analysis results. For a large amount of data, users may find it difficult to quickly and conveniently access the target information when probing the data. In order to better obtain the target information, users often need to utilize the auxiliary functions provided by data analysis tools to further probe the data. However, the probing results need to be presented in a new display region or page, lacking interactive between data, making it inconvenient to view and understand. Additionally, some users may struggle to familiarize themselves with the use of data analysis tools, significantly reducing the accuracy and efficiency of data analysis. For example, in table-based data analysis, displaying statistical information related to the table typically involves adding (or replacing) rows at the top or bottom of the table to present the information. When faced with a large amount of tabular data, users often require this type of functionality to assist in understanding the relevant features of the data in the table. Simply displaying numerical information may not be intuitive enough when dealing with the large amount of tabular data, and users may find it challenging to grasp the overall data situation of the columns based only on average, median, maximum, and minimum values.

In come embodiments of the present disclosure, by receiving a first operation instruction from the user, processing the set of data to obtain a data processing result, and updating the display state of the visualization region by receiving a second operation instruction from the user, the user can quickly grasp the data processing results of the set of data. Furthermore, the user can interactively access and analyze related data by linking the set of data with the visualization region, thereby enhancing the efficiency of the user in reading and understanding tabular data.

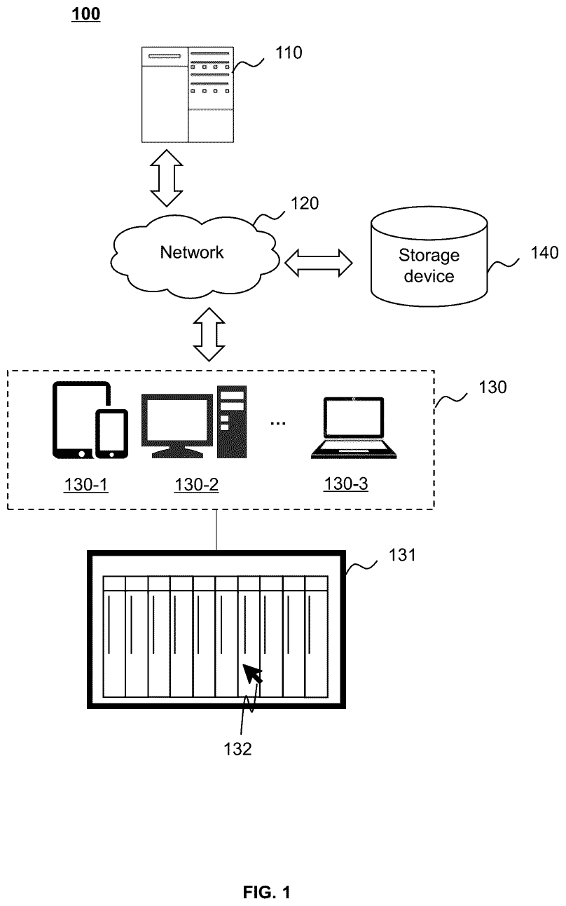

FIG. 1 is an exemplary schematic diagram illustrating an application scenario of a system for visual data analysis and interaction according to some embodiments of the present disclosure.

In some embodiments, the system for visual data analysis and interaction may be applied to various data analysis task scenarios and/or any scenarios where processing with a large amount of data is required. For example, the scenarios may include enterprise operation data analysis, financial industry data analysis, health data analysis in the medical field, or the like. As another example, the scenarios may include a bank, a company, a school, etc.

In some embodiments, various types of scenario data may be probed and/or analyzed in an application scenario 100 of the system for visual data analysis and interaction by implementing the method and/or processes disclosed herein to obtain a corresponding data processing result.

As shown in FIG. 1, in some embodiments, the application scenario 100 of the system for visual data analysis and interaction may include a processor 110, a network 120, a user terminal 130, a storage device 140, etc.

The processor 110 may be configured to process information and/or data related to the application scenario 100 of the system for visual data analysis and interaction. In some embodiments, the processor 110 may process data, information, and/or a processing result from at least one module of the system for visual data analysis and interaction and/or an external data source (e.g., a cloud data center, etc.), and execute program instructions based on the data, the information, and/or the processing result to perform one or more functions described in the present disclosure. For example, the processor 110 may display a visualization region in a user interface, the visualization region including a set of data; generate a data graph based on the set of data; in response to receiving a first operation instruction from a user, obtain a data processing result by processing at least a portion of the set of data based on the data graph; and in response to receiving a second operation instruction from the user, display the data processing result and update a display state of the visualization region.

In some embodiments, the processor 110 may include a central processing unit (CPU), an application-specific integrated circuit (ASIC), an application-specific instruction set processor (ASIP), a microprocessor, etc., or any combination thereof. In some embodiments, the processor 110 may be a single server or a server group. The server group may be centralized or distributed. In some embodiments, the processor 110 may be local or remote. In some embodiments, the processor 110 may be integrated into the user terminal 130.

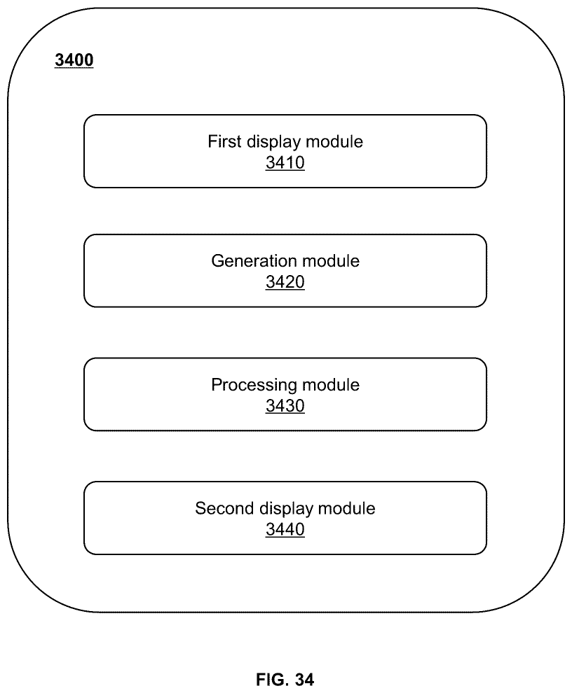

In some embodiments, the processor 110 may be an integral part of the system for visual data analysis and interaction, and may include a first display module, a generation module, a processing module, a second display module, etc. More descriptions regarding the first display module, the generation module, the processing module, and the second display module may be found in FIG. 34 and relevant descriptions thereof.

The network 120 may include any suitable network capable of facilitating an exchange of information and/or data for the application scenario 100 of the system for visual data analysis and interaction. In some embodiments, one or more components (e.g., the processor 110, the user terminal 130, the storage device 140, etc.) of the application scenario 100 of the system for visual data analysis and interaction may exchange information and/or data with each other through the network 120. In some embodiments, the network 120 may include any one or more of any form of wired or wireless network. In some embodiments, the network 120 may include one or more network access points.

The user terminal 130 refers to one or more terminal devices or software used by a user. The user refers to an operator or administrator of the system for visual data analysis and interaction, etc. In some embodiments, the user terminal 130 may interact with other components (e.g., the processor 110, etc.) in the application scenario 100 of the system for visual data analysis and interaction via the network 120. For example, the user terminal 130 may send a first operation instruction used for obtaining a data processing result and/or a second operation instruction used for displaying the data processing result and updating a display state of the visualization region to the processor 110 via the network 120.

In some embodiments, the user terminal 130 may include a mobile device 130-1, a computer 130-2, a laptop 130-3, etc., or any combination thereof.

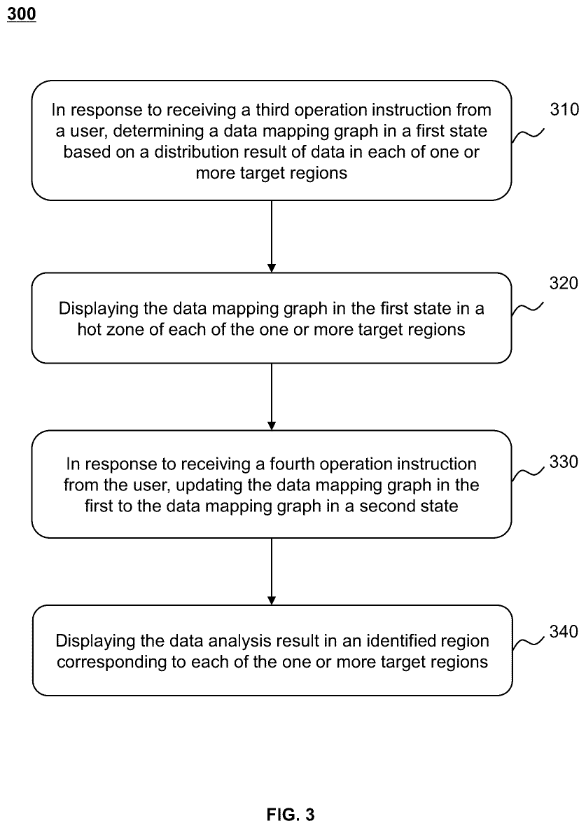

In some embodiments, the user terminal 130 may include a display component (e.g., a display screen, etc.), an interaction component (e.g., a mouse, a keyboard, a touch screen, etc.), or the like. As shown in FIG. 1, the display component may be used to display a user interface 131. The interaction component may send one or more instructions (e.g., the first operation instruction, the second operation instruction, etc.) to the processor 110 via a mouse cursor 132, etc., on the user interface 131. The processor may process the set of data based on the data graph to obtain and display the data processing result and update the display state of the visualization region based on the received instructions. In some embodiments, the processor may recognize an operation mode of the first operation instruction and/or the second operation instruction, determine different display modes (e.g., first state display, highlighted display, simultaneous display, interactive display, etc.) and determine whether to switch a display state of a target object corresponding to the first operation instruction and/or the second operation instruction. In some embodiments, the processor may recognize data corresponding to the first operation instruction and/or the second operation instruction, and display a data processing result corresponding to the data corresponding to the first operation instruction and/or the second operation instruction in the user interface. More descriptions may be found in FIG. 3 and relevant descriptions thereof.

The storage device 140 may store data (e.g., history operations of the user and history display states at different times, a data states saved by the user at a specific moment, a data states saved by default by the system, etc.), instructions, and/or any other information. In some embodiments, the storage device 140 may store information and/or data obtained from other components (e.g., the processor 110 and/or the user terminal 130) of the application scenario 100 of the system for visual data analysis and interaction or from the external data source. In some embodiments, the storage device 140 may store data and/or instructions that the processor 110 may execute and/or use to perform exemplary methods described in the present disclosure.

In some embodiments, the storage device 140 may include a large capacity storage, a removable memory, etc., or any combination thereof. In some embodiments, the storage device 140 may be integrated in the processor 110 and/or the user terminal 130. In some embodiments, the storage device 140 and the processor 110 may be integrated in the user terminal 130 as a portion of the user terminal 130.

It should be noted that the application scenario 100 of the system for visual data analysis and interaction is provided only for illustrative purposes, and may be not intended to limit the scope of the present disclosure. For those skilled in the art, a variety of modifications or variations may be made in accordance with the descriptions herein. For example, the application scenario 100 of the system for visual data analysis and interaction may implement similar or different functions on other devices. However, these variations and modifications do not depart from the scope of the present disclosure.

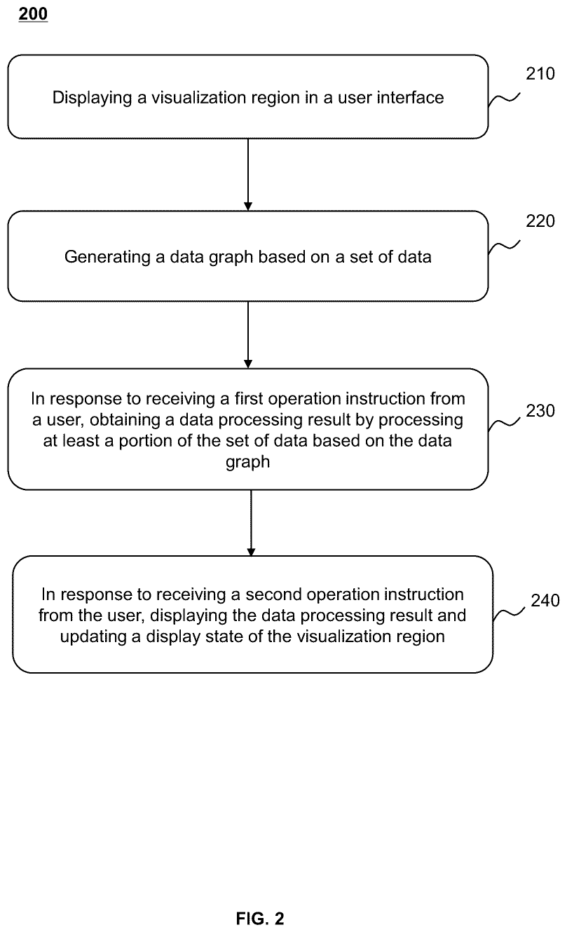

FIG. 2 is a flowchart illustrating an exemplary process for visual data analysis and interaction according to some embodiments of the present disclosure. In some embodiments, process 200 may be performed by a processor (e.g., the processor 110) or the system for visual data analysis and interaction and modules thereof. As shown in FIG. 2, the process 200 may include following operations.

In 210, a visualization region may be displayed in a user interface.

The user interface refers to an interface of a display component displayed on a user terminal configured to facilitate a communication or interaction between a user and the system for visual data analysis and interaction. More descriptions regarding the user interface and the display component may be found in FIG. 1 and related descriptions thereof.

The visualization region refers to a region in the user interface used for visual data analysis and/or interaction. In some embodiments, the visualization region may include a set of data.

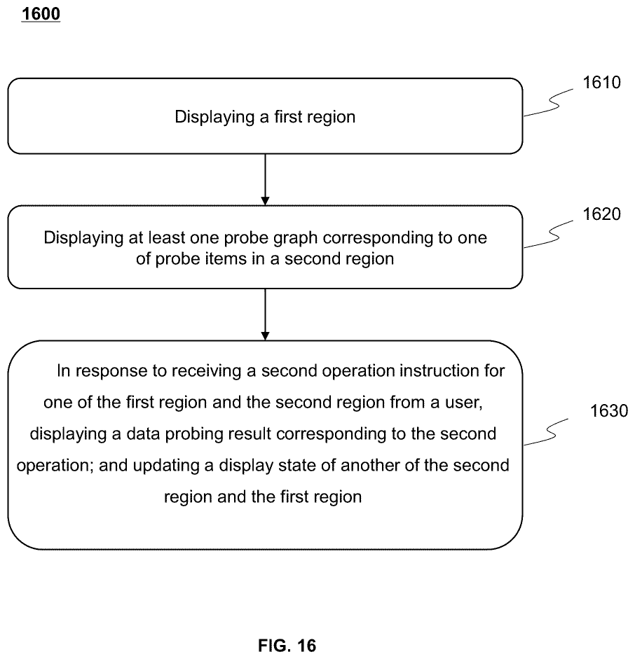

The set of data may include data that requires analysis and/or interaction. In some embodiments, the set of data may include data to be analyzed and/or data to be probed. More descriptions regarding the set of data may be found in FIG. 3, FIG. 16, and related descriptions thereof.

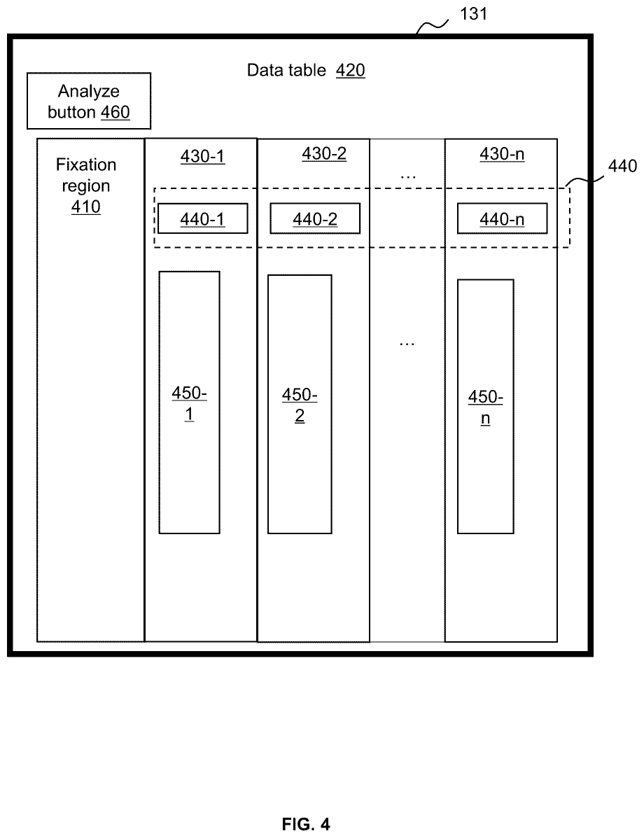

In some embodiments, the visualization region may include one or more target regions. The target regions may include a portion or all of the set of data within the visualization region. More descriptions regarding the target regions may be found in FIG. 3, FIG. 4, and related descriptions thereof.

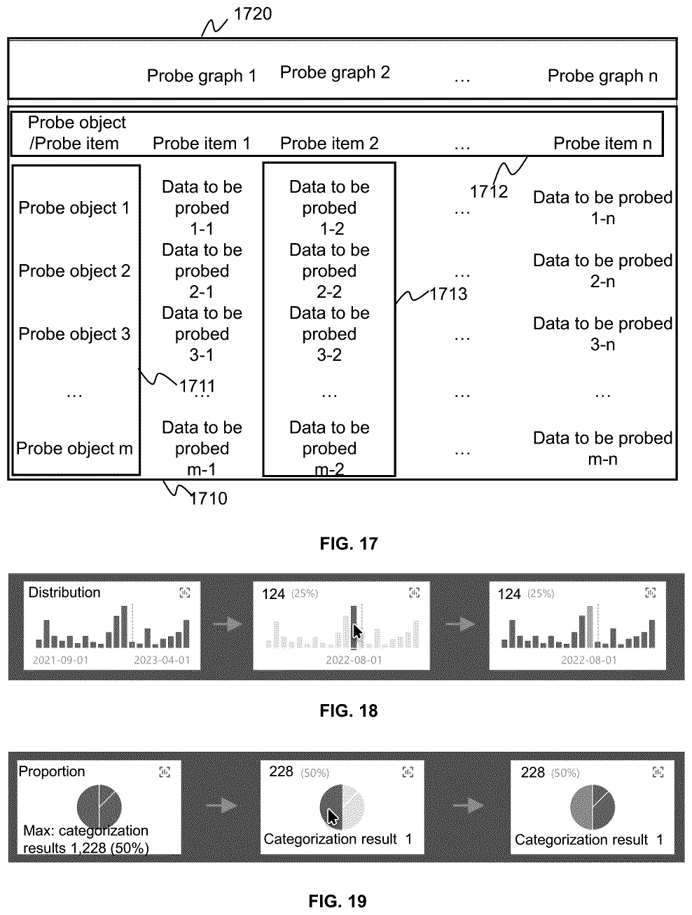

In some embodiments, the visualization region may include a first region and a second region. The first region may be a region that displays a specific data text of the data to be probed, and the second region may be a region in the user interface that displays a probe graph. More descriptions regarding the target regions may be found in FIG. 16 and FIG. 17, and related descriptions thereof.

In some embodiments, the processor may display the visualization region in the user interface. A display position of the visualization region may be set according to actual needs. In 220, a data graph may be generated based on the set of data.

The data graph refers to a graph structure related to the set of data. The data graph may reflect a distribution result and/or a probing result of the set of data.

In some embodiments, the data graph may include a data mapping graph. More descriptions of the data mapping graph may be found in FIG. 3 and related descriptions thereof.

In some embodiments, the data graph may include a probe graph. More descriptions of the probe graph may be found in FIG. 16 and FIG. 17, and related descriptions thereof.

In some embodiments, the data graph may include the probe graph and the data mapping graph.

In some embodiments, the processor may generate the data graph based on the set of data. For example, the processor may generate the data graph based on the set of data using a data analysis tool. Exemplarily, the data analysis tool may include inserting a pivot table, a pivot chart, or the like.

In some embodiments, in response to receiving a third operation instruction from the user, the processor may determine the data mapping graph in a first state based on a distribution result of data in each of the one or more target regions; display the data mapping graph in the first state in a hot zone of each of the one or more target regions; and in response to receiving a fourth operation instruction from the user, update the data mapping graph in the first state to the data mapping graph in a second state. The data in each of the one or more target regions may be a portion of the set of data, e.g., the data to be analyzed.

In 230, in response to receiving a first operation instruction from the user, a data processing result may be obtained by processing at least a portion of the set of data based on the data graph.

The first operation instruction refers to a trigger instruction for obtaining the data processing result inputted by the user. In some embodiments, the user may generate the first operation instruction in various ways. For example, the user may generate the first operation instruction by voice input. As another example, the user may generate the first operation instruction by clicking on a data processing button. The data processing button refers to a button used for the user to interact with the user interface to issue the first operation instruction. The position of the data processing button may be preset based on the system or by a human.

The data processing result refers to a processing result of a portion of the set of data corresponding to the first operation instruction. In some embodiments, the data processing result may include a data analysis result. Data analysis refers to a process for analyzing data based on the data mapping graph. The data analysis result may include an analysis result related to features of the data to be analyzed, e.g., a maximum value, a minimum value, etc., of the data to be analyzed. In some embodiments, the data processing result may include a data probing result. Data probing refers to a process for viewing data based on the probe graph. The data probing result may include a probing result of the data to be probed, e.g., a categorization of the data to be probed, a count of categorizations, or the like. In some embodiments, the data processing result may include the data analysis result and the data probing result.

In some embodiments, the processor may process the set of data based on the data graph to obtain the data processing result. For example, the processor may designate a distribution result and/or a probing result, etc., of the set of data as the data processing result based on the data graph. The processor may designate a distribution result of the data to be analyzed as the data processing result based on the data mapping graph or designate a probing result of the data to be probed as the data processing result based on the probe graph. More descriptions regarding the data analysis result may be found in FIG. 3 and related descriptions thereof. More descriptions regarding the data probing result may be found in FIG. 16 and related descriptions thereof.

In 240, in response to receiving a second operation instruction from the user, the data processing result may be displayed, and a display state of the visualization region may be updated.

The second operation instruction may be an instruction generated based on an operation of the user in the visualization region. For example, the second operation instruction may include an instruction generated by an operation of the user, e.g., clicking on a preset position, etc., in the visualization region. The preset position may be pre-set based on a user requirement. In some embodiments, the second operation instruction may be used to display the data processing result and update the display state of the visualization region. More descriptions regarding the second operation instruction may be found in FIG. 16 and related descriptions thereof.

The process for updating the display state of the visualization region may include receiving the second operation instruction from the user for one of the second region and the first region, displaying the data probing result, and updating a display state of another of the second region and the first region.

In some embodiments, the processor may display the data processing result corresponding to the second operation instruction at the preset position. The preset position may be set by the system or by the user or an operator of the system.

In some embodiments, the processor may update the display state of the visualization region based on the second operation instruction. For example, the processor may update the display state of the data processing result corresponding to the second operation instruction to be highlighted display, etc.

In some embodiments of the present disclosure, by generating the data graph based on the set of data, and in response to receiving the first operation instruction, processing the set of data based on the data graph to obtain the data processing result; and in response to receiving the second operation instruction, displaying the data processing result and updating the display state of the visualization region, the user can intuitively understand a relevant situation of the set of data, thereby improving efficiency of reading and understanding of the data.

FIG. 3 is a flowchart illustrating an exemplary process for visual data analysis according to some embodiments of the present disclosure.

In 310, in response to receiving a third operation instruction from a user, a data mapping graph in a first state may be determined based on a distribution result of data in each of one or more target regions. More descriptions regarding the user may be found in FIG. 1 and related descriptions thereof.

The one or more target regions may be a portion or all of regions where one or more sets of data displayed by the user interface is located. In some embodiments, the one or more sets of data displayed by the user interface may be tabular data, and the one or more target regions may be a portion of regions in a data table corresponding to the tabular data. For example, the target regions may be a column or row in the data table. The tabular data may include a plurality of analysis objects and a plurality of analysis items corresponding to each of the plurality of analysis objects. An analysis item refers to a analytic content for an analysis object. Different analysis items may correspond to different analytic contents. For a certain analysis item, the target regions may be regions (e.g., rows or columns corresponding to the analysis item) in which data of each of the analysis objects is located. For example, the analysis objects and the analysis items may be located in a column header or a row header of the data table, respectively. As a further example, when the user interface displays tabular data including a company profile, the analysis objects may be different companies (which may be indicated by different company names, etc.), the analysis items may be analysis contents (e.g., registered capital, a time of establishment, etc.) for each of the companies, and the target regions may be columns corresponding to the registered capital of each of the companies.

FIG. 4 is a schematic diagram illustrating an exemplary user interface according to some embodiments of the present disclosure. In some embodiments, for tabular data, a target region may be a column in the table. As shown in FIG. 4, a data table 420 includes n columns, and at least one target region (e.g., a target region 430-1, a target region 430-2, etc.) corresponds one-to-one with at least one column in the data table 420. Each of the at least one target region corresponds to one of the at least one column in the data table 420. For example, the target region 430-1 and the target region 430-2 may correspond to a first column and a second column in the data table 420, respectively. As another example, a target region 430-n may correspond to a n-th column in the data table 420.

In some embodiments, each of the one or more target regions may include an identified region 440, a hot zone, etc. More contents may be found in related descriptions below FIG. 3.

In some embodiments, the identified region, the hot zone, and the target region may correspond one-to-one. For example, an identified region 440-1 and a hot zone 450-1 may correspond to the target region 430-1; an identified region 440-2 and a hot zone 450-2 may correspond to the target region 430-2; and an identified region 440-n and a hot zone 450-n may correspond to the target region 430-n.

In some embodiments, the processor may display at least one target region in the user interface. A display position of the at least one target region may be set based on actual needs. The at least one target region may be a portion of a region in the data table 420 (e.g., at least one column in the data table 420).

In some embodiments, in response to receiving the third operation instruction from the user, for each target region, the processor may display a different data mapping graph and a data analysis result. The specific process may be explained through following operations 320-330.

The third operation instruction refers to an instruction for triggering analysis of the data to be analyzed. In some embodiments, the third operation instruction may include a user-initiated instruction for triggering the analysis of the data to be analyzed in each of the one or more target regions. The data to be analyzed refers to data to be analyzed in each of the one or more target regions. In some embodiments, when the target region is a portion of a region in the data table, the data to be analyzed may be data included in the target region in the data table. For example, the data to be analyzed may be data in each cell in a column or row corresponding to the target region. Different target regions may correspond to different data to be analyzed. For example, data corresponding to an analysis item 1 for each company may be data to be analyzed in a target region, and data corresponding to an analysis item 2 for each company may be data to be analyzed in another target region.

In some embodiments, a type of the data to be analyzed may include text, a numeric value, or the like. In some embodiments, the user may generate the third operation instruction by interacting with a user terminal. For example, the user may click on an analyze button 460 in the user interface to generate the third operation instruction. As another example, the user may generate the third operation instruction via voice input, etc. The analyze button 460 refers to a button used for the user to interact with the user interface to issue the third operation instruction. In some embodiments, the analyze button 460 may be located anywhere in the user interface, e.g., the analyze button may be located at the upper left of the user interface, etc.

The data mapping graph refers to a graph reflecting a distribution result of the data to be analyzed in each of the one or more target regions. In some embodiments, when the data to be analyzed in a target region is numerical data, the data mapping graph may be a numerical mapping graph. When the data to be analyzed in the target region is text data, the data mapping graph may be a textual mapping graph. In some embodiments, the numerical mapping graph may include a box plot, and the textual mapping graph may include a textual categorization graph. More descriptions regarding the numerical mapping graph and the textual mapping graph may be found in related descriptions below.

In some embodiments, the distribution result may include a first distribution result and/or a second distribution result. The first distribution result may correspond to the data mapping graph and include a position of each piece of the data to be analyzed after being arranged in a preset arrangement. For example, the preset arrangement may include arranging from largest to smallest, etc. The second distribution result may correspond to the textual mapping graph and include a proportion of each type of data to be analyzed in all data to be analyzed.

In some embodiments, the processor may determine the data mapping graph in the first state based on the distribution result of the data to be analyzed through data processing. For example, the data mapping graph may be made by, e.g., data processing software, based on the distribution result of the data to be analyzed in the target region. For example, the data processing software may include at least one of Google Sheets, Plotly, Highcharts, or the like. A state of the data mapping graph refers to a state of the data mapping graph under different operation instructions.

The first state refers to a state of the data mapping graph under the third operation instruction. In some embodiments, the first state may be a default state of the data mapping graph.

In 320, the data mapping graph in the first state may be displayed in a hot zone of each of the one or more target regions.

In some embodiments, the hot zone refers to an area in each of the one or more target regions for displaying the data mapping graph. The position of the hot zone may be set according to actual needs. In some embodiments, the hot zone may be located at a fixed position within the target region. For example, the hot zone may be located at a left position and/or a top position within the target region, etc.

In some embodiments, in response to receiving the third operation instruction from the user (e.g., the user clicking the analyze button in the user interface, etc.), the hot zone of each of the one or more target regions may display the data mapping graph in the first state.

In some embodiments, the processor may determine whether a count of a plurality of pieces of the data to be analyzed is less than a threshold, and in response to a determination that the count of the plurality of pieces of the data to be analyzed is less than the threshold, determine that the hot zone includes a plurality of sub-hot zones dispersed in the target region. In some embodiments, in response to a determination that the count of the plurality of pieces of the data to be analyzed is greater than the threshold, the processor may determine that the hot zone is a centralized region located in the target region.

The threshold may be set in advance according to actual requirements, for example, the threshold may be 10, 9, 8, etc. The count of the plurality of pieces of data to be analyzed may be a count of a plurality of pieces of data to be analyzed in the target region. Meanwhile, a plurality of data mapping graphs may also be referred as to the plurality of data mapping sub-graphs.

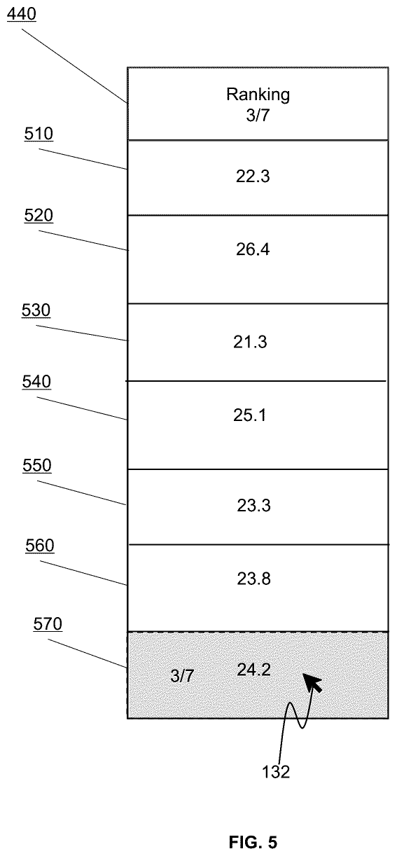

The sub-hot zone refers to an area used to display a certain data mapping sub-graph. The plurality of data mapping sub-graphs may correspond to the plurality of sub-hot zones. The data mapping sub-graph may be used to display a data analysis result (e.g., a ranking or proportion, etc.) for a portion of the data to be analyzed (e.g., a particular piece of data to be analyzed) in each of the one or more target regions. In some embodiments, the plurality of sub-hot zones may be dispersed in the target region in an area where the plurality of pieces of the data to be analyzed are located. For example, in each of the one or more target regions, an area where each of the plurality of pieces of the data to be analyzed is located may correspond to each of the plurality of sub-hot zones. FIG. 5 is a schematic diagram illustrating an exemplary sub-hot zone according to some embodiments of the present disclosure. As shown in FIG. 5, a count (i.e., 7) of a plurality of pieces of data to be analyzed in a target region is less than a threshold (i.e., 10), and the plurality of sub-hot zones are dispersed in the target region in an area where the plurality of pieces of the data to be analyzed are located. For example, a sub-hot zone 510, a sub-hot zone 520, a sub-hot zone 530, a sub-hot zone 540, a sub-hot zone 550, a sub-hot zone 560, and a sub-hot zone 570 are dispersed in areas where data to be analyzed 22.3, 26, 4, 21.3, 25.1, 23.3, 23.8, and 24.2 are located, respectively.

As shown in FIG. 5, in response to the cursor 132 hovering over the sub-hot zone 570, the sub-hot zone 570 and the identified region 440 may display a ranking (e.g., 3/7) of the data to be analyzed of 24.2 corresponding to the sub-hot zone 570 among all the data to be analyzed in the target region. As shown in FIG. 5, when the cursor 132 hovers over the sub-hot zone 570, the sub-hot zone 570 may also be displayed by highlighting.

The centralized region means that the hot zone is located in the target region as a whole region, instead of being dispersed in different positions of the target region. At this point, there may be one data mapping graph in the hot zone. As mentioned earlier, at this point the hot zone may be located at a fixed position in the target region (e.g., the top position, etc.).

In some embodiments of the present disclosure, when an amount of the data to be analyzed is relatively small, the plurality of sub-hot zones may be dispersed in the target region in an area where the plurality of pieces of the data to be analyzed are located, and the user may view a data analysis result of the data to be analyzed corresponding to the sub-hot zone by hovering the cursor over the sub-hot zone, which makes it easy for the user to view the data analysis result simply and intuitively.

The data mapping graph in the first state refers to a system default data mapping graph. In some embodiments, the data mapping graph in the first state may be a graph displaying a data concentration distribution in the data distribution result of the data to be analyzed. In some embodiments, the data mapping graph in the first state may include a numerical mapping graph in the first state, a textual mapping graph in the first state, or the like.

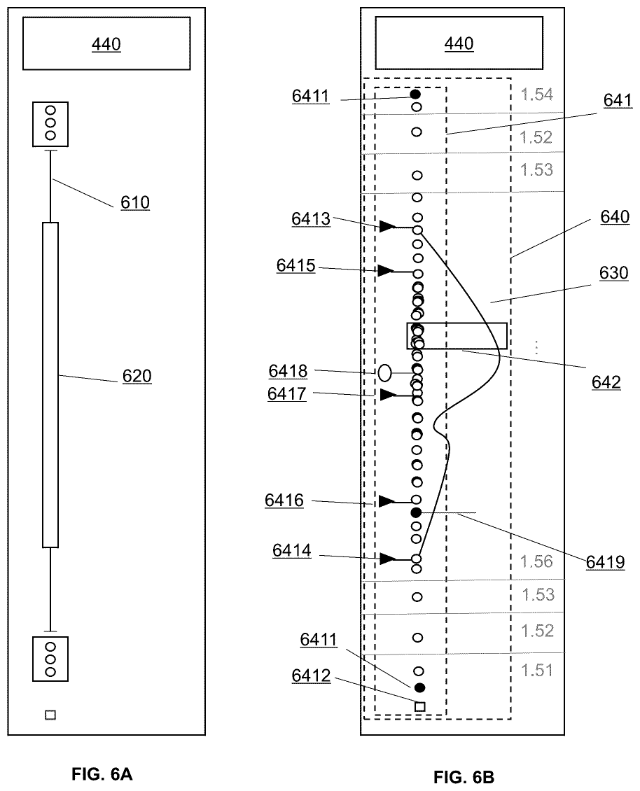

FIG. 6A is a schematic diagram illustrating an exemplary numerical mapping graph in a first state according to some embodiments of the present disclosure. As shown in FIG. 6A, a numerical mapping graph in a first state may be a box plot with a column. The box plot includes a box body 620, and lines at the two ends of the box body 620 denote box lines 610, and the two ends of the box lines 610 reflect maximum and minimum values in the data to be analyzed, respectively. In some embodiments, in different target regions, positions of maximum and minimum values of the data to be analyzed and lengths of box plots may be the same. The box body 620 may reflect a portion of data to be analyzed in a target region, and a size of the box body 620 may reflect a proportion of the portion of the data to be analyzed in the target region in all the data to be analyzed. For example, the larger the proportion, the larger the box body, and conversely, the smaller the box body. In some embodiments, a distribution of a box body (also referred to as a box body distribution) in the box plot may reflect a concentration position of the data to be analyzed in the first distribution result. The box body distribution may be a position of the box body in the box plot. For example, the closer a box body of the box plot is to the maximum value, the more concentrated the data to be analyzed in the target region is at the top position.

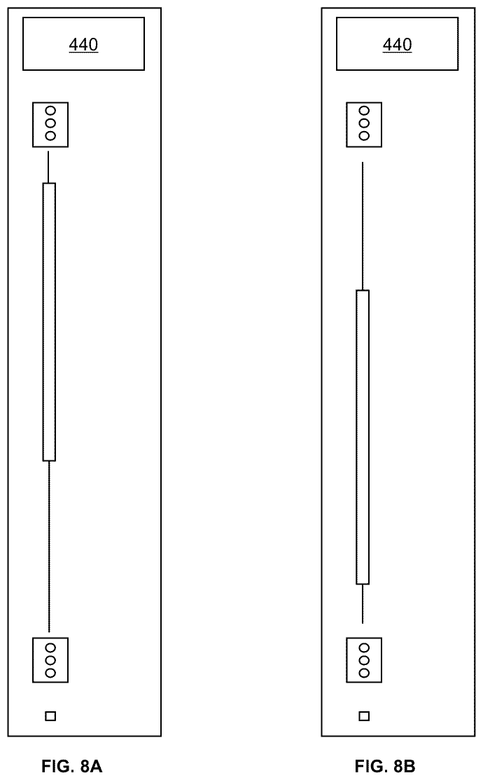

For example, the first distribution result may be positions of a plurality of pieces of the data to be analyzed arranged from largest to smallest on the box plot in an upper to lower manner, and the box body 620 may represent data between an upper quartile and a lower quartile of the first distribution result. If the box body is located in a middle portion of the box plot, the data to be analyzed in the target region may be concentrated near a middle value in the first distribution result. FIG. 8A is a schematic illustration illustrating an exemplary position distribution of mapping segments according to some embodiments of the present disclosure. As shown in FIG. 8A, if the box body is located in an upper portion of the box plot, the data to be analyzed in the target region may be concentrated near a larger value in the first distribution result. FIG. 8B is a schematic illustration illustrating another exemplary position distribution of mapping segments according to some embodiments of the present disclosure. As shown in FIG. 8B, if the box body is located in a lower portion of the box plot, the data to be analyzed in the target region may be concentrated near a smaller value in the first distribution result. The upper quartile may be data at a 1/4 position of the data to be analyzed arranged from largest to smallest, and the lower quartile may be data at a 3/4 position of the data to be analyzed arranged from largest to smallest. The data at the 3/4 position is less than the data at the 1/4 position.

In some embodiments, the numerical mapping graph may include one or more mapping segments, and a length of each of the mapping segments may be determined based on an amount of a portion of the data to be analyzed whose values are between the upper quartile and the lower quartile. A position distribution of the mapping segments on the data mapping graph may reflect a distribution concentration level of the data to be analyzed.

As shown in FIG. 6A, a mapping segment may be the box body 620 in the box plot. The greater the amount of data to be analyzed located between the upper and lower quartiles, the longer the mapping segment.

In some embodiments, different types of data and different users may correspond to different box bodies and different portions of the data to be analyzed. The type of data may include the amount, the grade, the increase, etc. The user type may be divided based on occupation or based on other information.

For example, the first distribution result may be positions of the plurality of pieces of the data to be analyzed arranged in order from largest to smallest on the box plot in an upper to lower manner, and in response to a determination that the user focuses on the top 50% of the data to be analyzed in the first distribution result, the box body may be located between the maximum value and the median value of the data to be analyzed, reflecting the concentration situation of the top 50% of the data to be analyzed.

In some embodiments, the processor may determine the box body and a portion of the data to be analyzed corresponding to the box body in various ways. For example, the processor may obtain a user-defined box body. As another example, the processor may automatically determine the box body based on historical operation data of the user, the type of data, etc. As a further example, the processor may recommend a plurality of preset box bodies to the user, and in response to a determination that the user selects one of the preset box bodies or makes adjustments based on one of the preset box bodies, determine a final box body. The historical operation data of the user refers to data related to operations performed by the user on the data to be analyzed in historical data. For example, the historical operation data of the user may include a count of operations for the user to select the top 50% of the data to be analyzed, a customary selection order of the user for probing data to be analyzed in the plurality of target regions, or the like. The preset box bodies may be pre-set based on a historical experience.

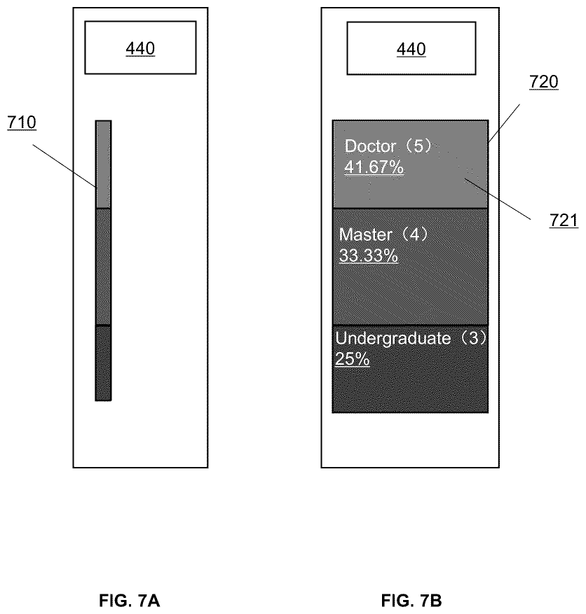

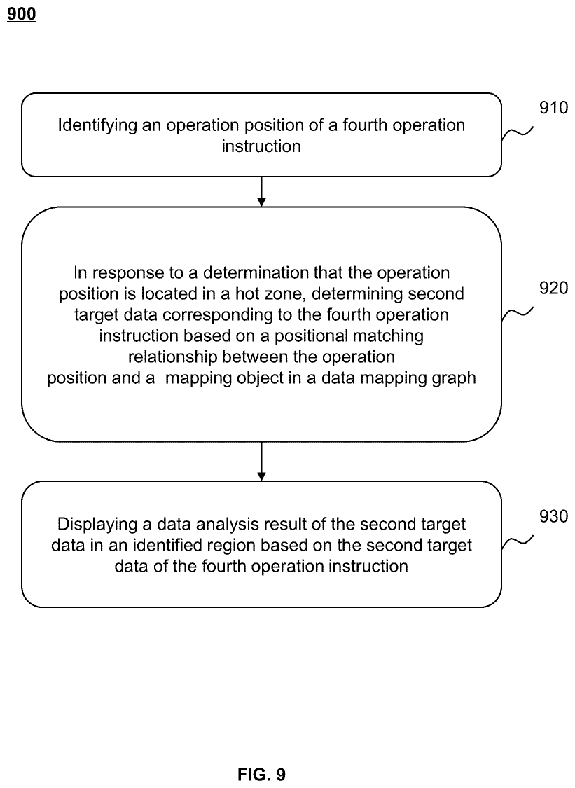

FIG. 7A is a schematic diagram illustrating an exemplary textual mapping graph in a first state according to some embodiments of the present disclosure. As shown in FIG. 7A, the textual mapping graph in the first state may be a textual categorization graph in the form of a strip. The textual categorization graph in the first state may abbreviate categorization information of text data. For example, the textual categorization graph in the form of a strip may include a plurality of rectangles 710 with different colors (which may also be referred to a plurality of preset segments). The rectangle with each color reflects text data of a text type. The text type may be a type characterizing a meaning of text. For example, the text type may include a job title, a gender, an age, an education, a nationality, or the like, or a combination thereof. More description regarding the categorization information may be found in FIG. 9 and related description thereof.

In some embodiments, the distribution of hot zones corresponding to different target regions may be different. The distribution of the hot zones refers to a parameter (e.g., an acreage, a length, etc.) by which the hot zones need to occupy the target region. In some embodiments, for a certain target region, the processor may determine the distribution of the hot zones based on a data distribution feature of the data to be analyzed in the target region. The data distribution feature may characterize an amount of data to be analyzed concentrated in the preset segments.

In some embodiments, the processor may determine the data distribution feature by processing the data to be analyzed in the target region in various ways. For example, the processor may determine the data distribution feature by processing the data to be analyzed in the target region based on a data analysis manner and/or a data analysis rule. As another example, the processor may process the data to be analyzed in the target region based on a feature model to determine the data distribution feature. The feature model may be a machine learning model. For example, the feature model may include a neural network (NN) model, etc. The feature model may be obtained by training. In some embodiments, the feature model may be obtained by training a data categorization model. The data categorization model may be used to classify data. Classifying data refers to classifying data into a plurality of categories with different degrees (e.g., difficulty, case, etc.) according to a complexity of the data. In some embodiments, the data categorization model may include a feature extraction layer and a categorization layer. The feature extraction layer and the categorization layer may be neural network (NN) models, etc. The data categorization model may be obtained by training based on sample data and a categorization label corresponding to the sample data, and the feature extraction layer in a trained data categorization model may be used as a feature extraction model.

In some embodiments, the processor may determine the distribution of hot zones based on the data distribution feature in a variety of ways. For example, the processor may construct a data distribution vector based on the data distribution feature, match the data distribution vector with reference data distribution vectors in a first vector database, and select reference data distribution vector with the highest similarity to the data distribution vector as a target reference data distribution vector that is successfully matched with the data distribution vector, and determine a distribution of preheated hot zones corresponding to the target reference data distribution vector as a distribution of preheated hot zones of the target region corresponding to the data distribution feature. The similarity of the vectors may be negatively correlated to a distance between the vectors, which may be a cosine distance, etc.

In some embodiments, the data distribution vector may include each preset segment and an amount of data to be analyzed within the preset segment. The first vector database may be pre-constructed and may include the reference data distribution vectors and distributions of preheated hot zones corresponding to the reference data distribution vectors. The reference data distribution vector refers to a vector constructed based on a reference data distribution feature. The reference data distribution feature and the distribution of preheated hot zones corresponding to the reference data distribution vector may be pre-set based on the historical experience, historical data, etc.

In some embodiments of the present disclosure, by determining parameters of personalized hot zones in different target regions according to an actual situation of the data to be analyzed in the different target regions, the data mapping graph displayed by the hot zones may be more in line with the actual situation of the different target regions.

In some embodiments, the processor may process the data to be analyzed in the target region based on a distribution prediction model to determine the distribution of the hot zones corresponding to the target region.

In some embodiments, the distribution prediction model may be a machine learning model. For example, the distribution prediction model may include any one or a combination of a convolutional neural network (CNN) model, a neural network (NN) model, or other customized model structure.

In some embodiments, an input of the distribution prediction model may include data to be analyzed in at least one target region, and an output of the distribution prediction model may include a distribution of hot zones corresponding to the data to be analyzed in the at least one target region.

The distribution prediction model may be obtained by training based on a plurality of first training samples and a first label. The first training samples may be obtained from historical data and may include both positive and negative samples. The first label may be a distribution of actual preset tasks corresponding to historical data to be analyzed. In some embodiments, the processor may determine the positive samples and the negative samples based on a count of operations performed by a historical user on a historical data mapping graph corresponding to the historical data to be analyzed. The count of operations performed by the historical user refers to a count of operations by the historical user to zoom in or zoom out the data mapping graph corresponding to the historical data to be analyzed after the historical data mapping graph is displayed. For example, in response to the count of operations greater than an operation threshold, historical data to be analyzed corresponding to the data mapping graph may be designated as the negative sample; and in response to the count of operations less than the operation threshold, the historical data to be analyzed corresponding to the data mapping graph may be designated as the positive sample. The operation threshold may be pre-set based on a priori knowledge or historical experience.

In some embodiments, the processor may train the distribution prediction model based on the plurality of first training samples with the first label using a gradient descent manner. The processor may input the plurality of first training samples with the first label into a preliminary distribution prediction model, construct a loss function based on the first label and results of the preliminary distribution prediction model, and iteratively update parameters of the preliminary distribution prediction model based on the loss function. When the loss function of the preliminary distribution prediction model satisfies a preset condition, model training may be completed and the trained distribution prediction model may be obtained. The preset condition may be that the loss function converges, the count of iterations reaches a threshold, etc.

In 330, in response to receiving a fourth operation instruction from the user, the data mapping graph in the first state may be updated to the data mapping graph in a second state.

The second state refers to a state of the data mapping graph under the fourth operation instruction. In some embodiments, the second state may be an active state of the data mapping graph.

The fourth operation instruction may be an instruction for analyzing the data to be analyzed. In some embodiments, the fourth operation instruction may include an instruction for requesting to update the data mapping graph. In some embodiments, the fourth operation instruction may be used to display the data analysis result, and more contents regarding displaying the data analysis result may be found in a related description in FIG. 3. In some embodiments, triggering of the fourth operation instruction may be in the form of clicking or hovering over any position of the hot zone, clicking on the data to be analyzed, clicking on a fixation region, or the like, by the user. More description regarding the fixation region may be found in FIG. 13 and related descriptions thereof.

The data mapping graph in the second state may be a data mapping graph that completely presents the distribution result of the data to be analyzed. In some embodiments, the data mapping graph in the second state may include a numerical mapping graph in the second state, a textual mapping graph in the second state, or the like. In some embodiments, the numerical mapping graph in the second state may include markers that reflect the data analysis result of the data to be analyzed and/or a data range, markers with statistical significance, curves that reflect the distribution result of the data to be analyzed, etc. The textual mapping graph in the second state may include the categorization information and proportion information of the data to be analyzed, or the like.

FIG. 6B is a schematic diagram illustrating an exemplary numerical mapping graph in a second state according to some embodiments of the present disclosure. As shown in FIG. 6B, the numerical mapping graph in the second state may include a mapping object 640 and a distribution curve 630. The mapping object may be located to a left side of the hot zone. For example, the distribution curve may be located on a right side of the hot zone. In some embodiments, in response to a determination that the numerical mapping graph in the second state is displayed, the data to be analyzed may be darkened for display.

More description regarding the mapping object may be found in FIG. 9 and related description thereof.

In some embodiments, the distribution curve 630 may characterize a region where the data to be analyzed is concentrated. The more concentrated the data to be analyzed, the higher the peak value of a curve segment corresponding to a numerical range of the data to be analyzed; and the sparser the data to be analyzed, the lower the peak value of the curve segment corresponding to the numerical range of the data to be analyzed. In some embodiments, a range of the distribution curve in the data mapping graph in the second state may be the same as a length of the box body in the data mapping graph in the first state.

FIG. 7B is a schematic diagram illustrating an exemplary textual mapping graph in a second state according to some embodiments of the present disclosure. In some embodiments, as shown in FIG. 7B, compared to a textual mapping graph in a first state, the textual mapping graph in a second state may include a plurality of rectangles 720 with a larger acreage. An amount of text data of each text type and a proportion of the text data of each text type in total text data may be displayed in each of the plurality of rectangles. More description regarding the textual mapping graph in the first state may be found in operation 320 and related description thereof.

In some embodiments, when the mouse cursor hovers over a rectangle of the textual mapping graph, the system for visual data analysis and interaction may highlight and/or flash rows of all data to be analyzed of a text type corresponding to the rectangle, which allows the user to view specific contents of the data to be analyzed of the text type corresponding to the rectangle.

In some embodiments, in response to the mouse cursor hovering over one of the data mapping graphs, a display panel, etc., the system for visual data analysis and interaction may highlight and/or flash rows of all data to be analyzed corresponding to a position where the mouse cursor hovers. More description regarding the display panel may be found in FIG. 9 and related description thereof.

In some embodiments, the processor may determine the data mapping graph in the first state and/or the data mapping graph in the second state based on the distribution result of the plurality of pieces of data to be analyzed in the target region in a variety of ways. For example, the data mapping graph may be made by the data processing software based on the distribution result of the plurality of pieces of data to be analyzed in the target region. The data processing software may include Google Sheets, Plotly, Highcharts, or the like.

In 340, the data analysis result may be displayed in an identified region corresponding to each of the one or more target regions.

The identified region of a target region may be a region displaying the data analysis result in the target region independently of the hot zone in the target region. In some embodiments, in response to receiving the fourth operation instruction initiated by the user, the data analysis result of the data to be analyzed corresponding to the fourth operation instruction may be displayed in the identified region. The identified region may be a portion of the target region 430. The identified region may be at a fixed position in the target region. For example, the identified region (as shown in FIG. 4, the identified region 440) may be a header of each column in the data table, etc.

The data analysis result refers to a result that may characterize a feature of the data to be analyzed corresponding to the fourth operation instruction. For example, the data analysis result may characterize at least one of ranking information, categorization information, proportion information, a maximum value, a minimum value, a median value, and an average value, or the like, or a combination thereof, of the data to be analyzed in the target region. More descriptions may be found in FIG. 9 and related description thereof.

In some embodiments, in response to receiving the fourth operation instruction from the user (e.g., the user clicking or hovering over any position of the hot zone, etc.), the processor may update the data mapping graph in the first state of the hot zone to the data mapping graph in the second state. In some embodiments, in response to the user clicking or hovering over a different position of the data mapping graph in the second state, the identified region corresponding to the target region may display the data analysis result of data to be analyzed displayed by the position. For example, if the user clicks or hovers over a position in the data mapping graph in the second state, and the position is a mapping object corresponding to a mapping maximum value, the identified region corresponding to the target region may display the maximum value in the data to be analyzed. As another example, as shown in FIG. 6B, if the user clicks or hovers over a position in the data mapping graph in the second state, and the position is a mapping interval 642, the identified region 440 may display a numerical range of the mapping interval 642 and/or an amount of data to be analyzed included in the mapping interval 642. More descriptions may be found in FIG. 9 and related description thereof.

In some embodiments, each target region (each column) may correspond to one identified region, and when data probing is performed on one of the one or more target regions, only a corresponding identified region may display the data analysis result of the probing. For example, when the user clicks on a marker of the average value in the data mapping graph in a certain target region, an identified region corresponding to the target region may display a specific value of the average value, while other identified regions do not change. More descriptions may be found in FIG. 9 and related description thereof.

In some embodiments, the processor may recognize the operation position of the fourth operation instruction, and in response to a determination that the operation position is located in the hot zone, determine second target data corresponding to the fourth operation instruction based on a positional matching relationship between the operation position and a mapping object in the data mapping graph and display a data analysis result of the second target data. More descriptions may be found in FIG. 9 and related description thereof.

In some embodiments of the present disclosure, in response to receiving the third operation instruction and the fourth operation instruction from the user, two forms of data mapping graphs may be displayed in the user interface, which enables the user to freely choose to display data of greater interest and intuitively and clearly observe the data analysis result and the data distribution result, thereby making a judgment based on the data analysis result and the data distribution result.

In some embodiments, the processor may update the data mapping graph based on a distribution result of first target data in the data to be analyzed, and the first target data may be determined based on an analytical requirement of the user for the data to be analyzed.

The first target data may be a portion of the data to be analyzed in the target region that the user needs to analyze. For example, the first target data may include the top 50% of the data to be analyzed, the last 50% of the data to be analyzed, or the like.

In some embodiments, the processor may update the data mapping graph based on the distribution result of the first target data. For example, if the first target data is the top 50% of the data to be analyzed in the target region, the processor may generate a new mapping graph based on the first distribution result of the first target data or generate a new categorical numerical mapping graph based on a second distribution result of the second target data. In some embodiments, in response to the user selecting a portion of the data mapping graph, the data mapping graph within the selected range may be enlarged and displayed in a preset space. In some embodiments, in response to an operation of the user on the preset space, the system for visual data analysis and interaction may change the size of the preset space, and the operation may include dragging edges of the preset space, or the like.

The preset space may be an interface independent of the interface of the target region. For example, the preset space may be a new display box that pops up on the current interface of the target region.

In some embodiments, in response to the user selecting a portion of the data mapping graph, data to be analyzed within the selected range may be used as the first target data, and the processor may update the data mapping graph based on the distribution result of the first target data.

In some embodiments of the present disclosure, by updating the data mapping graph based on a distribution result of data to be analyzed in a sub-set of the data to be analyzed, a more personalized analysis of data may be provided based on the analytical requirement of the user. Meanwhile, when the amount of data to be analyzed is large, interference of other uninterested data can be eliminated, but there is no need to delete other uninterested data for the user to view later.

In some embodiments, each of the one or more target regions may include a plurality of target sub-regions distributed in a plurality of data pages, and the data mapping graph may reflect a distribution result of data in the plurality of target sub-regions. In some embodiments, in response to receiving a fifth operation instruction, the processor may jump a first page displayed on the user interface to a second page; and display the data mapping graph in a hot zone in the second page. A display state of the data mapping graph in the first page is the same as a display state of the data mapping graph in the second page, and a position of the hot zone in the second page is matched with a position of the hot zone in the first page.

In some embodiments, the data table may include a plurality of pages. The data page may be one of the pages of the data table. One column in the data table may be divided into sub-columns in the plurality of data pages. The target region (i.e., a column in the data table) may include a plurality of target sub-regions. One sub-column in the data table may correspond to one target sub-region. The data mapping graph may reflect the distribution result of data to be analyzed in a whole column (i.e., all sub-columns in the plurality of data pages).

The display state refers to a display appearance. The position of the hot zone in the second page matched with the position of the hot zone in the first page means that the position and acreage of the hot zone in the first page are the same as the position and acreage of the hot zone in the second page. Understandably, page switching may be only a change in the data to be analyzed in the target region, but the hot zone and the data mapping graph remain exactly the same.

The fifth operation instruction refers to an operation instruction regarding page switching. In some embodiments, the fifth operation instruction may include an instruction requesting switching the data pages. In some embodiments, in response to the user clicking on a page switching button in the user interface, any one of all the data pages in the data table may be selected to be displayed. The page switching button is generated for the user to interact with the user interface.

In some embodiments of the present disclosure, when switching to a different data page, the display state and position of the data mapping graph do not change, so that the user can still view the overall distribution result of the data to be analyzed while probing the data in different data pages, which improves the user experience.

In some embodiments, in response to receiving the fourth operation instruction from the user, the processor may adapt a display range of each of the target regions (which may also be referred to as a first target region) and/or a second target region; and/or predict the display range of the first target region and/or the second target region based on user historical operation data and current operation data. The first target region refers to a target region where the user clicks or hovers corresponding to the fourth operation instruction. The second target region refers to target regions except the first target region among all the target regions.

The display range refers to a size of the display region (i.e., a width of the columns of the data table) of the first target region and the second target region. In some embodiments, in response to receiving the fourth operation instruction from the user, the processor may automatically adjust the display range. For example, the processor may expand the display range of the target region corresponding to the fourth operation instruction based on a first preset width, and narrow the display range of the second target region based on a second preset width. In response to the user stopping sending the fourth operation instruction, the display ranges of the first target region and the second target region may be restored to an initial display range. The first and second preset widths refer to width references for adjusting the display range, which may be set in advance. The initial display range may be set in advance.

In some embodiments, the processor may predict the display range of the first target region and/or the second target region based on the user historical operation data and the current operation data. In some embodiments, the user historical operation data may include a customary selection order of the user for probing the plurality of target regions in historical data. The current operation data refers to data related to a current operation of the user, e.g., a position where the user clicked, a count of times the user clicked, etc. The processor may obtain the current operation data based on operations by the user through the user terminal. More description regarding the historical operation data may be found in FIG. 3 and related descriptions thereof.

In some embodiments, the processor may construct an operation vector based on the current operation data and the user historical operation data, and match the operation vector with reference operation vectors in a second vector database, and select a reference operation vector with the highest similarity to the operation vector as a target operation vector that is successfully matched with the operation vector, and determine an actual first display range and an actual second display range corresponding to the target operation vector as the display range of the first target region and the second target region, respectively. The actual first display range refers to a display range corresponding to a historical first target region associated with historical operation data corresponding to the reference operation vector. The actual second display range refers to a display range corresponding to a historical second target region associated with the historical operation data corresponding to the reference operation vector. The process for constructing the second vector database may be similar to the process for constructing the first vector database.

In some embodiments, in response to determining the predicted display ranges of the first target region and the second target region, the processor may automatically expand the display range of the first target region and automatically reduce the second target region in real time.

In some embodiments of the present disclosure, the display range adapting the first target region and the second target region enables the user to view the data to be analyzed of the first target region of concern more clearly, making it more convenient for the user to operate the data mapping graph and for the exploration of the data.

It should be noted that the foregoing descriptions of the process 300 may be intended to be exemplary and illustrative only and does not limit the scope of application of the present disclosure. For those skilled in the art, various modifications and changes can be made to the hand-eye calibration process under the guidance of the present disclosure. However, these modifications and changes remain within the scope of the present disclosure.

FIG. 9 is a flowchart illustrating an exemplary process for displaying a data analysis result according to some embodiments of the present disclosure. As shown in FIG. 9, process 900 may include following operations.

In 910, an operation position of a fourth operation instruction may be identified. More description regarding the fourth operation instruction may be found in FIG. 3 and related description thereof.

The operation position refers to a position where the user interacts with a user interface to trigger the fourth operation instruction. The position where the user interacts with the user interface to trigger the fourth operation instruction refers to a position point or a region on the user interface where the user acts at. In some embodiments, the user may interact with the user interface in various ways. For example, the user may interact with the user interface (e.g., clicking on or cursor hovering over the user interface, etc.) by touching a display screen or using an interactive component (e.g., a mouse, etc.).

In some embodiments, the processor may automatically recognize and obtain a position where the user interacts with the user interface (e.g., a position of clicking or cursor hovering, etc.) and determine the position as the operation position.

In 920, in response to a determination that the operation position is located in a hot zone, second target data corresponding to the fourth operation instruction may be determined based on a positional matching relationship between the operation position and a mapping object in a data mapping graph. More description regarding the hot zone may be found in FIG. 3 and related descriptions thereof.

The mapping object refers to a marker on the data mapping graph that may map or link a data analysis result of data to be analyzed. In some embodiments, the mapping object may be a marker corresponding to the data to be analyzed and/or a marker corresponding to data obtained after processing (e.g., segmenting, dividing, taking a median value, etc.) the data to be analyzed. More description regarding the data analysis result may be found in FIG. 3 and related descriptions thereof.

In some embodiments, combined with FIG. 6B, the mapping object 640 may include at least one of a mapping marker point 641 or one or more mapping intervals 642. In some embodiments, the mapping marker point 641 may include at least one of mapping statistic points 6411-6418 or a mapping data point 6419. The mapping statistic points 6411-6418 refer to a plurality of statistically significant marker points. More description regarding the mapping statistic point may be found in related descriptions below.

In some embodiments, the mapping statistic points and the mapping intervals may be displayed in the hot zone according to a preset arrangement. For example, the mapping statistic points and the mapping intervals may be displayed on a left side of the hot zone in order from smallest to largest. More description regarding the preset arrangement may be found in FIG. 3 and related description thereof. In some embodiments, the user may view a data analysis result of data to be analyzed that is mapped by the mapping object 640 through an operation of the user on the mapping object 640, and the data analysis result may be displayed in an identified region simultaneously.

The mapping marker point 641 refers to a marker of a certain data point that may map the data analysis result. In other words, the mapping marker point may be a data point in the data mapping graph having the data analysis result. In some embodiments, when the second target data is a data point, the mapping marker point may be a marker point of the second target data in the data mapping graph.

In some embodiments, the mapping statistic points may include at least one of an anomaly mapping marker 6411, a null mapping marker 6412, or mapping markers corresponding to a maximum value 6413, a minimum value 6414, an upper quartile 6415, a lower quartile 6416, a median value 6417, an average value 6418, or the like, or the combination thereof.

More description regarding the upper quartile and the lower quartile may be found in FIG. 3 and related descriptions thereof. More description regarding the anomaly mapping marker and the null mapping marker may be found in FIG. 9 and related description below.

The mapping statistic point may be a marker point corresponding to data obtained after statistical processing the data to be analyzed.

The maximum value 6413 refers to a mapping statistic point that maps a maximum value in the data to be analyzed. The minimum value 6414 refers to a mapping statistic point that maps a minimum value in the data to be analyzed. The median value 6417 refers to a mapping statistic point that maps a median value of the data to be analyzed. The average value 6418 refers to a mapping statistic point that maps an average value of the data to be analyzed.

In some embodiments, the processor may determine a distribution concentration level of the data to be analyzed based on a position relationship of the mapping markers corresponding to the median value and the average value in the data mapping graph.

The position relationship may include a mapping statistic point of the median value being above a mapping statistic point of the average value or the mapping statistic point of the median value being below the mapping statistic point of the average value. In some embodiments, if the mapping statistic point of the median value is above the mapping statistic point of the average value, the data to be analyzed may be concentrated at a top portion; and if the mapping statistic point of the median value is below the mapping statistic point of the average value, the data to be analyzed may be concentrated at a bottom portion.

In some embodiments, the anomaly mapping marker 6411 may include at least one of the mapping markers corresponding to a biased large outlier and a biased small outlier. At least one of the biased large outlier or the biased small outlier may be determined based on a rule type.

The anomaly mapping marker 6411 refers to a mapping statistic point that maps an outlier in the data to be analyzed. The biased large outlier refers to data to be analyzed that has a larger value compared to other data to be analyzed. The biased small outlier refers to data to be analyzed that has a smaller value compared to other data to be analyzed.

In some embodiments, the processor may determine the biased large outlier and/or the biased small outlier based on the rule type. The rule type refers to a rule that determines the biased large outlier and the biased small outlier. There may be a plurality of rule types. In some embodiments, the rule type may include at least one of determining the biased large outlier based on a biased large threshold or determining the biased small outlier based on a biased small threshold. The processor may determine data to be analyzed greater than the biased large threshold as the biased large outlier, and determine data to be analyzed less than the biased small threshold as the biased small outlier.

In some embodiments, the biased large threshold and the biased small threshold may be expressed by the following formula (1) and formula (2), respectively:

$$A = S + 1.5 * ( S - X ) \qquad ( 1 )$$

$$B = X - 1.5 * ( S - X ) \qquad ( 2 )$$

where A denotes the biased large threshold, B denotes the biased small threshold, S denotes the upper quartile, and X denotes the lower quartile.

In some embodiments, the processor may determine the biased large outlier and/or the biased small outlier through any feasible manners.

In some embodiments, combined with FIG. 6A and FIG. 6B, anomaly mapping markers mapping biased large outliers may be set in an upper region of the maximum value 6413 and arranged equidistantly or overlappingly from top to bottom according to the size of the biased large outliers.

In some embodiments, an anomaly mapping marker mapping a biased small outlier may be set in a lower region of the minimum value 6414. In some embodiments, anomaly mapping markers mapping biased small outliers may be arranged equidistantly or overlappingly from bottom to top according to the size of the biased small outliers.

In some embodiments, the anomaly mapping marker of each of the biased large outliers and the anomaly mapping marker of each of the biased small outliers may be represented by marker points of a preset shape. The preset shape may include any reasonable figures, e.g., a circle, a triangle, or the like.

In some embodiments, when there are a large number of biased large outliers or biased small outliers, circular marker points may overlap, and in response to the user clicking on the circular marker points, the identified region 440 may display specific values of biased large outliers or the biased small outliers corresponding to the circular marker points.

In some embodiments, the null mapping marker 6412 may be a mapping marker corresponding to a null value in the data to be analyzed. In some embodiments, in response to a determination that the data to be analyzed includes the null value, the processor may highlight a mapping marker corresponding to the null value.

In some embodiments, the null mapping marker 6412 refers to a mapping statistic point that maps the null value in the data to be analyzed. In some embodiments, the null mapping marker may be located in a lowermost region below the anomaly mapping marker 6411 that maps the biased small outlier. In response to a determination that the data to be analyzed includes the null value, the processor may highlight the mapping marker corresponding to the null value.

In some embodiments, the null mapping marker may be highlighted. For example, if there exists the null value, the null mapping marker may be highlighted by a rectangle filled with a color such as orange. In some embodiments, the null mapping marker may be represented by any type of graphic and may be set at a preset position in the hot zone. The preset position may be pre-set based on a user requirement.

In some embodiments of the present disclosure, by highlighting the null mapping marker, the user can clearly and quickly confirm whether a null value exists in the target region.

In some embodiments, the processor may perform at least one of the following operations. The operations may include adjusting a display of the mapping statistic point in the data mapping graph based on a user requirement; or determining a type of the mapping statistic point displayed in the data mapping graph based on at least one of a user business scenario or a display rule.

In some embodiments, the user requirement may include whether a plurality of mapping statistic points may be displayed. For example, the user requirement may include displaying the anomaly mapping marker 6411 or not, displaying the maximum value 6413 or not, or the like. The user requirement may be determined by user input.

The user business scenario refers to a scenario to which the data to be analyzed may be applied. For example, the user business scenario may include a school, a bank, a hospital, etc. The display rule refers to a rule used to determine the mapping statistic point. For example, the display rule may be that data to be analyzed greater than the upper quartile is the biased large outlier and is indicated by the anomaly mapping marker.

In some embodiments, the processor may determine the type of the mapping statistic point displayed in the data mapping graph in a variety of ways based on at least one of the user business scenario or the display rule. For example, if the user business scenario is a school, and the display rule is that data with a score less than 30 is the biased small outlie and is indicated by the anomaly mapping marker, the type of the mapping statistic point displayed in the data mapping graph may include the anomaly mapping marker mapping the biased small outlier, indicating students with too low grades. As another example, if the user business scenario is a bank, and the display rule is that data with a deposit less than $500 is the biased small outlier and is indicated by the anomaly mapping marker, the type of the mapping statistic point displayed in the data mapping graph may include the anomaly mapping marker mapping the biased small outlier, indicating depositors with small deposit amounts.

In some embodiments, the system for visual data analysis and interaction may form a customized data mapping graph based on adjustments of the user to the mapping object. For example, in response to the user clicking on the box plot, the user interface may display an adjustment menu, and the adjustment menu may include whether to display outliers, whether to display statistically significant values such as the maximum value, the minimum value, the median value, the average value, and other reference data, rules for determining anomaly mapping markers, or the like. After the user adjust the mapping object based on the adjustment menu, the system for visual data analysis and interaction may form the customized data mapping graph based on the adjustment menu.

In some embodiments of the present disclosure, the customized data mapping graph may be formed based on the user requirement and the user business scenario and/or the display rule, enabling the user to use a data mapping graph that better meets the user requirement for data probing, thereby improving the user experience.

The mapping data point refers to a notation point of the data to be analyzed in the data mapping graph, e.g., the mapping data point 6419, etc. In some embodiments, each mapping data point may correspond to a rectangle in the textual categorization graph. For example, referring to FIG. 7B, a mapping data point 721 may correspond to the rectangle 720 in the textual categorization graph indicating a doctoral degree in the data to be analyzed that is classified based on educational qualifications.

In some embodiments, in response to the user clicking on a mapping data point of a piece of data, the system for visual data analysis and interaction may jump to a data page in which the data is located and highlight a row in which the data is located. More description regarding the data page may be found in FIG. 3 and related description thereof.

In some embodiments, in response to the user selecting a row of data to be analyzed, the mapping data point in the plurality of numerical mapping graphs that corresponds to the row may be highlighted, allowing the user to clearly view the correspondence relationship of the data to be analyzed.

The mapping interval 642 refers to a marker that may map a certain data range of the data analysis result. In other words, the mapping interval may be a certain data range in the data mapping graph where a data analysis result exists. In some embodiments, when the second target data is a data range, the mapping interval may be a marker of the second target data in the data mapping graph. For example, the mapping interval may be determined based on a data range divided by the data to be analyzed or based on a quantity range including each of pieces of the data to be analyzed.

In some embodiments, the mapping interval 642 may be a portion of a region of the distribution curve 630. For example, the system for visual data analysis and interaction may divide the distribution curve 630 into 20 mapping intervals equidistantly. In some embodiments, in response to the user clicking on the distribution curve 630, the user interface may display a setting panel. The setting panel may include parameters such as a count of portions and dimensions for dividing the distribution curve. In response to the user setting the distribution curve via the setting panel, the system for visual data analysis and interaction may update and display the distribution curve.

In some embodiments, the mapping intervals may be displayed through an area display graph. The area display graph may be a graph that presents the mapping intervals. In some embodiments, the hot zone may be divided into a plurality of blocks from top to bottom. A single block may represent a mapping interval, and all of the blocks may construct the area display graph. In some embodiments, in response to the user clicking on or hovering over a mapping interval, the hot zone may display a block in the area display graph corresponding to the mapping interval.

In some embodiments, in response to a determination that the operation position is located between the distribution curve and a vertical axis on which the mapping statistic point is located, the hot zone may display the mapping intervals, and the identified region may display a numerical range of the mapping intervals and/or a count of pieces of data to be analyzed included by the mapping intervals. For example, the identified region may display that the numerical range of the mapping intervals is 2.25%-2.35% in a descending order of smallest to largest, the count of pieces of data to be analyzed included by the mapping intervals is 15, or the like.

In some embodiments, there may be a plurality of mapping intervals. In some embodiments, the processor may identify an operation mode of the fourth operation instruction; and in response to a determination that the operation position of the fourth operation instruction is located in one of the plurality of mapping intervals and the operation mode is a hover mode, an expansion panel may be displayed on the user interface. The expansion panel may include a portion of the data to be analyzed reflected by the mapping interval corresponding to the fourth operation instruction. In some embodiments, in response to a determination that the operation position of the fourth operation instruction is located on a piece of data located within the expansion panel, the processor may display a data page where the piece of data is located and a data strip (e.g., a row where the data is located, etc.) corresponding to the piece of data on the user interface. More description regarding the data page may be found in FIG. 3 and related description thereof. More description regarding the data strip may be found in operation 1321 in FIG. 13 and related description thereof. More description regarding the operation mode may be found later in FIG. 9 and related description thereof.

In some embodiments, in response to the user hovering over one of the plurality of mapping intervals of the numerical mapping graph, the system for visual data analysis and interaction may highlight all rows of the data to be analyzed corresponding to the mapping interval, allowing the user to view the details of the data to be analyzed corresponding to the mapping interval.

In some embodiments, the numerical mapping graph in the first state may include an anomaly mapping marker and a null mapping marker, and the numerical mapping graph in the second state may include a mapping marker point and mapping intervals. The mapping intervals may be displayed through an area display graph, and more description regarding the area display graph may be found in the relevant descriptions of FIG. 9.

In some embodiments, the textual mapping graph in the first state may include a plurality of mapping data points, and the textual mapping graph in the second state may include the mapping data points and data analysis results of the mapping data points. Each of the mapping data points may correspond to a rectangle in the textual categorization graph.

In some embodiments, the data analysis results of the mapping data points may include at least one of ranking information, categorization information, and/or proportion information. As shown in FIG. 7B, in response to the user clicking on the mapping data point 721, the data analysis results of the mapping data point 721 may be displayed in the identified region 440. The ranking information refers to a ranking of pieces of data to be analyzed corresponding to the mapping data points based on a proportion size. In some embodiments, the mapping data points may be ranked from smallest to largest and from bottom to top based on the proportion size. The categorization information refers to a category of the data to be analyzed that corresponds to the mapping data point. The proportion information refers to a proportion size of the data to be analyzed that corresponds to the mapping data point. The proportion size is related to a proportion of the data to be analyzed corresponding to the mapping data point in all the data to be analyzed.

The positional matching relationship may reflect whether the operation position matches the position of the mapping object. If the operation position is the same as the position of the mapping object, or a distance between the operation position and the position of the mapping object is less than a threshold, the operation position may match the position of the mapping object. For example, in response to a determination that a position (i.e., where a cursor clicked or hovered within the user interface) where the user interacts by touching the display screen or through an interactive component (e.g., a mouse) is the same as the position of the mapping object, the processor may determine that the operation position matches the position of the mapping object.

The second target data refers to specific data corresponding to the mapping object. For example, the second target data may include specific data corresponding to mapping marker points and/or mapping intervals, etc. Exemplarily, the second target data may be an outlier, a null value, a maximum value, a minimum value, an upper quartile, a lower quartile, a median value, an average value, the data to be analyzed, and/or a numerical range, or the like. In some embodiments, in response to a determination that the operation position is located in a hot zone and the operation position matches the position of the mapping object, the processor may determine the second target data as the specific data corresponding to the mapping object. For example, in response to a determination that the operation position matches a position of a mapping statistic point of the average value, the processor may determine the second target data as specific data of the average value.

In 930, a data analysis result of the second target data in the identified region may be displayed based on the second target data corresponding to the fourth operation instruction.

In some embodiments, the identified region may display data analysis results of different pieces of second target data. For example, if the second target data is specific data of the average value, the identified region may display a numerical value corresponding to the average value. As another example, if the second target data is one piece of data to be analyzed, the identified region may display a numerical value corresponding to the data to be analyzed and a ranking of the numerical value among the data to be analyzed in the target region.

In some embodiments of the present disclosure, by identifying the operation position of the fourth operation instruction and based on the positional matching relationship between the operation position and the mapping object, the second target data of the fourth operation instruction may be determined and the data analysis result of the second target data may be displayed in a timely manner, avoiding problems such as a large amount of data being displayed at the same time causing the user to view the data in a way that may be not clear and intuitive, and making it difficult to find the focus.

When there is a larger amount of data to be analyzed, the mapping objects may overlap, which is not easy for the user to view the data analysis results of the data to be analyzed. In some embodiments, in response to an operation of the user satisfying a preset condition (e.g., clicking on the data mapping graph twice), the processor may cause the data mapping graph to be enlarged and displayed in other areas outside the area of the data mapping graph clicked by the user.

In some embodiments, in response to the user clicking on or hovering over a specific mapping marker point, an area in which the specific mapping marker point and a preset count of mapping marker points before and after the specific mapping marker point are located may be enlarged and displayed based on a preset space. The preset count and a size of the preset space may be determined by user settings.

In some embodiments, the system for visual data analysis and interaction may display mapping marker points corresponding to the data to be analyzed within a data range of each target region based on settings of the user on the data range. For example, if the user only focuses on the top 50% of the data, the box plot may be set to display only mapping marker points corresponding to the top 50% of the data to be analyzed, and mapping marker points corresponding to the rest of the data to be analyzed may be temporarily hidden for easy viewing and manipulation, and the mapping marker points corresponding to the maximum value, the minimum value, the average value, the median value, etc., may be displayed for easy comparison.

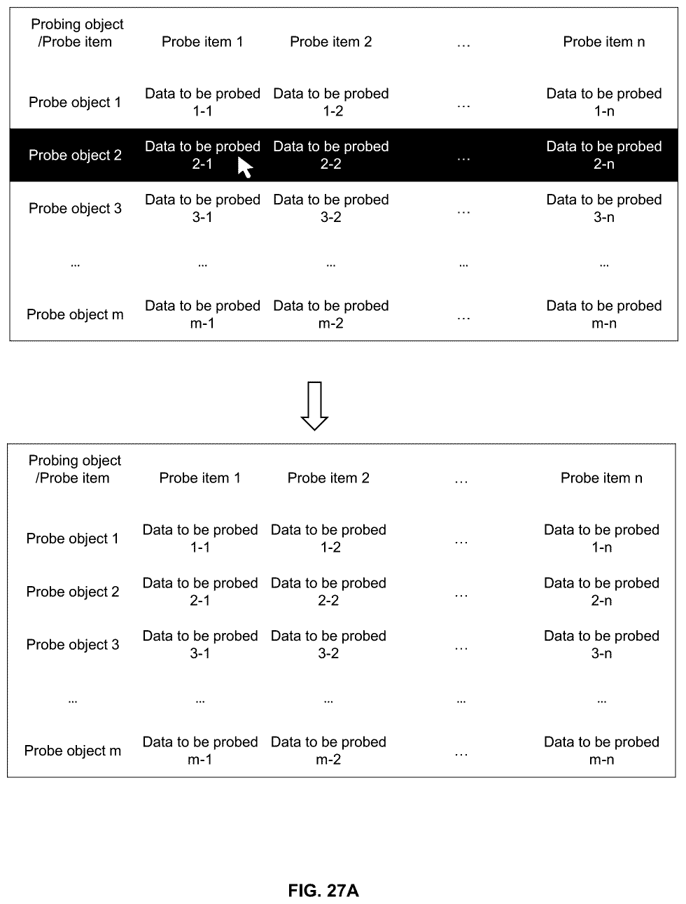

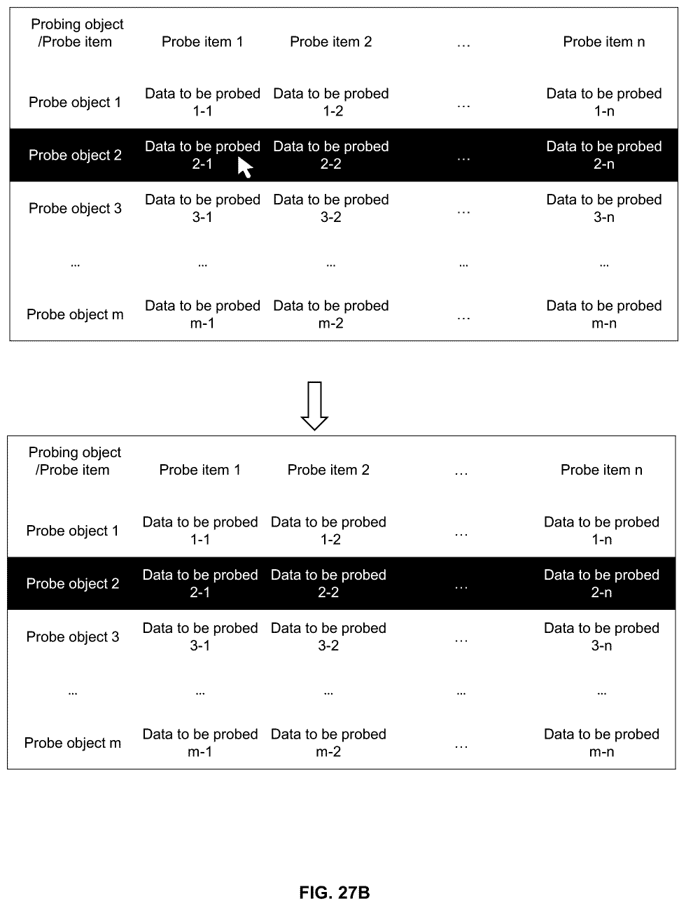

In some embodiments, the processor may identify the operation mode of the fourth operation instruction. The operation mode refers to a manner in which the user interacts with the user interface. The operation mode may include a hover mode, a selection mode, or the like. More descriptions regarding the operation mode, the hover mode, and the selection mode may be found in FIG. 27A and related descriptions thereof.

In some embodiments, in response to a determination that the operation position of the fourth operation instruction is located in an area where the anomaly mapping marker or the null mapping marker is located, and the operation mode of the fourth operation instruction is the hover mode, the data mapping graph displayed on the user interface may remain in the first state. More description regarding the anomaly mapping marker and the null mapping marker may be found in operation 920 and related description thereof.

In some embodiments, in response to a determination that the operation position of the fourth operation instruction matches the position of the mapping marker point, and the operation mode of the fourth operation instruction is the selection mode, the first target data in the data to be analyzed in the target region may be highlighted. The first target data refers to the data to be analyzed pointed to by the fourth operation instruction and the mapping marker point. More description regarding the first target data may be found in FIG. 3 and related description thereof. The highlighted display may include any one or a combination of a plurality of ways such as bolding, or the like.

In some embodiments, in response to a determination that the first target data is highlighted, the rest of the data to be analyzed in the target region may be non-highlighted. The non-highlighted display may include dimmed display, etc.

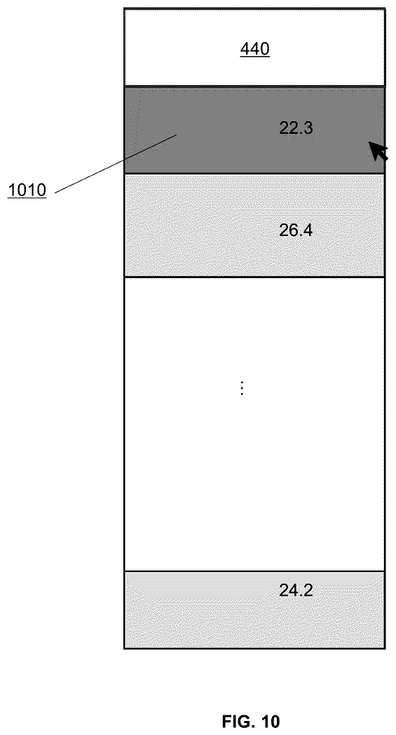

FIG. 10 is an exemplary schematic diagram illustrating a highlighted display of first target data according to some embodiments of the present disclosure. As shown in FIG. 10, in response to a determination that an operation position of a fourth operation instruction matches a position of a mapping marker point 1010 and an operation mode is a selection mode, data to be analyzed of 22.3 pointed to by the mapping marker point 1010 may be highlighted, while the remaining data to be analyzed may be dimmed.

In some embodiments, in response to a determination that a plurality of consecutive operation positions of the fourth operation instruction match positions of a plurality of mapping marker points in different data mapping graphs (e.g., the position where the user clicks may be the same as the positions of the plurality of mapping marker points in the different data mapping graphs) and the operation mode is a selection mode, data analysis results of the plurality of mapping marker points may be displayed in a plurality of identified regions corresponding to the plurality of mapping marker points simultaneously. That is, the data analysis result of each of the mapping marker points may be displayed is highlighted and displayed in the corresponding identified region.

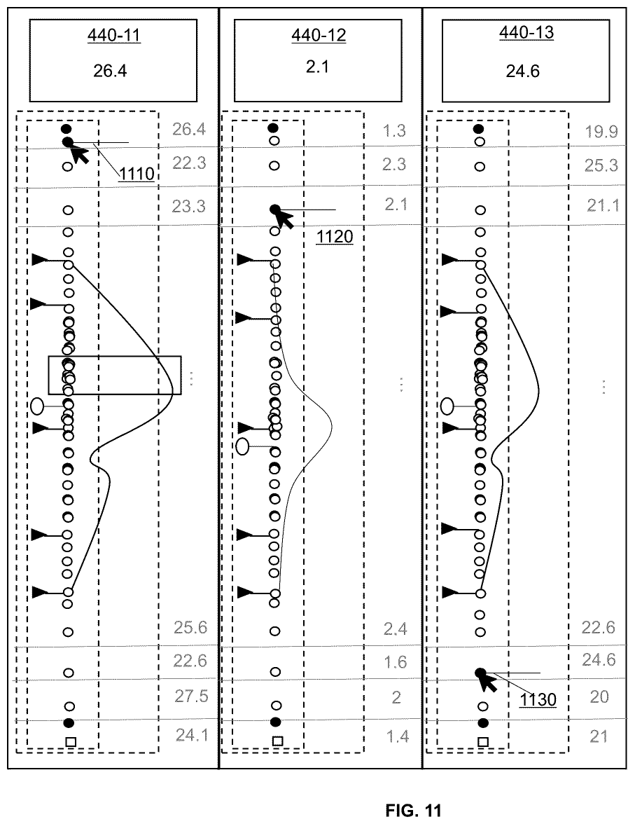

FIG. 11 is an exemplary schematic diagram illustrating a plurality of data analysis results according to some embodiments of the present disclosure. As shown in FIG. 11, in response to a user clicking on a mapping marker point 1110 with a mapping value of 26.4, a mapping marker point 1120 with a mapping value of 2.1, and a mapping marker point 1130 with a mapping value of 24.6, numerical values and/or data analysis results corresponding to the mapping marker point 1110, the mapping marker point 1120, and the mapping marker point 1130, respectively, may be displayed in an identified region 440-11, an identified region 440-12, and an identified region 440-13 corresponding to the mapping marker point 1110, the mapping marker point 1120, and the mapping marker point 1130, respectively.

In some embodiments of the present disclosure, the data analysis results of the plurality of mapping marker points can be displayed at the same time in a plurality of identified regions corresponding to the plurality of mapping marker points, which can facilitate the user to view a plurality of data to be analyzed at the same time and reduce the number of operations.

In some embodiments, the processor may recognize an operation position of a fourth operation instruction, and in response to a determination that the operation position is matched with a position of a target mapping data point in a target textual mapping graph in one or more textual mapping graphs, the processor may display intersection data corresponding to the target mapping data point in a textual mapping graph other than the target textual mapping graph in the one or more textual mapping graphs. The target textual mapping graph refers to a textual mapping graph corresponding to the fourth operation instruction. The target mapping data point refers to a mapping data point in the target textual mapping graph corresponding to the fourth operation instruction.

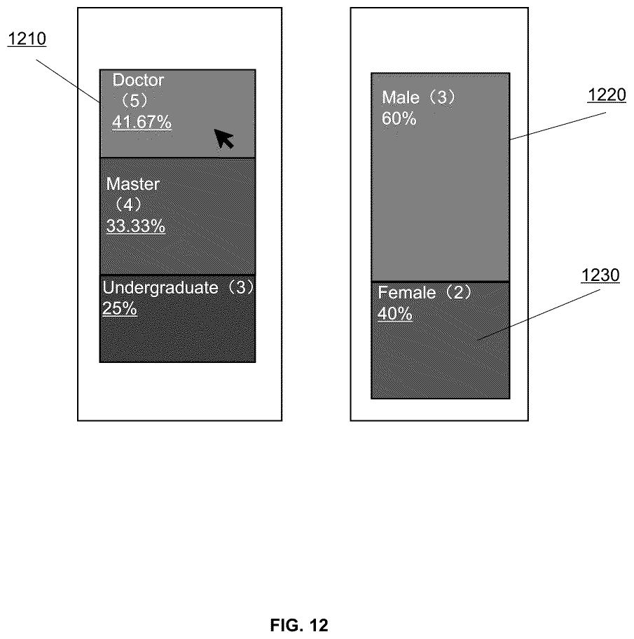

The intersection data refers to data related to other textual mapping graphs associated with the target mapping data point. The intersection data may belong to both the target mapping data point and one or more mapping data points of other textual mapping graphs. For example, when the target mapping data point is one of data points in educational qualifications, the intersection data may be various data under the educational qualification represented by the data point, e.g., genders, posts, etc. FIG. 12 is a schematic diagram illustrating an exemplary process for displaying intersection data according to some embodiments of the present disclosure. As shown in FIG. 12, the target textual mapping graph may be a graph representing proportion information of educational qualifications, and a target mapping data point 1210 maps the proportion information of a doctoral degree. In response to a determination that the operation position matches the position of the target mapping data point in the target textual mapping graph, an identified region corresponding to the target textual mapping graph may display the proportion information of the doctoral degree, and a textual mapping graph indicating proportion information of genders may display proportion information of males 1220 and proportion information of females 1230 in the doctoral degree.

In some embodiments of the present disclosure, the intersection data may be displayed in the textual mapping graph other than the target textual mapping graph, whereby the user may intuitively understand the correlation between data of the different target regions. thereby improving the user experience.

It should be noted that the foregoing description of the process 900 may be intended to be exemplary and illustrative only and does not limit the scope of application of the present disclosure. For those skilled in the art, various modifications and changes can be made to the hand-eye calibration process under the guidance of the present disclosure. However, these modifications and changes remain within the scope of the present disclosure.

FIG. 13 is a flowchart illustrating an exemplary process for displaying a data analysis result of first target data according to some embodiments of the present disclosure. As shown in FIG. 13, process 1300 may include following operations.

In 1310, in response to a determination that an operation position is located in a fixation region. The fixation region may be independent of one or more target regions in the user interface. More description regarding the operation position may be found in FIG. 9 and related description thereof. More description regarding the user interface may be found in FIG. 3 and related descriptions thereof.

In some embodiments, the user interface may include the fixation region. As shown in FIG. 4, a fixation region 410 may be included outside of the one or more target regions (e.g., 430-1, . . . , 430-n, etc.) in the user interface. For example, the fixation region 410 may be a table column that does not require data analysis. The fixation region 410 may be independent of the one or more target regions in the user interface and may be used to display fixed information. The fixed information refers to information that does not require data analysis, e.g., companies, names, or other analysis objects. In some embodiments, the fixation region may be set at a preset position around the one or more target regions, e.g., a left side of the one or more target regions. In some embodiments, there may be a correspondence between the fixation region and the target regions. For example, the fixation region may be used to display each of the analysis objects. Merely by way of example, when the user interface displays tabular data including a company profile, a company name may be inside the tabular data. In some embodiments, there may be a correspondence between the analysis objects of the fixation region and the data to be analyzed in each of the target regions. The data to be analyzed in the target region may be data of an analysis item corresponding to the target region for each of the analysis objects in the fixation region.

In some embodiments, in response to a determination that the operation position is located in the fixation region, the processor may perform operation 1321 and operation 1322.

In 1321, a target data strip may be switched from a first display state to a second display state on the user interface.

The display degree (e.g., a highlighting degree) of the first display state is lower than the display degree of the second display state. The first display state refers to a default state of the data to be analyzed after a third operation instruction is received. More descriptions regarding the third operation instruction may be found in FIG. 3 and related descriptions thereof. The second display state refers to a highlighted display state of the data to be analyzed. In some embodiments, the highlighted display state may be indicated by adding a background color, etc.

The data strip may be composed of a plurality of pieces of data to be analyzed that have a correlation relationship in different target regions. The correlation relationship means that the plurality of pieces of data to be analyzed belong to the same analysis object.

The target data strip may be composed of first target data including target analysis objects in a plurality of target regions. In some embodiments, the target data strip may include a plurality of pieces of first target data, the plurality of pieces of first target data have a one-to-one correspondence with the plurality of target regions, and the regions in which the plurality of pieces of first target data are located and the operation position satisfy a preset condition. More description regarding the first target data may be found in FIG. 3 and related description thereof. The target analysis object may be determined based on the operation position. If the operation position and a position of a certain analysis object satisfy the preset condition (e.g., a distance between the two positions is less than a threshold, a line connecting the two positions lies on a preset line, etc.), the analysis object may be used as the target analysis object. Taking a table as an example, if the analysis object is located at the header of the list, and the operation position is located in a row in which the analysis object is located, the analysis object may be used as the target analysis object.

In some embodiments, in response to the user clicking on a mapping object or a piece of data to be analyzed, a numerical value or a textual content of data corresponding to the aforementioned mapping object or the piece of data to be analyzed and data to be analyzed corresponding to the mapping object clicked by the user and corresponding data strip information may be displayed suspended above the target region. The data strip information may include all of the data in the row where the data to be analyzed is located.

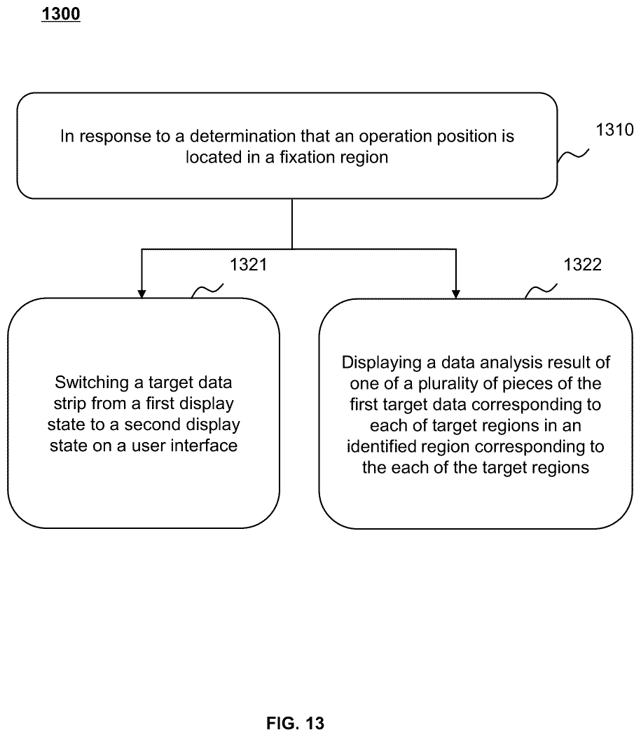

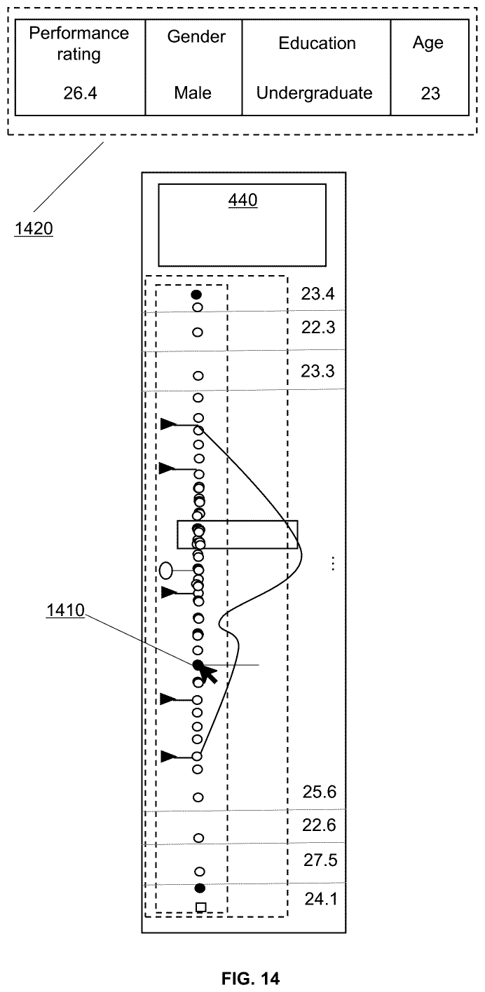

FIG. 14 is a schematic diagram illustrating an exemplary suspended display according to some embodiments of the present disclosure. As shown in FIG. 14, in response to a user clicking on a mapping data point 1410 of a piece of data to be analyzed, a hover region 1420 above one or more target regions may suspend and display a value of data corresponding to the mapping data point 1410 and the data strip information of the data to be analyzed corresponding to the mapping data point clicked by the user.

In 1322, a data analysis result of one of the plurality of pieces of the first target data corresponding to each of the target regions may be displayed in an identified region corresponding to the each of the target regions.

In some embodiments, in response to a determination that the operation position is located in the fixation region, the data analysis result of one of the plurality of pieces of the first target data corresponding to each of the target regions may be displayed in the identified region corresponding to the each of the target regions. More descriptions regarding the target regions, the identified region, and the data analysis result may be found in FIG. 3 and related description thereof.

In some embodiments, in response to a determination that the operation position is located in the fixation region, the numerical mapping graph may include a marker line, and the marker line may indicate a position, in a corresponding numerical graph, of data to be analyzed of a numerical type in the target data strip.

In some embodiments, in response to a determination that the operation position is located in the fixation region, the processor may enlarge and display a mapping data point in a textual mapping graph corresponding to data to be analyzed of a text type in the target data strip.

In some embodiments, in response to a determination that the operation position is located in the fixation region, numerical mapping graphs in the plurality of target regions may include a plurality of marker lines. Each of the marker lines may be used to identify a position in the data mapping graph corresponding to the first target data corresponding to each of the target regions.

In some embodiments, in response to a determination that the operation position is located in the fixation region, the processor may switch the first target data in the textual mapping graph corresponding to the fixed information in the fixation region from the first display state to the second display state and enlarge the first target data to display, while the remaining data to be analyzed in the textual mapping graph may be displayed faded.

In some embodiments of the present disclosure, the target data strip of the user interface may be switched from the first display state to the second display state, and the data analysis result of the first target data corresponding to each of the target regions may be displayed in the identified region corresponding to each of the target regions, which allows the user to intuitively view all the data to be analyzed associated with the analysis object of interest and the data analysis result of the data to be analyzed, thereby simplifying the operation of the user.

In some embodiments, in response to a determination that the operation position is located in at least one of the target regions and outside of the hot zone (i.e., a data region), the processor may switch a target data block outside of the hot zone corresponding to the operation position from the first display state to the second display state; and display a target data analysis result of first target data in an identification region corresponding to the at least one of the target regions.

The target data block refers to an area within the target region occupied by a piece of first target data. In some embodiments, the target data block in a target region may correspond to an area where the first target data outside of the hot zone in the target region is located. In some embodiments, the target data block may be highlighted. The target data analysis result refers to a data analysis result corresponding to the first target data, and more description regarding the data analysis result may be found in FIG. 3 and related description thereof.

In some embodiments, in response to a determination that the operation position is located in a target region and outside of the hot zone (i.e., the data region) of the target region, the numerical mapping graph within the target region may include a marker line. The marker line may be used to identify a position of the data to be analyzed corresponding to the target data block in the data mapping graph.

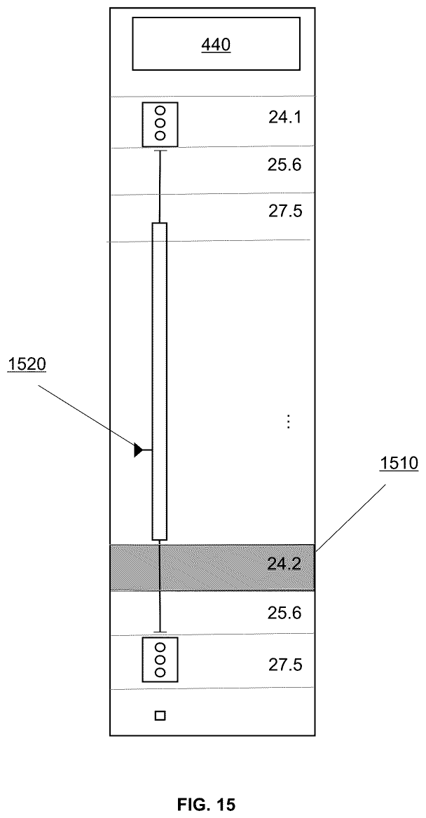

FIG. 15 is a schematic diagram illustrating an exemplary target data block according to some embodiments of the present disclosure. As shown in FIG. 15, in response to a determination that the operation position is located at a target data block 1510 and the target data block 1510 corresponds to data of 24.2, a numerical mapping graph in the target region may include a marker line 1520 used to identify a position of the data of 24.2 in the data mapping graph.

In some embodiments, in response to a determination that the operation position is located in a textual mapping graph in a target region, the data to be analyzed in the textual mapping graph corresponding to the operation position may be switched from a first display state to a second display state, while the remaining data to be analyzed in the textual mapping graph may be displayed faded.

In some embodiments, in response to a determination that the operation position is located outside of a hot zone (i.e., a data region) in a target region, an identified region corresponding to the target region may display a data analysis result of first target data corresponding to the target region.

In some embodiments, in response to a determination that the operation position is located in the textual mapping graph in a target region, an identified region corresponding to the target region may display a data analysis result of the first target data corresponding to the target region. More description regarding the first target data may be found in FIG. 3 and related description thereof. More description regarding the data analysis result may be found in FIG. 3, FIG. 9 and related descriptions thereof.

In some embodiments of the present disclosure, the target data block in the user interface may be switched from the first display state to the second display state, and the data analysis result of the first target data may be displayed in the identified region corresponding to the at least one of the target regions, which can enable the user to intuitively view certain data to be analyzed of concern and the data analysis result of the data to be analyzed.

FIG. 16 is a flowchart illustrating an exemplary process for visual data interaction according to some embodiments of the present disclosure. In some embodiments, process 1600 may be performed by a processor or the system for visual data analysis and interaction and various modules thereof.

In some embodiments, a data graph may include one or more probe graphs, a visualization region may include a first region and a second region, and the visualization region may be displayed based on following operations 1610-1620:

In 1610, the first region may be displayed.

The first region refers to a region that displays a specific data text of a portion of a set of data. In some embodiments, the portion of the set of data may also be referred as to data to be probed.

In some embodiments, the first region may include a plurality of first sub-regions.

The plurality of first sub-regions refer to a plurality of sub-regions in the first region divided according to a type, an attribute, etc., of the data to be probed. Different first sub-regions may display data texts of different portions of the data to be probed of a probe object for different probe items

In some embodiments, the first region refers to a plurality of table columns or rows in the tabular data displaying the data to be probed. Each column or row may correspond to each of the plurality of first sub-regions.

The probe object refers to an object to which the data to be probed in the first region belongs. For example, the probe object may be an object such as an enterprise, an organization, a person, a specific code, or the like, to which the data to be probed belongs. In some embodiments, the probe object may be distributed in an leading column or leading row (e.g., a table header) of the first region. In some embodiments, the probe object may be located in an leading column or leading row in a table, and data in subsequent columns or rows may be the data to be probed corresponding to the probe object.

The probe item refers to an analysis type of the data to be probed. For example, the probe item may be used to represent types, attributes, or the like, of the data to be probed in different first sub-regions in the first region. Merely by way of example, if the data to be probed in the first region is data indicating registered capital of a company, the probe item may be the registered capital; and if the data to be probed is data indicating a revenue proportion of the company, the probe item may be the revenue proportion. In some embodiments, the probe item may be displayed above, below, or on a left side or right side of the first region. In some embodiments, the probe item may correspond to the header of each column or row of the table. When the probe object is a row header of the table, the probe item may be a column header. On the contrary, when the probe object is a column header of the table, the probe item may be a row header.

The data to be probed refers to data in the first sub-region that the user wants to read, understand, or analyze. For example, the data to be probed may include a data text including financial information, stock market trends, company operations, product sales status, or the like, or a combination thereof.

In some embodiments, for data in a table, the plurality of sub-regions in the first region may be a plurality of columns in the table displaying the data to be probed. The data to be probed in each column may be a group of data to be probed. The header corresponding to each column may be a corresponding probe item, each row in the table may correspond to a probe object, and different rows may correspond to the same or different probe objects.

In some embodiments, the plurality of sub-regions in the first region refer to a plurality of rows in the table displaying the data to be probed. The data to be probed in each row may be a group of data to be probed. The header corresponding to each row is a corresponding probe item, each column in the table corresponds to a probe object, and different columns may correspond to the same or different probe objects.

FIG. 17 is a schematic diagram illustrating an exemplary first region and an exemplary second region according to some embodiments of the present disclosure.

In some embodiments, as shown in FIG. 17, a plurality of groups of data to be probed may be displayed in a first region 1710 of a user interface. A plurality of first sub-regions 1713 may be included in the first region 1710, each of the first sub-regions 1713 may include a group of data to be probed. Different first sub-regions 1713 correspondingly display data texts of data to be probed for different probe items 1712 by the probe object 1711.

In some embodiments, the processor may display the first region in the interface based on a received data display instruction. The data display instruction may be generated based on a preset operation of the user or default settings of the system.

In 1620, at least one probe graph corresponding to one of the probe items may be displayed in the second region.

The second region refers to a region in the user interface in which the probe graph is displayed. In some embodiments, the second region may be located near the first region. For example, as shown in FIG. 17, the second region 1720 may be disposed above the first region 1710 and may display a probe graph corresponding to the probe items 1712. In some embodiments, the second region may also be located on the left, right or below the first region, which is not limited in the present disclosure.

In some embodiments, the second region may be a region above the header of each column in the table, and each column may correspond to one second region. In some embodiments, the second region may also be a region at the left of the header of each row in the table, and each row may correspond to one second region.

The probe graph refers to a graph structure that may be used to represent a probing result of the probe item.

In some embodiments, the probe graph may include a chart that demonstrates a correlation analysis, such as a scatter plot, a heat graph, or the like. In some embodiments, the probe graph may present a data analysis result. More description regarding the data analysis result may be found in FIG. 3 and related description thereof. The correlation between first sub-regions may be observed more intuitively by the user based on the probe graph, thereby simplifying data understanding and analysis.

In some embodiments, the probe graph may be generated based on the data to be probed. For example, the processor may generate a probe graph corresponding to tabular data based on the data analysis result of the data to be probed utilizing a preset data analysis tool of the table. Exemplarily, the preset data analysis tool may include, but not limited to, inserting a pivot table, a pivot chart, or the like.

In some embodiments, the processor may generate the probe graph based on the data to be probed using an image generation model. The image generation model may be a trained machine learning model.

In some embodiments, the processor may determine a graph mode of each of one or more probe graphs based on a type and/or a distribution of the data to be probed.

The type of the data to be probed may include enumeration time, textual information, numerical information, continuous and non-repeating information, etc. The enumeration time refers to data to be probed whose content is a specific time enumeration value, e.g., a date, a month, etc. The textual information refers to data to be probed whose content is a text, e.g., the name of a security, an organization, etc. The numerical information refers to data to be probed whose content is a specific value, e.g., registered capital, paid-up capital, etc. The continuous and non-repeating information refers to data to be probed whose content is continuous and non-repeating, e.g., continuous serial numbers, data with an occurrence frequency of 1 (e.g., continuous trading days, continuous days, continuous months, continuous quarters, and continuous years), etc.

The distribution of the data to be probed refers to a distribution of the data to be probed in the first sub-region, e.g., a proportion, a distribution range, a distribution time interval, whether the distribution is continuous, whether the data is duplicated, or the like.

The graph mode refers to different presentation modes of the probe graph. In some embodiments, the graph mode refers to a type of the probe graph.

In some embodiments, the graph mode may include at least one of a time distribution graph, a text proportion graph, a numerical distribution graph, and a placeholder graph. More description regarding the graph mode may be found in FIGS. 18-21 and related descriptions thereof.

In some embodiments of the present disclosure, according to different graph modes, a more appropriate graph mode can be determined according to the type and distribution of the data to be probed, which is conducive to presenting the features and correlations of the data to be probed.

In some embodiments, the processor may determine the graph mode of the probe graph based on the type and/or distribution of the data to be probed using a preset rule. The preset rule may be set by a human. In some embodiments, the processor may determine a graph mode of the data to be probed based on a preset correspondence between the type and/or distribution of the data to be probed and different graph modes.

In some embodiments, the processor may generate the probe graph in a variety of ways based on the data to be probed and the graph mode. For example, the processor may generate the probe graph based on the data to be probed and the graph mode using the preset data analysis tool. Exemplarily, the processor may determine target data that needs to generate the probe graph in the data to be probed, determine the graph mode of the probe graph in the preset data analysis tool, and generate a graph-generation instruction based on the target data and the graph mode to control the preset data analysis tool to generate the probe graph. For example, the processor may generate the probe graph based on the data to be probed and the graph mode using a preset algorithm or the image generation model.

In some embodiments, the probe graphs corresponding to the data to be probed in the plurality of first sub-regions may have the same graph mode or may have different graph modes.

In some embodiments, in response to a determination that the data to be probed is the enumeration time, the processor may determine that the graph mode is the time distribution graph. In some embodiments, in response to a determination that the data to be probed is the textual information, the processor may determine that the graph mode is the text proportion graph. In some embodiments, in response to a determination that the data to be probed is the numerical information, the processor may determine that the graph mode is the numerical distribution graph. In some embodiments, in response to a determination that the data to be probed is continuous and not repeated, the processor may determine that the graph mode is the placeholder graph.

In some embodiments, in response to an operation of the user, the probe graph may present different display states and display data analysis results corresponding to the different display states.

The following will be illustrated by the time distribution graph, the text proportion graph, the numerical distribution graph, and the placeholder graph, respectively.

The time distribution graph refers to a probe graph that reflects a distribution of enumeration times in the data to be probed.

FIG. 18 is a schematic diagram illustrating an exemplary time distribution graph according to some embodiments of the present disclosure. As shown in FIG. 18, when the data to be probed is an enumeration time, the processor may determine that the graph mode is the time distribution graph. The time distribution graph may be a strip graph, a horizontal axis may be time intervals, and a vertical axis may be an amount of data to be probed located in each time interval. The time interval may be preset, e.g., a month, a week, a 24-hour, or the like. The time interval may also be a specific time point, e.g., Aug. 1, 2024.

In some embodiments, when the data to be probed is determined as the enumeration time, the processor may generate a time distribution graph based on an analysis result of the data to be probed and display the time distribution graph in the second region. The analysis result of the enumeration time may include a division result of the time intervals, an occurrence frequency of data in different time intervals, or the like.

In some embodiments, combined with FIG. 17, each strip in the time distribution graph in a default state may be displayed at the same display degree, and a first preset position (e.g., a lower portion) of the time distribution graph displays time intervals corresponding to left and right-side strips, i.e., a minimum value and a maximum value of time intervals corresponding to a set of data to be probed. When a mouse of the user hovers over a probe sub-graph (i.e., a strip) of the time distribution graph, the time distribution graph may be displayed in a third display state; in the third display state, the hovered strip may be highlighted; a first preset position (e.g., a lower portion) of the time distribution graph may display the time interval corresponding to the strip, and a second preset position (e.g., an upper left portion) may display the occurrence frequency and proportion of the data to be probed corresponding to the strip. When the user clicks on a probe sub-graph (i.e., a strip) of the time distribution graph, the time distribution graph may be displayed in the third display state; in the third display state, the strip may be highlighted, the first preset position (e.g., the lower portion) of the time distribution graph may display a time interval corresponding to the strip, the second preset position (e.g., the upper left portion) may display the occurrence frequency and the proportion of the data to be probed corresponding to the strip, and data to be probed corresponding to the strip (i.e., data to be probed located at the time interval) in the first region may be highlighted.

The text proportion graph refers to a probe graph that reflects a proportion of textual information in the data to be probed.

FIG. 19 is a schematic diagram illustrating an exemplary text proportion graph according to some embodiments of the present disclosure. As shown in FIG. 19, the processor may determine that the graph mode is a text proportion graph when the data to be probed is textual information. The text proportion graph may be a pic graph, a rectangular tree graph, etc. In the pie graph, data to be probed with the same textual information may be a type and may correspond to a sector in the pie graph, and different sectors may indicate proportions of textual information corresponding to different categorization results. The text proportion graph may also include a part tree graph. More description regarding the part tree graph may be found in FIG. 18 and related descriptions thereof.

In some embodiments, when the data to be probed is the textual information, the processor may generate the text proportion graph based on the analysis result of the data to be probed and display the text proportion graph in the second region. The analysis result of the textual information may include a categorization result of the textual information, a count of pieces of different textual information, a proportion of different textual information in all the textual information, or the like.

For example, referring to FIG. 18, in the default state (i.e., in the third display state), each sector in the text proportion graph may be displayed at the same degree display, and a first preset position (e.g., a lower portion) of the text proportion graph may display a text content, a count, and a proportion corresponding to a sector with a largest proportion. When the mouse of the user hovers over a certain sector (i.e., a certain probe sub-graph), the pic graph may be switched to the third display state for display; in the third display state, the sector may be highlighted, the first preset position (e.g., the lower portion) of the text proportion graph may display a text content corresponding to the sector, and a second preset position (e.g., an upper left portion) may display a count of pieces and a proportion of the data to be probed corresponding to the sector. When the user clicks on a sector (i.e., a probe sub-graph), the pic graph may be switched to the third display state and display a data probing result corresponding to the clicking, which is similar to when hovering over the sector, and will not be repeated here.

In some embodiments, after the user clicks on a sector and then hovers the mouse over another sector, both the clicked sector and the hovered sector may be highlighted, and the first preset position or the second preset position of the pic graph may synchronously display the text content, the count, and the proportion of the clicked sector and the hovered sector. For example, the analysis result corresponding to the clicked sector may be displayed on the left side, while the analysis result corresponding to the hovered sector may be displayed on the right side, so as to facilitate the user to compare data.

The numerical distribution graph refers to a probe graph that reflects the distribution of numerical information in the data to be probed.

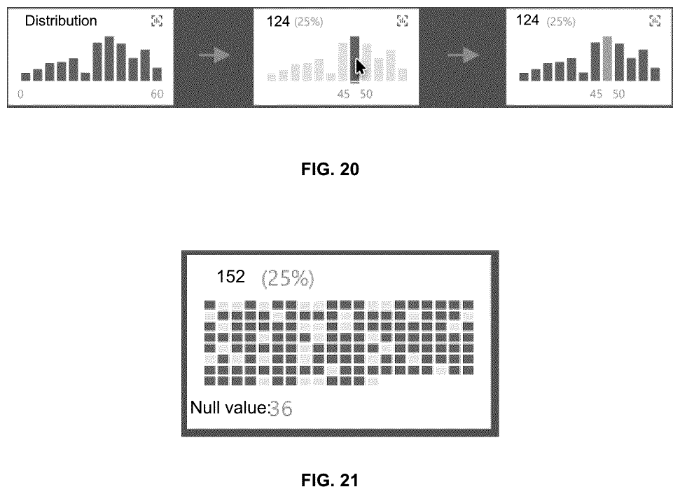

FIG. 20 is a schematic diagram illustrating an exemplary numerical distribution graph according to some embodiments of the present disclosure. In some embodiments, as shown in FIG. 20, when data to be probed is numerical information, the processor may determine that a graph mode is a numerical distribution graph. The numerical distribution graph may be a strip graph, numerical intervals of a horizontal axis of the strip graph may be a preset count of interval segments obtained by rounding the maximum and minimum values of the data to be proved to the left and right, respectively, and dividing the data to be proved. Numerical values of a vertical axis of the strip graph may be an occurrence frequency of the data to be probed in each interval.

For example, referring to FIG. 20, data to be probed in the same numerical interval in the numerical information may form a type and constitute a strip in the numerical distribution graph. Each strip in the numerical distribution graph in a default state may be displayed at the same display degree. A first preset position (e.g., a lower portion) of the numerical distribution graph may displays values corresponding to left and right-side strips. When a mouse of the user hovers over a strip (i.e., a probe sub-graph), the numerical distribution graph may be switched to a third display state. In the third display state, the hovered strip may be highlighted. A first preset position (e.g., a lower portion) of the numerical distribution graph may display a numerical interval corresponding to the strip, and a second preset position (e.g., an upper left portion) may display an occurrence frequency and a proportion of data to be probed corresponding to the strip. When the user clicks on a strip, the numerical distribution graph may be switched to the third display state. In the third display state, the strip may be highlighted, the first preset position (e.g., the lower portion) of the numerical distribution graph may display a numerical interval corresponding to the strip, the second preset position (e.g., the upper left portion) may display the occurrence frequency and the proportion of the data to be probed corresponding to the strip, and data to be probed corresponding to the strip in the first region may be highlighted in the third display state.

In some embodiments, the first preset position and the second preset position may be the same position or different positions.

More descriptions regarding the third display state described above and a fourth display state may be found in FIG. 16 and related descriptions thereof.

The placeholder graph refers to a probe graph that reflects a continuous and non-repeating information distribution feature in the data to be probed.

FIG. 21 is a schematic diagram illustrating an exemplary placeholder graph according to some embodiments of the present disclosure. In some embodiments, as shown in FIG. 21, the processor may determine that the graph mode is a placeholder graph when the data to be probed is continuous and not repeated. For example, when the data to be probed includes continuous serial numbers, a non-repeating time (e.g., continuous trading days, continuous days, continuous months, continuous quarters, and continuous years), and a text with an occurrence frequency of 1, and more than a preset proportion (e.g., 40%) of data in the data to be probed are null values, the processor may determine that the probe graph corresponding to the data to be probed is the placeholder graph.

Distribution features of the data to be probed in the first sub-region corresponding to the placeholder graph may be understood based on the placeholder graph. As shown in FIG. 21, there are 152 pieces of data to be probed in the first sub-region corresponding to the placeholder graph, wherein there are 36 null values, accounting for 25% of the total data in the first sub-region.

In some embodiments, the placeholder graph may embody the distribution features of the data to be probed based on a preset shape. In some embodiments, a preset shape corresponding to a null value may be identified by a preset color. The preset shape and the preset color may be preset by the system or by a human. For example, referring to FIG. 21, the preset shape may be a square, the preset shape corresponding to the null value may be identified by a light color, and the distribution features of the data to be probed may be expressed by the placeholder graph. The preset shape may also be identified in other ways, e.g., a line, a pattern, etc., different from a non-null value.

A size of the preset shape may be determined based on a count of pieces of the data to be probed, e.g., the larger the count, the smaller the preset shape.

In some embodiments, the arrangement of preset shapes in the placeholder graph may include a variety of ways to facilitate the user to view a distribution of localized data. For example, every 20 pieces of data to be probed may be lined up in a column or row. The arrangement may also be automatically adjusted based on a user requirement.

In some embodiments, the processor may divide a preset amount of data to be probed into a partition. The user may click on the data to be probed in each partition to probe the data more specifically, or the user may select a plurality of partitions to probe at the same time. After the processor receives that the user clicks on a partition, only data in the partition selected by the user may be displayed in the placeholder graph, and unselected data may be collapsed or hidden for display.

In some embodiments of the present disclosure, the placeholder graph may be determined by a preset shape and a preset color, so that the user may more intuitively feel the distribution features of the continuous and non-repeating data to be probed.

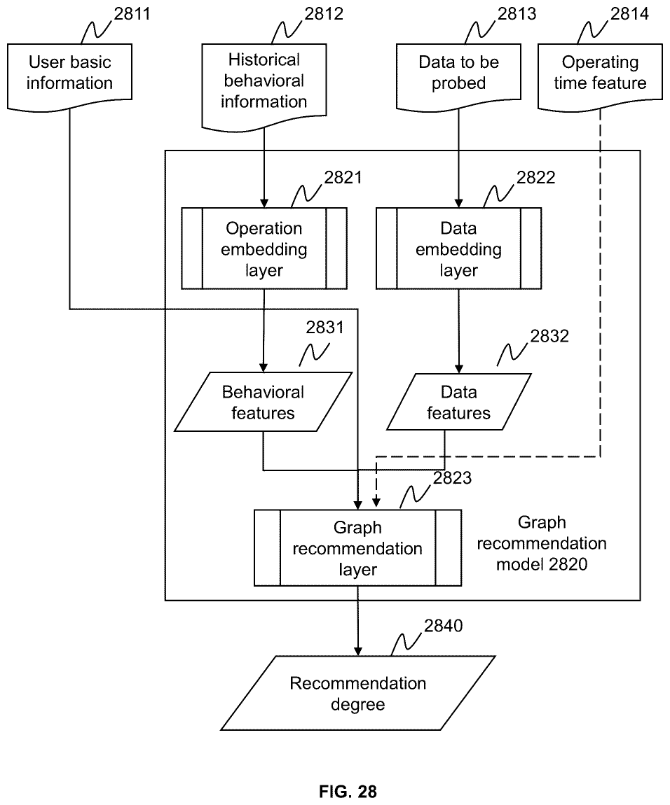

In some embodiments, the processor may determine the probe graph via a graph recommendation model, more of which may be found in FIG. 28 and related description thereof.

In some embodiments of the present disclosure, by determining the graph mode of the probe graph based on the type and/or distribution of the data to be probed, features and correlations of the data to be explored can be better represented.

In some embodiments, the processor may display, in the second region, at least one probe graph corresponding to the probe item in a variety of ways. For example, the processor may determine an order in which the probe graphs are displayed in the second region based on an order in which the probe items are listed. As another example, the processor may display the probe graphs in the second region based on a preset display order. The preset display region may be determined based on the user requirements or default settings of the system.

In some embodiments, the size and dimension of the probe graph may be set by system default or based on user settings. For example, the processor may recognize user operations (e.g., stretching and compression operations on the probe graph) to adjust the size and dimension of the probe graph. By freely adjusting the size of the probe graph by the user, the probe graph can be adapted to different screen sizes and the amount of data to be probed, which helps to meet requirements of different users.

In some embodiments, the probe graph may include a plurality of probe sub-graphs corresponding to the categorization results of the data to be probed, and the processor may display a first portion of a preset count of probe sub-graphs in the second region. In some embodiments, in response to receiving a display switching instruction from the user, a second portion of the preset count of probe sub-graphs may be displayed in the second region to replace the first portion of the preset count of probe sub-graphs More description regarding the probe sub-graph may be found in a later related description.

The first portion of the probe sub-graphs refer to probe sub-graphs of the probe graph displayed in the second region in the default state. For example, assuming that the probe graph includes 40 probe sub-graphs, but only a preset count (e.g., 20) of the probe sub-graphs can be displayed at a time due to the limited size of the second region, then the preset count of the probe sub-graphs displayed in the default state may be the first portion of the probe sub-graphs. The preset count may be adjusted based on the default settings of the system or based on user requirements.

In some embodiments, the processor may determine the preset count based on user historical operation data, current operation data, and/or a current time. For example, the processor may determine the preset count of probe sub-graphs displayed in the second region by processing the user historical operation data, the current operation data, and/or the current time through a machine learning model. Understandably, the operating habits and display requirements may be different for different users and at different times. A count of probe sub-graphs suitable for users to display may be determined more accurately through the machine learning model.

In some embodiments, the count of intervals divided in the numerical or time distribution graph may be a preset count, and the processor may increase the count of intervals in the numerical or time distribution graph when the data to be probed satisfies a preset condition. For example, the preset condition may be that a distribution range of the data to be probed is greater than a range threshold. In some embodiments, the processor may determine the count of intervals based on a user selection.

The display switching instruction refers to an instruction for switching the display state, the display range, and/or the display content of the probe graph. For example, the display switching instruction may include an instruction generated by an operation such as moving the mouse left and right, zooming in or out, dragging a preset control strip, etc.

The second portion of the probe sub-graphs refer to a preset count of probe sub-graphs that are displayed in the second region after the user performs a display switching operation. The second portion of probe sub-graphs may be the same as or completely different from a part of the first portion of the probe sub-graphs. For example, each of the first portion of probe sub-graphs may be different from each of the second portion of probe sub-graphs. As another example, one of the first portion of probe sub-graphs may be the same as one of the second portion of probe sub-graphs.

In some embodiments, referring to FIG. 17, assuming that in the default state, a first portion of probe sub-graphs corresponding to a total of 20 time intervals from 2021 Sep. 1 to 2023 Apr. 1 may be displayed in the time distribution graph, and in response to receiving a instruction to shift the time distribution graph left and right from the user, the processor may update the second region and display a second portion of probe sub-graphs corresponding to other 20 time intervals different from the aforementioned 20 time intervals in the second region. For example, in response to receiving the display switching instruction from the user, the processor may display probe sub-graphs corresponding to a total of 20 time intervals from 2021 Oct. 1 to 2023 May 1 in the second region, at which time partially identical probe sub-graphs (i.e., the probe sub-graphs corresponding to the time intervals from 2021 Oct. 1 to 2023 Apr. 1) exist between the second portion of probe sub-graphs and the first portion of probe sub-graphs. As another example, in response to receiving the display switching instruction from the user, the processor may display probe sub-graphs corresponding to a total of 20 time intervals from 2020 Jan. 1 to 2021 Aug. 1 in the second region, at which time the second portion of probe sub-graphs is completely different from the first portion of probe sub-graphs.

The display switching of the numerical distribution graph may be similar to the display switching of the time distribution graph, which will not be repeated here.

In some embodiments, when receiving a double-click operation of the user on the time distribution graph or the numerical distribution graph, the processor may enlarge the time distribution graph or the numerical distribution graph, and display probe sub-graphs corresponding to all intervals in the enlarged time distribution graph or the enlarged numerical distribution graph.

In some embodiments, each of the numerical distribution graph and the time distribution graph may include a search box. For example, the search box may be hidden in the default state, and the user may double-click a search icon of the search box on the numerical or time distribution graph to expand the search box. After receiving an input of the user in the search box, the processor may locate a distribution interval of data to be probed corresponding to the input in the probe graph (e.g., automatically adjusting the distribution interval to a center of the probe graph and highlighting the distribution interval).

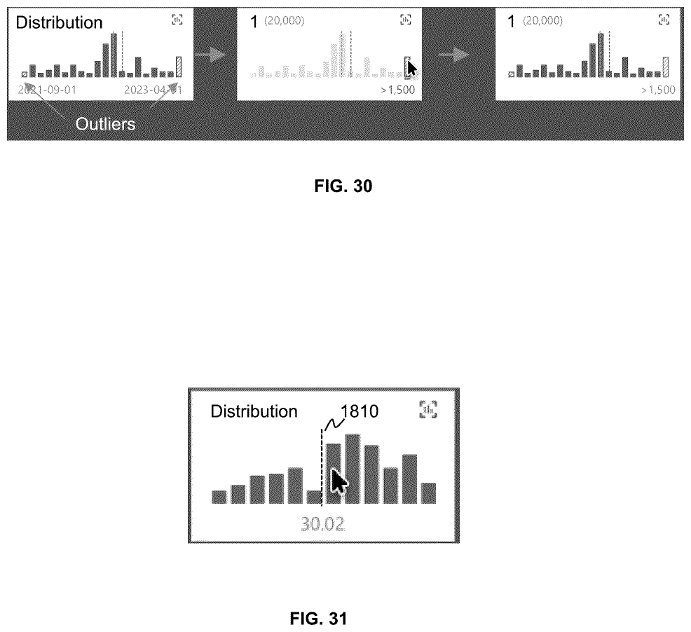

In some embodiments, one or more preset markers may be present at one or more preset positions (e.g., lower left and lower right portions) of the numerical distribution graph. A preset marker may be used to view a situation related to an extreme value in the data to be probed. In some embodiments, the processor may highlight the preset marker when there is an extreme value, and may hide the preset marker from view when there are no extreme values. In some embodiments, when a count of intervals of the numerical distribution graph is greater than a preset count, the user may not be able to directly view the extreme value and may locate the probe sub-graph corresponding to the extreme value by clicking on the preset marker. More description regarding the extreme value may be found in FIG. 30 and related description thereof.

In the case where the amount of data to be probed is particularly large, it may not be possible to adequately represent the probing result of the data to be probed according to the preset count of probe sub-graphs, and it may not be possible to adequately display all probe sub-graphs in the probe graph in a fixation region when the count of probe sub-graphs is large. In some embodiments of the present disclosure, by displaying the first portion of the preset count of probe sub-graphs in the second region; and in response to receiving he display switching instruction from the user, updating and displaying the second portion of the preset count of probe sub-graphs in the second region, the data to be probed can be fully analyzed based on the user requirement, which helps to improve the user experience.

In some embodiments, the data processing result includes a data probing result, and in response to receiving the second operation instruction from the user, the data processing result may be displayed and a display state of the visualization region may be updated, which includes following operation 1630.

In 1630, in response to receiving the second operation instruction for one of the first region and the second region from the user, the data probing result corresponding to the second operation instruction may be displayed; and a display state of another of the second region and the first region may be updated.

In some embodiments, the second operation instruction may include an instruction generated based on an operation of the user on the second region or the first region. The second operation instruction may be used to direct to update the display of the first region and/or the second region. For example, the second operation instructions may include an instruction generated by hovering, clicking, and other operations of a mouse.

The data probing result refers to a probing result corresponding to the second operation instruction. For example, the data probing result may include a categorization of the data to be probed in the first sub-region, a count of categorizations, and textual information of each categorization, a data analysis result (e.g., a proportion, a specific value, or the like), a data distribution result (e.g., a division of intervals, an amount of data in each interval, an occurrence frequency of the data, or the like), or the like, or a combination thereof.

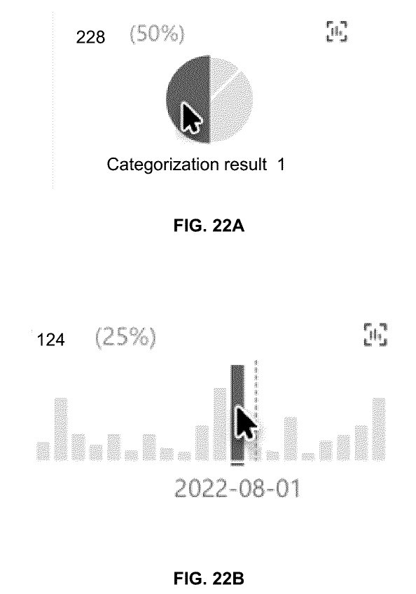

In some embodiments, the processor may display the data probing result of the second operation instruction at a preset position, which may be set by the system or by a human. For example, the processor may display a specific analysis result of textual information in an upper left portion of a text proportion graph, and display the textual information in a lower portion of the text proportion graph. Exemplarily, referring to FIG. 22A, the upper left portion of the text proportion graph displays an amount and a proportion of data to be probed corresponding to a selected sector, and the lower portion of the text proportion graph displays a textual content of a categorization result 1 corresponding to the selected sector.

In some embodiments, the data probing result may include a first analysis result and a second analysis result, the probe graph may include a first probing region and a second probing region, and the processor may display the first analysis result in the first probing region and display the second analysis result in the second probing region.

The first analysis result may include a categorization name and/or interval information corresponding to the probe sub-graph, and the second analysis result may include detailed information of the categorization and/or partition corresponding to the probe sub-graph. For example, the second analysis result may include a proportion of a categorization and a data amount in the categorization, a data amount in an interval and a proportion of the partition, etc.

The probe sub-graph may be a sub-region of the probe graph. For example, the probe sub-graphs may include sectors in a pic graph, strips in a numerical distribution graph, or the like. In some embodiments, at least one probe sub-graph may correspond to at least one categorization result of the data to be probed.

There may be a plurality of types of categorization results of the data to be probed based on types of the data to be probed, e.g., a categorization of text data, numerical partitioning of numerical data, temporal partitioning of enumeration time, etc.

The first probing region refers to a region of the probe graph used to display the first analysis result, and the second probing region refers to a region of the probe graph used to display the second analysis result. For example, the first probing region may be located in a lower portion of the probe graph, and the second probing region may be located in an upper left portion of the probe graph. The positions of the first probing region and the second probing region may be set by the system by default or preset by user requirements, and may be the same or different.

In some embodiments, the processor may, based on a second operation instruction for a certain probe sub-graph of the probe graph from the user, display the first analysis result corresponding to the probe sub-graph in the first probing region and display the second analysis result corresponding to the probe sub-graph in the second probing region. FIG. 22A is a schematic diagram illustrating an exemplary process for displaying a data probing result of a second operation instruction according to some embodiments of the present disclosure. In some embodiments, referring to FIG. 22A, when the processor receives a second operation instruction (e.g., clicking on a certain probe sub-graph) from the user for the text proportion graph in the second region, a first analysis result (e.g., a categorization name corresponding to the probe sub-graph, the categorization result 1) corresponding to the aforementioned second operation instruction may be displayed in the first probing region (e.g., a lower portion of the probe graph), and a second analysis result (e.g., a proportion of the categorization result 1 corresponding to the probe sub-graph and an amount of data to be probed) corresponding to the aforementioned second operation instruction may be displayed in the second probing region (e.g., an upper left portion of the probe graph).

FIG. 22B is a schematic diagram illustrating another exemplary process for displaying a data probing result of a second operation instruction according to some embodiments of the present disclosure. In some embodiments, referring to FIG. 22B, when the processor receives a second operation instruction (e.g., clicking on a certain probe sub-graph) from the user for the time distribution graph in the second region, a first analysis result (e.g., a time interval of 2022 Aug. 1 corresponding to the probe sub-graph) corresponding to the second operation instruction may be displayed in the first probing region (e.g., a lower portion of the probe graph), and a second analysis result (e.g., a data proportion of the time interval of 2022 Aug. 1 corresponding to the probe sub-graph and an amount of data to be probed) corresponding to the second operation instruction may be displayed in the second probing region (e.g., an upper left portion of the probe graph).

In some embodiments of the present disclosure, by displaying the first analysis result in the first probing region and the second analysis result in the second probing region, a user may more quickly and intuitively obtain the data probing result corresponding to the probe sub-graph. In some embodiments, the processor may receive the second operation instruction from the user for one of the second region and the first region to update the display state of another of the second region and the first region. In some embodiments, the processor may receive an operation instruction of the user for one of the second region and the first region, and update the display state of another of the second region and the first region based on the third display state. More descriptions regarding the third display state may be found in FIG. 27A, FIG. 27B, and related descriptions thereof.

For example, after receiving the second operation instruction from the user for the second region, the processor may update the display state of the probe sub-graph corresponding to the second operation instruction and/or the display state of the data to be probed in the first region corresponding to the categorization result of the probe sub-graph to be highlighted. As another example, after receiving the second operation instruction from the user for the first region, the processor may update the display state of the data to be probed corresponding to the second operation instruction in the first region and/or the display state of the probe sub-graph corresponding to the data to be probed in the second region to be highlighted.

In some embodiments, the processor may update the display at least one probe graph corresponding to the second operation instruction and/or a region corresponding to a probing target in the first region based on the third display state, and more description may be found in FIG. 17 and related description thereof.

In some embodiments, the second region may include a hide control and a move control. In some embodiments, in response to receiving a ninth operation instruction from the user, the processor may trigger the hide control to adjust the display state of the data to be probed in the first region; and/or trigger the move control to adjust a display order of at least one first region and at least one second region.

The ninth operation instruction refers to an instruction regarding target extraction. In some embodiments, the ninth operation instruction may include an instruction for extracting target data. The target data refers to data to be probed used for centralized analysis. In some embodiments, the processor may determine the target data by receiving the second operation instruction from the user. For example, the processor may designate data to be probed clicked by the user as the target data. As another example, the processor may designate data to be probed corresponding to a probe sub-graph clicked by the user as the target data.

In some embodiments, the user may generate the ninth operation instruction by clicking on icons corresponding to the hide control and/or the move control displayed in the second region.

The hide control refers to a control used to adjust the display state of the data to be probed in the first region.

In some embodiments, when the ninth operation instruction is to click on the hide control, the processor may trigger the hide control to adjust the display state of the data to be probed in the first region. For example, the processor may hide non-target data in the first region.

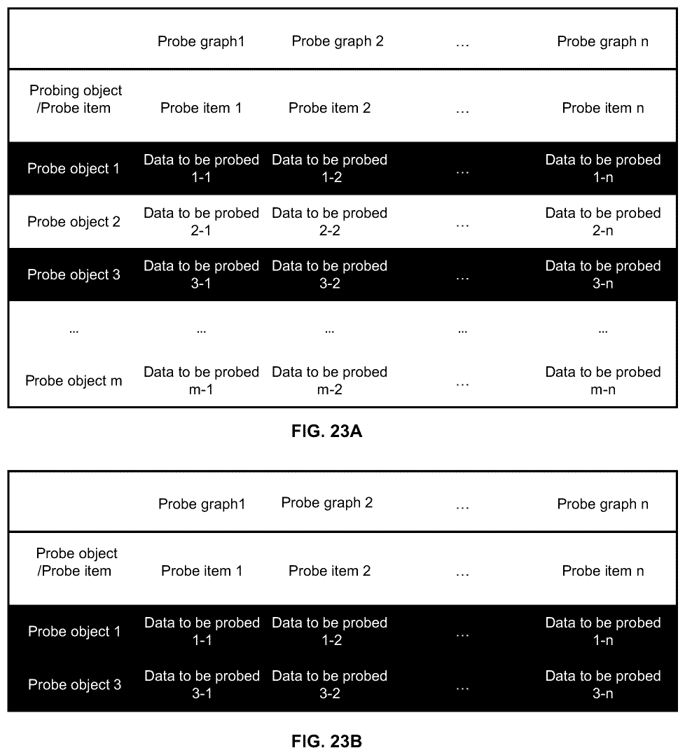

FIG. 23A is an exemplary schematic diagram illustrating target data in a first region according to some embodiments of the present disclosure. FIG. 23B is a schematic diagram illustrating an exemplary process for triggering a hide control to adjust a display state of a first region according to some embodiments shown in the present disclosure.

As shown in FIG. 23A, the first region may include target data (i.e., data of two rows corresponding to a probe object 1 and a probe object 3) corresponding to a second operation instruction and non-target data, wherein the target data may be highlighted and the non-target data may be displayed to the same degree. When the user triggers the hide control, as shown in FIG. 23B, the non-target data in the first region may be hidden, and the target data may be highlighted centrally in the first region.

In some embodiments, the hide control may be used to hide a first sub-region. The processor may trigger the hide control to hide a first sub-region selected by the user based on a user operation so that the user can more intently view the first sub-region of the second target data, reducing visual distractions.

The move control refers to a control for adjusting the display order of the at least one first region and the at least one second region.

In some embodiments, when the ninth operation instruction is to click on the move control, the processor may trigger the move control to adjust the display order of the at least one first region and the at least one second region. After clicking on the move control, the processor may receive a move operation by the user on the probe graph or the data to be probed to adjust the display order of the at least one first region or the at least one second region. The move operation may include dragging and dropping the probe graph, the data to be probed, or the like.

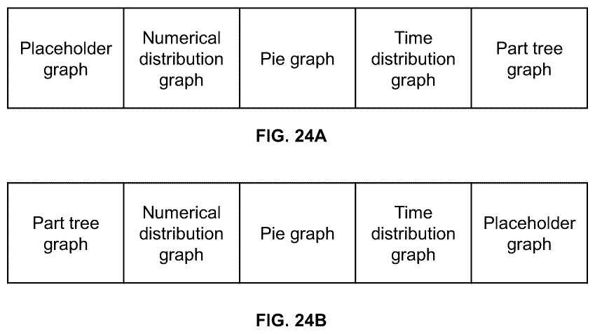

FIG. 24A is a schematic diagram illustrating an exemplary second region according to some embodiments of the present disclosure. FIG. 24B is a schematic diagram illustrating an exemplary process for adjusting a display order of a second region according to some embodiments of the present disclosure. In some embodiments, as shown in FIG. 24A, the display order of probe graphs in the second region may be as follows: a placeholder graph, a numerical distribution graph, a pie graph, a time distribution graph, and a part tree graph. If the user wants to analyze data probing results of the part tree graph and the placeholder graph at the same time, when the processor recognizes that the user has triggered the move control (e.g., dragging and dropping the part tree graph to the position of the placeholder graph), as shown in FIG. 24B, the processor may replace the display order of the probe graphs in the second region as follows: the part tree graph, the numerical distribution graph, the pie graph, the time distribution graph, and the placeholder graph, and at this time, the part tree graph and the numerical distribution graph may be centrally displayed.

In some embodiments of the present disclosure, by triggering the hide control to adjust the display state of the data to be probed in the first region to centrally display the target data, and/or triggering the move control to adjust the display order of the at least one first region and the at least one second region to centrally display the probe graph, the content that the user wants to view may be centrally distributed, which helps the user to read and understand the data in a centralized manner, thereby meeting different usage requirements of the user.

In some embodiments, a data viewing panel may be included in the visualization region of the user interface. The data viewing panel may be a panel for centralized viewing the target data. In some embodiments, the processor may receive a selection instruction and a panel operation instruction from the user to determine whether or not to pop up the data viewing panel. The selection instruction may be generated based on a selection operation of the user on the target data, and the panel operation instruction refers to an instruction generated based on an operation of the user of clicking on a data viewing panel pop-up button. After popping up, the data viewing panel may be dragged around in the user interface without affecting other functions. According to the data viewing panel, the user can conveniently view the target data in a centralized manner without affecting the data source.

In some embodiments of the present disclosure, by displaying data text in a plurality of first sub-regions and displaying the probe graph in the second region, and receiving the operation instructions from the user and displaying data probing results corresponding to the operation instructions, data visualization and interactive probing can be achieved. The user can more intuitively probe and analyze the data to be probed, and interact with the data through the operation instructions to obtain required information and results.

In some embodiments, the processor may display a range control strip of one or more probe graphs in the second region, and in response to receiving an eighth operation instruction for the range control strip, dynamically update a display state of the one or more probe graphs and/or the first region.

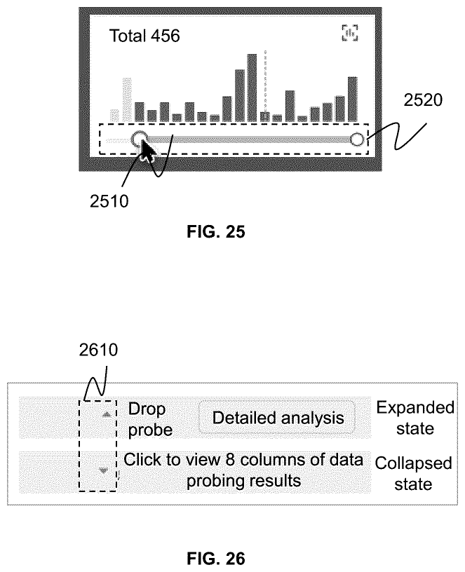

The range control strip refers to a setting strip for controlling the display of intervals of the probe graph. FIG. 25 is a schematic diagram illustrating an exemplary range control strip according to some embodiments of the present disclosure. In some embodiments, referring to FIG. 25, a long strip 2520 in the dashed box below the probe graph is the range control strip.

The eighth operation instruction refers to an operation instruction regarding movement. In some embodiments, the eighth operation instruction may include an instruction for moving the range control strip. In some embodiments, the eighth operation instruction may be generated based on the operation of the user of dragging and dropping the range control strip. In some embodiments, the processor may move the control strip based on the eighth operation instruction to determine a selected range of the probe graph. In some embodiments, the eighth operation instruction may also be generated through hovering the mouse over the range control strip and scrolling a mouse wheel by the user.

In some embodiments, the processor may dynamically update the display state of the probe graph and/or the first region based on the recognized eighth operation instruction. For example, the probe sub-graph moved over based on the eighth operation instruction may be grayed out, the corresponding data to be probed in the first region may be grayed out at the same time; and probe sub-graphs that have not been moved over and corresponding data to be probed in the first region may remain highlighted.

In some embodiments, referring to FIG. 25, when the processor recognizes that the mouse of the user hovers over the range control strip, the range control strip may become larger; and when the processor recognizes that the range control strip is dragged, bubbles 2510 may appear on the range control strip and move following the range control strip. The movement of the range control strip stays aligned with strips in the probe graph. In some embodiments, the processor may gray out strips that the range control strip has moved over, and simultaneously gray out the data to be probed in the first region corresponding to the strips that the range control strip has moved over; and the strips that have not been moved over remain selected, and data to be probed in the first region corresponding to the strips that have not been moved over remains highlighted.

In some embodiments of the present disclosure, by receiving the eighth operation instruction for the range control strip to update the display state of the probe graph and/or the first region, the user may be free to adjust and control the display range of the probe graph to meet specific needs and concerns, which helps to provide a more flexible and personalized experience on data probing and analysis and helps the user better understand and interpret data.

In some embodiments, the processor may control a display mode of at least one probe graph in the second region through a preset control marker.

The preset control marker refers to a marker used to control the display mode of the probe graph in the second region, and the preset control marker may be obtained based on a system or human preset. The display mode refers to whether the probe graph is displayed expanded or folded in the second region. When the probe graph is displayed expanded, the complete probe graph and relevant data in the graph are visible; and when the probe graph is displayed folded, only the preset control marker is visible.

In some embodiments, the processor may control the display mode of the probe graph in the second region by receiving a click operation from the user on the preset control marker. For example, when the probe graph is displayed expanded currently, the probe graph may switch to be displayed folded (i.e., displayed in a collapsed state) by clicking the preset control marker once. Similarly, when the probe graph is displayed folded currently, the probe graph may switch to be displayed expanded by clicking the preset control marker once.

FIG. 26 is a schematic diagram illustrating an exemplary preset control marker according to some embodiments of the present disclosure.

In some embodiments, as shown in FIG. 26, the display mode of the probe graph in the second region may include an expanded state and a collapsed state, and the preset control marker may be a triangular marker 2610 in FIG. 26. In the expanded state, the probe graph may be displayed in the second region, and the user may switch the display mode to be collapsed state by clicking on the preset control marker, and the probe graph may be hidden in the second region in the collapsed state.

In some embodiments of the present disclosure, the display mode of the probe graph in the second region may be controlled by the preset control marker, and the user can switch the display mode of the probe graph according to the actual requirement, which satisfies a visualization requirement of the user for the probe graph while simplifying the interface.

In some embodiments, the second region may include a memory control, and in response to receiving a tenth operation instruction from the user, the processor may trigger the memory control; identify a target history operation corresponding to the tenth operation instruction; and switch the display of the first region and the second region to a target display state corresponding to the target history operation.

The memory control refers to a control that may be used to determine a history operation and a history display state corresponding to the history operation. In some embodiments, the memory control may integrate history operations and history display states of the user at different times. The history operations may include user historical probing operations, e.g., clicking on or hovering over the probe sub-graph, etc. The history display state may include display states of the first region and the second region corresponding to the history operation.

The tenth operation instruction refers to an instruction regarding triggering the memory control. In some embodiments, the tenth operation instruction may include an instruction for triggering the memory control. In some embodiments, the tenth operation instruction may include clicking on the memory control.

The target history operation refers to a history operation that the user wants to select based on a current tenth operation instruction.

In some embodiments, in response to the tenth operation instruction triggering the memory control, the processor may receive a selection operation of the user on the memory control, and select one of a plurality of history operations integrated by the user from the memory control as the target history operation. The user may select the target history operation based on a time corresponding to each of the history operations based on a requirement.

The target display state refers to a display state corresponding to the target history operation.

In some embodiments, the processor may switch the current display states of the first region and the second region to the target display state corresponding to the target history operation and display a history data probing result corresponding to the target display state.

In some embodiments of the present disclosure, the memory control is triggered by the tenth operation instruction, and then the display states of the first region and the second region are switched, and display states of the first region and the second region corresponding to the historical operation and history data probing results corresponding to the display states are displayed according to a requirement, which can satisfy a requirement of the user for viewing the data to be probed under a same condition, and reduce a time and workload of repeated operations of the user simultaneously.

In some embodiments, the processor may perform aggregation operations such as summing, averaging, counting, or the like, on the data to be probed in the first sub-region selected by the user through a preset window gadget or a preset key combination, and display a corresponding result in the second region. The user may quickly obtain overall statistical information of the data to be probed in the first sub-region, which can simplify the user operation.

It should be noted that the foregoing descriptions of the process may be intended to be exemplary and illustrative only and does not limit the scope of application of the present disclosure. For those skilled in the art, various modifications and changes can be made under the guidance of the present disclosure. However, these modifications and changes remain within the scope of the present disclosure.

FIG. 27A is a schematic diagram illustrating an exemplary process for updating a display state of another region of a second region and a first region according to some embodiments of the present disclosure.

In some embodiments, the probe graph may include at least one probe sub-graph, and the at least one probe sub-graph may correspond to at least one categorization result of the data to be probed. In some embodiments, the processor may determine a probing target corresponding to a second operation instruction, and update and display, based on a third display state, at least one probe graph corresponding to the second operation instruction and/or a region corresponding to the probing target in a first region.

The probing target may characterize data reflected by a target (e.g., a probe sub-graph or a certain row in the first region) in the first region and/or the second region corresponding to the second operation instruction. In some embodiments, the probing target may include a target probe object and/or a target categorization result. The target probe object refers to a probe object to which the data to be probed corresponding to the operation instruction belongs. That is, there may be a subordinate relationship between each piece of data to be probed and the probe object, e.g., registered capital of Company A, wherein the registered capital is the data to be probed, and the Company A is a probe item. The target categorization result refers to a categorization result corresponding to the probe sub-graph corresponding to the operation instruction.

Taking tabular data as an example, the target probe object refers to a probe object corresponding to a row or a column in a table in which the data to be probed corresponding to the second operation instruction are located; and the target categorization result refers to a categorization corresponding to a probe sub-graph corresponding to the second operation instruction. For example, the second operation instruction of the user may be a click operation on the probe sub-graph, and the target categorization result may be a categorization result corresponding to the probe sub-graph. As another example, the second operation instruction of the user may be a hover operation on the data to be probed, and the target probe object may be a probe object corresponding to a row or column where the data to be probed is located in the table.

The third display state refers to highlighting a relevant content of the probing target (e.g., the target probe object or the target categorization result) corresponding to the second operation instruction. The relevant content of the probing target may include data to be probed corresponding to the target probe object and/or a probe sub-graph in a probe graph corresponding to the target categorization result.

In some embodiments, the third display state may be set by system default or based on a requirement. For example, the third display state may be to highlight the probe sub-graph corresponding to the second operation instruction in the second region and the data to be probed corresponding to the second operation instruction in the first region in a highly saturated color, in a high brightness, flashing, enlarged, etc.

For example, when the first region or the second region is switched to the third display state in response to the second operation instruction, the probe sub-graph in the probe graph corresponding to the second operation instruction or the data to be probed in the first region corresponding to the second operation instruction may be highlighted (i.e., displayed in a highly saturated color, enlarged, etc.), while other probe sub-graphs in the probe graph or other data to be probed in the first region may remain grayed out, low brightness or not enlarged, etc.

In some embodiments, when the third display state is to display the relevant content of the probing target corresponding to the second operation instruction in a highly saturated color, the processor may set a color display rule for the probe graph or the data to be probed based on a variety of perspectives (e.g., a date range, a numerical threshold, a specific keyword, etc.). Probe sub-graphs or pieces of data to be probed that satisfy different color display rules may be highlighted in different colors in the first region and/or the second region. For example, the color display rule may be that the data to be probed exceeding a numerical threshold is displayed in red, and the data to be probed below the numerical threshold is displayed in green. As another example, the color display rule may be that probe sub-graphs that satisfy a particular keyword are displayed in orange, etc.

In some embodiments, the processor may identify an operation position of the second operation instruction to determine at least one probe graph and/or at least one probing target in the first region corresponding to the second operation instruction, and then update the region corresponding to the probing target to be highlighted.

For example, as shown in FIG. 27A, the second operation instruction from the user is a hover operation on the data to be probed, and the processor may determine a probing target corresponding to the operation position of the second operation instruction as a table row in which the data to be probed is located, and update that table row to be highlighted.

In some embodiments, the processor may identify an operation mode of the second operation instruction, and in response to receiving a sixth operation instruction, determine whether to update the third display state based on the operation mode of the second operation instruction.

In some embodiments, the operation mode of the second operation instruction may include a user operation mode corresponding to the second operation instruction. More description regarding the operation mode may be found in FIG. 3 and related description thereof. In some embodiments, the operation mode may include a hover mode and a selection mode. The hover mode refers to an operation mode performed by hovering over a mouse; and the selection mode refers to an operation mode performed by clicking using a mouse. In some embodiments, the processor may identify the operation mode based on a user operation. For example, when the mouse is located at a certain position and has not been clicked or moved within a preset time, it may be determined that the mouse is hovering, and the processor may identify the operation mode of the operation instruction as the hover mode.

The sixth operation instruction refers to an operation instruction about ending an operation. In some embodiments, the sixth operation instruction may include an instruction for the user to end a current operation. For example, the sixth operation instruction may include an instruction of user removing the mouse.

In some embodiments, display states of the first region and/or the second region correspond to operation modes of different second operation instructions may be different. After receiving the sixth operation instruction, the processor may determine whether to update the third display state based on the operation mode of the second operation instruction.

In some embodiments, if the operation mode of the second operation instruction is a hover mode, in response to receiving the sixth operation instruction, the processor may update the third display state to a fourth display state.

The fourth display state means that all contents in the first region and second region are displayed to the same degree (i.e., neither is highlighted). For example, in the fourth display state, the data to be probed in the first region or the probe sub-graphs of the probe graph in the second region may be displayed with the same saturation, the same brightness, the same display size, or the like.

In some embodiments, continuing to refer to FIG. 27A, when the mouse hovers over a table row in FIG. 27A (i.e., in the hover mode), the first region may be switched to the third display state, and the hovered table row may change from a grayed-out state to a highlighted display; and when the sixth operation instruction is received (i.e., the mouse is moved away from the table row), the table row may resume the grayed-out state, and the first display state of the first region may be switched to the fourth display state.

In some embodiments of the present disclosure, when the operation mode of the second operation instruction is the hover mode, in response to receiving the sixth operation instruction, the third display state may be updated to the fourth display state, which can promptly update the display content according to the second operation instruction from the user, highlight the data the user wants to probe, and provide a better user experience.

In some embodiments, when the operation mode of the second operation instruction is the selection mode, in response to receiving the sixth operation instruction, the display states of the first region and the at least one probe graph corresponding to the second operation instruction may maintain unchanged.

FIG. 27B is a schematic diagram illustrating another exemplary process for updating a display state of another region of a second region and a first region according to some embodiments of the present disclosure.

For example, referring to FIG. 27B, when the mouse is clicked on a table row in FIG. 27B (i.e., in the selection mode), the first region may be switched to the third display state, at which time the clicked table may be highlighted; and when the sixth operation instruction is received (i.e., the mouse is moved away from the table row), the table row may remain highlighted, i.e., the first region remains in the third display state.

In some embodiments of the present disclosure, when the operation mode of the second operation instruction is the selection mode, the display states of the first region and the at least one probe graph corresponding to the second operation instruction may remain unchanged after the user removes the mouse, which can enable the user-selected probing target to maintain the third display state, thereby providing a better user experience.

By setting the third display state to be switched or not switched after the end of the second operation instruction in different operation modes of the second operation instruction, a flexible and intuitive operation experience can be provided for the user.

In some embodiments, in response to a determination that the operation mode of the second operation instruction is the selection mode and the second operation instruction corresponds to a plurality of probe sub-graphs, the processor may display the second region and the first region based on a reference display mode.

The reference display mode refers to a pre-set display mode of the second region and the first region. In some embodiments, the reference display mode may include one of an intersection display mode, a concatenation display mode, and a complementary display mode. Different display modes have different display colors, different display brightnesses, or the like.

The intersection display mode refers to a display mode updating intersections of a plurality of probing targets corresponding to a plurality of probe graphs corresponding to the second operation instruction to be highlighted. For example, if the processor recognizes that the user has clicked to select one of a plurality of probe sub-graphs at the same time, and if a portion of a plurality of pieces of data to be probed corresponding to the plurality of probe sub-graphs has an intersecting relationship (e.g., the probe objects are the same), the portion of the plurality of pieces of data to be probed with the intersecting relationship may be displayed in a color (e.g., red) defaulting setted.

The concatenation display mode refers to a display mode updating concatenations of a plurality of probing targets corresponding to a plurality of probe graphs corresponding to the second operation instruction to be highlighted. Continuing with the above example, if the pieces of data to be probed corresponding to the plurality of probe sub-graphs are in a parallel relationship (e.g., the probe objects are different), i.e., there is no intersection, the pieces of data to be probed that have the parallel relationship may be displayed in different set colors for distinction.

The complementary display mode refers to a display mode updating complement sets of a plurality of probing targets corresponding to a plurality of probe graphs corresponding to the second operation instruction to be highlighted. Continuing with the above example, if a piece of data to be probed corresponding to a certain probe sub-graph among the data to be probed corresponding to the plurality of probe sub-graphs is a complementary illustration of a piece of data to be probed corresponding to another probe sub-graph, or the two pieces of data to be probed complement each other, the two probe sub-graphs and the data to be probed corresponding to the two probe sub-graphs may be displayed in a color.

In some embodiments, the processor may determine the reference display mode based on a data relationship and/or a user operation. The data relationship refers to whether there is an intersection relationship, a concatenation relationship, or a complementary relationship between a plurality of pieces of data to be probed in different first sub-regions in the first region corresponding to a selected probe sub-graph. The processor may determine reference display modes corresponding to different data relationships.

In some embodiments of the present disclosure, the second region and the first region may be displayed based on the reference display mode, and by determining the reference display mode of the second region and the first region through the data relationship and/or the user operation, the user can customize the display mode that may be currently required, which helps to better display the data to be probed and improve the efficiency of data understanding and analysis.

In some embodiments of the present disclosure, in response to receiving the sixth operation instruction, whether to update the third display state may be determined based on the operation mode of the second operation instruction, which can determine whether to update the display content in a timely manner based on the sixth operation instruction from the user, thereby providing a better user experience.

In some embodiments of the present disclosure, by updating and displaying at least one probe graph corresponding to the second operation instruction and/or a region corresponding to the probing target in the first region based on the third display state, the display state of the region corresponding to the probing target may be updated in real time, the data probing result can be intuitively displayed, and a more accurate and personalized mode of data probing can be provided, which helps the user to obtain the desired information according to requirements and interests.

FIG. 28 is a schematic diagram illustrating an exemplary graph recommendation model according to some embodiments of the present disclosure.

In some embodiments, as shown in FIG. 28, the processor may determine a graph mode of a probe graph and a recommendation degree 2840 based on user basic information 2811, historical behavioral information 2812, and data to be probed 2813, through a graph recommendation model 2820.

In some embodiments, the graph recommendation model 2820 may be a machine learning model, e.g., a Recurrent Neural Network (RNN) model, etc.

In some embodiments, an input of the graph recommendation model 2820 may include the user basic information 2811, the historical behavioral information 2812, and the data to be probed 2813; and an output of the graph recommendation model 2820 may include the graph mode of the probe graph and the recommendation degree 2840.

The user basic information refers to basic information related to a user. For example, the user basic information may include the occupation, industry background, personal preferences, or the like, or a combination thereof, of the user. In some embodiments, the processor may obtain the user basic information input by the user via a user terminal.

The historical behavioral information refers to information related to history operations of the user, e.g., historical selections, operations, and browsing behaviors of the user in a user interface. The processor may obtain the historical behavioral information based on historical data.

More description regarding the data to be probed may be found in FIGS. 16-FIG. 17 and related descriptions thereof. More description regarding the graph mode may be found in FIGS. 18-21 and related descriptions thereof.

The recommendation degree corresponding to the graph mode refers to a recommendation degree for each feasible graph mode when determining the graph mode for the data to be probed. In some embodiments, the recommendation degree may be a recommendation score.

In some embodiments, the graph recommendation model 2820 may include an operation embedding layer 2821, a data embedding layer 2822, and a graph recommendation layer 2823.

In some embodiments, the operation embedding layer 2821 may be a machine learning model, e.g., a recurrent neural network model. In some embodiments, an input of the operation embedding layer 2821 may include the historical behavioral information 2812; and an output may include behavioral features 2831. The behavioral features refer to feature information related to a historical behavior of the user.

In some embodiments, the data embedding layer 2822 may be a machine learning model, e.g., a recurrent neural network model. In some embodiments, an input of the data embedding layer 2822 may include the data to be probed 2813; and an output may include data features 2832. The data features refer to feature information related to the data to be probed. For example, the data features may be a feature vector including elements such as a data type, a data amount, a data distribution pattern, or the like, of the data to be probed.

In some embodiments, the graph recommendation layer 2823 may be a machine learning model, e.g., a recurrent neural network model. In some embodiments, an input of the graph recommendation layer 2823 may include the user basic information 2811, the behavioral features 2831, and the data features 2832; and an output may include the graph mode of the probe graph and the recommendation degree 2840.

In some embodiments, the input of the graph recommendation layer 2823 may also include an operating time feature 2814.

The operating time feature refers to a feature that relate to a time at which the user performs a probing operation on the probe graph. For example, the operating time feature may include a feature of the time at which the user performs probing operations in different graph modes when the user selects different graph modes for the same type of data to be probed.

In some embodiments, the operating time feature may include a total operation time and a dwell time. The total operation time refers to a total time for the user to select different graph modes for the same type of data to be probed to perform the probing operations. The dwell time refers to a pause time when the user does not perform any operations during probing.

When performing the probing operations for different graph modes for the same type of data to be probed, the longer the total operation time and the dwell time of a certain graph mode is, the more difficult for the user to perform the probing operations based on the graph mode may be. In some embodiments of the present disclosure, the operating time features may be input into the graph recommendation layer, which can make the recommendation degree of the graph mode output by the graph recommendation layer correlate with the operating time features, take into account the differences in the operating time features of different users for different probe graphs, and help improving the accuracy of the graph mode recommendation. For example, in the operating time features, the longer the total operation time and the dwell time of a graph mode is, the output graph recommendation degree corresponding to the graph mode may be appropriately reduced.

In some embodiments, the processor may obtain the graph recommendation model through joint training of the operation embedding layer, the data embedding layer, and the graph recommendation layer based on a plurality of second training samples with a second label.

Each of the second training samples may include sample user basic information, sample historical operation data at a first historical time period, sample data to be probed, and/or sample operating time features, and the second training samples may be obtained based on historical data. The second label may be a graph mode actually selected by the user in a second historical time period and an actual recommendation degree. In some embodiments, the processor may obtain a proportion of a count of times a certain graph mode was selected by the user during the second historical time period to a total count of times all of the graph modes were selected as the actual recommendation degree corresponding to the graph mode. The second historical time period is later than the first historical time period.

A process of joint training may include: designating the sample historical operation data of the first historical time period and the sample data to be probed as inputs of an initial operation embedding layer and an initial data embedding layer, respectively; designating behavioral features and data features output by the initial operation embedding layer and the initial data embedding layer, sample user basic information, and/or sample operating time features as inputs of an initial graph recommendation layer to determine an output of the initial graph recommendation layer; and constructing a loss function based on the output of the initial graph recommendation layer and the first label, iteratively updating parameters of the initial operation embedding layer, the initial data embedding layer, and the initial graph recommendation layer based on the loss function, until a condition is met, and obtaining a trained graph recommendation model, wherein the condition may include the loss function being less than a threshold or converging, a count of training iterations reaching a threshold, etc. In some embodiments, the processor may periodically perform augmentation training on the graph recommendation layer during applications of the graph recommendation model. An input of the augmentation training may include personalized data for each user, i.e., user basic information, operational data during actual use, and/or the data to be probed. The process of augmentation training may be similar to the training of the graph recommendation model, which can be seen in the previous description.

The period of the augmentation training may be determined based on user feedback. For example, the better the user feedback, the longer the period of the augmentation training.

In some embodiments of the present disclosure, the graph recommendation model may be set with different layers to handle different types of inputs, which can improve data processing efficiency.

In some embodiments of the present disclosure, based on the user basic information, the historical behavioral information, and the data to be probed, the graph mode and the corresponding recommendation degree of the probe graph may be determined using the graph recommendation model, which can utilize the self-learning capability of machine learning to improve the efficiency and accuracy of determining the graph mode (i.e., the corresponding recommendation degree) of the probe graph. At the same time, the user can choose the graph mode of the probe graph based on the output results of the graph recommendation model, which helps to improve the user.

In some embodiments, when a count of categorization results of the data to be probed is greater than a preset value, the probe graph may include a part tree graph, and in response to receiving a seventh operation instruction, the processor may change an acreage and/or a count of parts of the part tree graph.

The preset value may be preset by the system or by a human. For example, the preset value may be 10.

The part tree graph refers to a tree graph including a plurality of parts displaying a size and a proportion of the data to be probed. In some embodiments, the part tree graph may include a rectangular tree graph. In some embodiments, each of the parts in the part tree graph refers to a subd-graph of the part tree graph. For example, one part may be one rectangular region in the rectangular tree graph.

In some embodiments, one part in the part tree graph may correspond to a superior node of the data to be probed. The superior node may be displayed as a part (e.g., a rectangle) in the part tree graph. In some embodiments, a plurality of subordinate nodes that satisfy a preset condition may be aggregated into a superior node that corresponds to a larger categorization result. That is, the superior node corresponds to a concatenation of categorization results of a plurality of subordinate nodes. In some embodiments, the preset condition may be that a proportion of the subordinate nodes corresponding to the data to be probed is less than a preset proportion. In some embodiments, the preset condition may be related to a part concentration level, where a smaller part concentration level indicates a larger count of subordinate nodes that need to be aggregated into a superior node. More description regarding the part concentration level may be found below.

In some embodiments, a subordinate node may represent a categorization result of the data to be probed in the first sub-region. For example, assuming that the data to be probed in a certain first sub-region may be categorized into categorization results 1-20, the categorization results 1-20 may correspond to subordinate nodes 1-20. In some embodiments, the processor may categorize the data to be probed in a first sub-region into a plurality of categorization results corresponding to a plurality of subordinate nodes based on a preset rule.

In some embodiments, other subordinate nodes that do not satisfy the preset condition may be directly recognized as superior nodes to be displayed in the part tree graph. For example, the processor may determine a categorization result that represents a proportion of data to be probed is greater than the preset proportion in all categorization results, and directly determine a subordinate node corresponding to the categorization result as the superior node without aggregation.

The part concentration level refers to a degree of concentration of parts in the part tree graph. The part concentration level may be determined based on a size of a display region of the part tree graph; and the smaller the display region, the less the part concentration level.

For example, the data to be probed may be categorized into 10 categories from A1 to A10, and the 10 categories correspond to 10 subordinate nodes. The processor may aggregate a portion of the categories with a smaller proportion (e.g., subordinate nodes A5-A10) into a single superior node A5′, and each superior node may correspond to a part in the part tree graph. That is, there are a total of 5 nodes including the subordinate nodes A1-A4 and the superior node A5′, the 5 nodes correspond to 5 parts in the part tree graph, and the part concentration level is 5. If the display region of the part tree graph is larger, which means that more parts may be displayed, the part concentration level may be larger. The processor may appropriately reduce the count of subordinate nodes (i.e., categories) that are aggregated into the superior node. For example, if the subordinate nodes A6-A10 are aggregated into a single superior node A6′, that is, there are a total of 6 superior nodes including A1-A5 and A6′, correspondingly, 6 parts in the part tree graph may be displayed, and the part concentration level may be 6.

In some embodiments, the processor may determine the part concentration level of the part tree graph based on user historical probing data, user current probing operation, the data to be probed, and size of the display region via a concentration level prediction model.

In some embodiments, the concentration level prediction model may be a machine learning model, e.g., a recurrent neural network model.

The user historical probing data may be data related to user probing over a historical time. For example, the user historical probing data may include probing data for the user interface in user history operations and operation data for the part tree graph.

The user current probing operation refers to a probing operation of the user at a current moment, e.g., selecting or hovering over the probe graph or the data to be probed. More information regarding the data to be probed may be found in FIG. 16, FIG. 17, and related description thereof.

The size of the display region may be a size of the display region of the probe graph corresponding to a certain first sub-region.

In some embodiments, the concentration level prediction model may include a behavioral embedding layer, a data embedding layer, and a concentration level determination layer.

In some embodiments, an input of the behavioral embedding layer may include the user current probing operation; and an output of the behavioral embedding layer may include behavioral features.

In some embodiments, an input of the data embedding layer may include the data to be probed; and an output of the data embedding layer may include data features. In some embodiments, the concentration prediction model and the graph recommendation level model may use the same data embedding layer.

In some embodiments, an input of the concentration level determination layer may include user historical probing data, the behavioral features, the data features, and the size of the display region; and an output of the concentration determination layer may include the part concentration level.

The concentration level prediction model may be obtained through joint training of the behavioral embedding layer, the data embedding layer, and the concentration level determination layer based on a plurality of third training samples with a third label. Each of the third training samples may include sample user historical probing data at a first historical time, sample user current probing operation at a second historical time, and data to be probed and a size of a display region corresponding to the second historical time. The first historical time is earlier than the second historical time. The third label may be a part concentration level in the part tree graph at the second historical time. The third training samples and the third label may be obtained based on historical data.

The process of joint training may be similar to the training of the graph recommendation model, which may refer to related descriptions described in FIG. 28.

In some embodiments of the present disclosure, the concentration level prediction model may be set with different layers to handle different types of inputs, respectively, which can improve data processing efficiency.

In some embodiments of the present disclosure, based on the user historical probing data, the user current probing operation, and the data to be probed, target parts displayed in the part tree graph may be determined through the concentration level prediction model, which can utilize self-learning capabilities of machine learning to improve the efficiency and accuracy of determining the target parts, make the part tree graph more consistent with the actual needs of the user, and help to improve the user experience.

In some embodiments, the processor may determine the part concentration level based on other manners. For example, the processor may perform a statistical analysis on user historical probing operation to determine the part concentration level.

In some embodiments, when the count of categorization results of the data to be probed is less than or equal to a preset value, and the probe graph includes a pie graph, in response to not receiving the second operation instruction, the pie graph and/or the part tree graph may default to displaying a data analysis result of data to be probed with a largest proportion. For example, as shown in FIG. 19, the categorization with the largest proportion in the pie graph is the Shanghai Stock Exchange (SSE), and in response to not receiving an operation instruction, the processor in a default state may display a text content, a count, and a proportion corresponding to SSE below the pie graph.

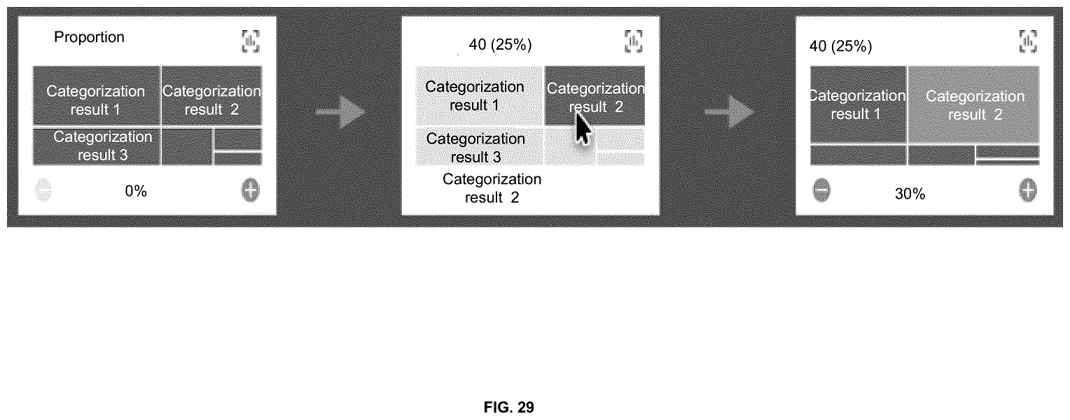

FIG. 29 is a schematic diagram illustrating an exemplary part tree graph according to some embodiments of the present disclosure. For example, as shown in FIG. 29, assuming that a categorization result 1 accounts for the largest proportion in a part tree graph, then in the default state without hovering, a lower portion of the part tree graph may display the text content of the categorization result 1, an upper left portion may display an amount and a proportion of data to be analyzed corresponding to the categorization result 1. When the mouse hovers over a part, the text content of a categorization result (e.g., a categorization result 2) corresponding to the part may be displayed in the lower portion of the part tree graph, and an amount and a proportion of data to be probed in the categorization result is displayed in the upper left portion. The hovering part (e.g., the categorization result 2) is highlighted, and other parts (e.g., thr categorization result 1, a categorization result 3, etc.) are highlighted. When the processor receives a click operation of the user on a part (e.g., the categorization result 2), the part (i.e., the categorization result 2) may be fixed in a selected state, the part (i.e., the categorization result 2) may be highlighted, and data to be probed corresponding to the categorization result 2 in the first region may be highlighted.

In some embodiments of the present disclosure, the data analysis result of the data to be probed with the largest proportion in the pie graph and/or the part tree graph may be displayed by default when the second operation instruction is not received, so that the user can, without any operation, quickly understand the relevant information of the data to be probed with the largest proportion, which is convenient for the user to analyze the data.

The seventh operation instruction refers to an operation instruction regarding an interaction. In some embodiments, the seventh operation instruction may include an instruction related to an interaction with the part tree graph. For example, the user may generate the seventh operation instruction corresponding to an operation, e.g., panning, zooming, or the like, of the part tree graph.

In some embodiments, the processor may change the acreage and the count of parts of the part tree graph based on the seventh operation instruction. For example, the processor may translate the parts displayed in the part tree graph left and right based on the seventh operation instruction generated based on a panning operation to view other parts not shown. As another example, the processor may enlarge or reduce the part tree graph based on the seventh operation instruction generated by a zoom operation, and when the part tree graph is enlarged, the acreage of the part tree graph may increases and the count of displayed parts may decrease.

In some embodiments, the part tree graph may display parts corresponding to categories with a higher proportion, and the user may view the other parts in the part tree graph by panning the part tree graph left and right. In some embodiments, the user may also zoom out the part tree graph to display more parts to find the part that the user wants to view.

In some embodiments, the part tree graph may include a search box, and in response to receiving a search instruction in the search box from the user, the processor may directly locate a searched target part for displaying in the part tree graph. The search box may be displayed in the part tree graph with a specific search icon.

By setting the search box, the user can search for the target part and perform clicking, hovering, etc., on the target part directly without having to find the target part by zooming, panning left and right, etc.

In some embodiments, the processor may change the identification display of the part.

The identification display may be used to characterize the display state of the part, e.g., a display color.

In some embodiments, in response to receiving an operation instruction from the user to operate the part, the processor may change the identification display of the part. For example, the processor may update the display color of the part from one to another or update the part to be highlighted.

In some embodiments of the present disclosure, by changing the identification display of the part, the user can determine the display state of the part tree graph as needed, which helps the user to analyze the part tree graph.

In some embodiments, the part tree graph may include a change control, and the processor may generate the seventh operation instruction by controlling the change control; and change the acreage and the count of parts of the part tree graph based on the seventh operation instruction.

The change control refers to a control used to adjust a display ratio of the part tree graph. For example, the change control may include a scaling control. The change control may include a ratio display function. In some embodiments, when the processor changes the acreage and the count of parts of the part tree graph based on the change control, the change ratio of the part tree graph may be synchronously displayed, e.g., a scaling ratio.

In some embodiments, the processor may recognize a user operation on the change control (e.g., dragging the control to the left to zoom out by 30%, dragging the control to the right to enlarge by 30%, etc.), and change the part tree graph to a display region and display ratio corresponding to the action.

For example, as shown in FIG. 29, the processor may recognize a click operation of the user on a part (e.g., the categorization result 2) and update the part (i.e., the categorization result 2) to be highlighted. The processor may change the acreage (e.g., enlarge by 30%) of the part tree graph and the count of parts displayed based on the seventh operation instruction (e.g., dragging the change control to the right to enlarge the part by 30%) generated by the user through controlling the change control.

In some embodiments of the present disclosure, by controlling the change control to change the acreage and the count of parts of the part tree graph, the user can adjust the part tree graph more easily.

In some embodiments of the present disclosure, by changing the acreage and the count of parts of the part tree graph through the seventh operation instruction, the user can customize the appearance and content of the probe graph as needed, which improves the user experience.

FIG. 30 is a schematic illustration illustrating an exemplary process for displaying mark information of an outlier according to some embodiments of the present disclosure.

In some embodiments, the processor may determine whether data in a first sub-region includes an outlier; and in response to a determination that the data in the first sub-region includes the outlier, display mark information of the outlier on a probe sub-graph on a side of a numerical distribution graph.

The outlier refers to an extreme value in the data to be probed. For example, the outlier may be a value significantly different from the rest of the data or having a large numerical difference.

In some embodiments, the processor may determine the outlier based on a preset rule.

An exemplary preset rule may include determining data to be probed less than Q1−(Q3−Q1)*1.5 or greater than Q3+(Q3−Q1)*1.5 as the outlier. Q1 refers to a smaller quartile of the data to be probed and Q3 refers to a larger quartile of the data to be probed. The larger quartile refers to a value located at approximately 25% in a order of the data to be probed from large to small, and the smaller quartile refers to a value located at approximately 75% in the order of the data to be probed from large to small.

In some embodiments, the preset rule may be modified and edited by the user as desired. For example, the user may modify and edit the preset rule in the interface, and the processor may recognize the modified and edited rule to determine the outlier. In some embodiments, the processor may predict the preset rule in advance based on operating habits of the user and a type of data to be probed.

Understandably, the default preset rule may not be applicable to all the data to be probed or may not be able to satisfy data probing requirements of various users, and by personalizing the design of the preset rule by the user, the flexibility of the judgment of the outlier and the user experience can be improved.

In some embodiments of the present disclosure, determining the outlier by the preset rule can quickly and accurately determine the outlier in the data to be probed, so as to facilitate reminding the user to carry out data cleaning and other operations on the outlier.

The mark information refers to mark information used to alert the outlier. For example, as shown in FIG. 30, the mark information of the outlier may be a different fill pattern (e.g., slash fill) than the other probe sub-graphs.

In some embodiments, the processor may display the mark information of the outlier on the probe sub-graph on the side of the numerical distribution graph. For example, continuing to FIG. 30, the processor may display the mark information of the outlier on left and right strips of the numerical distribution graph, and the probe sub-graphs on the side of the numerical distribution graph may display distribution information related to the outlier.

In some embodiments of the present disclosure, by displaying the mark information of the outlier on the probe sub-graph on the side of the numerical distribution graph, a function of visually identifying and probing the outlier in the data is provided, which helps the user to find out the anomalies in the data and take appropriate measures.

In some embodiments, the numerical distribution graph may include an auxiliary marking line, and the processor may identify an operation mode of the second operation instruction, and in response to a determination that the operation mode of the second operation instruction is a hover mode, and an operation position of the second operation instruction is matched with a position of the auxiliary marking line, display a reference result.

The auxiliary marking line refers to a marking line used to characterize the reference result in the data analysis result of the data to be probed. The auxiliary marking line may be dashed or other line types.

The reference result may be a relevant data analysis result, e.g., an average value, a median value, etc., which is preset by the system or human as reference.

The matching between the operation position of the second operation instruction and the position of the auxiliary marking line may include a matching between a mouse hover position and a preset range of the auxiliary marking line. For example, the mouse hover position may be located on the auxiliary marking line. In some embodiments, the auxiliary marking line has a higher hover priority than two sides of the auxiliary marking line. That is, if the mouse docs not hover exactly over the auxiliary marking line, for example, the mouse is slightly off the auxiliary marking line and overlaps with the probe sub-graphs on the two sides, the processor may determine that the mouse hovers over the auxiliary marker line rather than the probe sub-graphs on the two sides. By setting the hover priority, the sensitivity of hovering over the auxiliary marking line can be ensured and the user experience can be improved.

In some embodiments, when the hover position is matched with the position of the auxiliary marking line, the processor may display the reference result corresponding to the auxiliary marking line at the preset position of the probe graph.

FIG. 31 is a schematic diagram illustrating an exemplary process for displaying a reference result according to some embodiments of the present disclosure. In some embodiments, referring to FIG. 31, when the operation position of the second operation instruction matches the position of an auxiliary marking line 3110, the processor may display the reference result of 30.02 (e.g., the average value of the data to be probed in the numerical distribution graph) corresponding to the auxiliary marking line 3110 at a preset position (e.g., a lower portion) of the probe graph.

In some embodiments of the present disclosure, by setting the auxiliary marking line and displaying the reference result when the mouse hovers over the auxiliary marking line, it can be convenient for the user to quickly understand the relevant situation of special data in the probe graph, which is convenient for the user to perform data analysis.

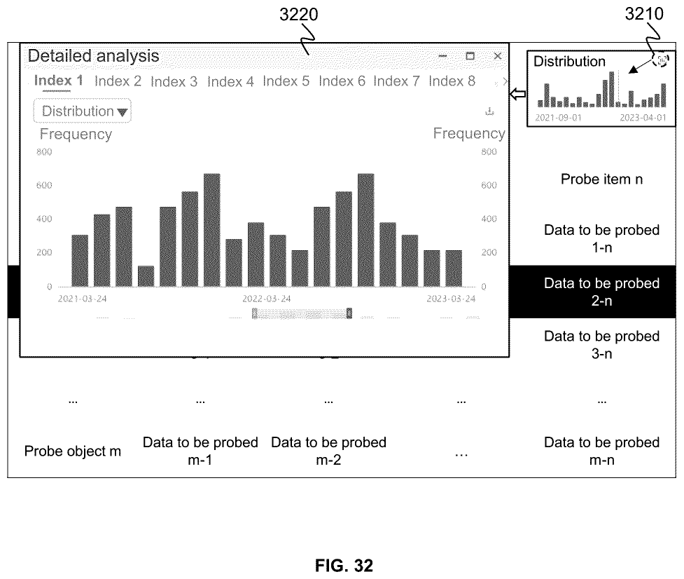

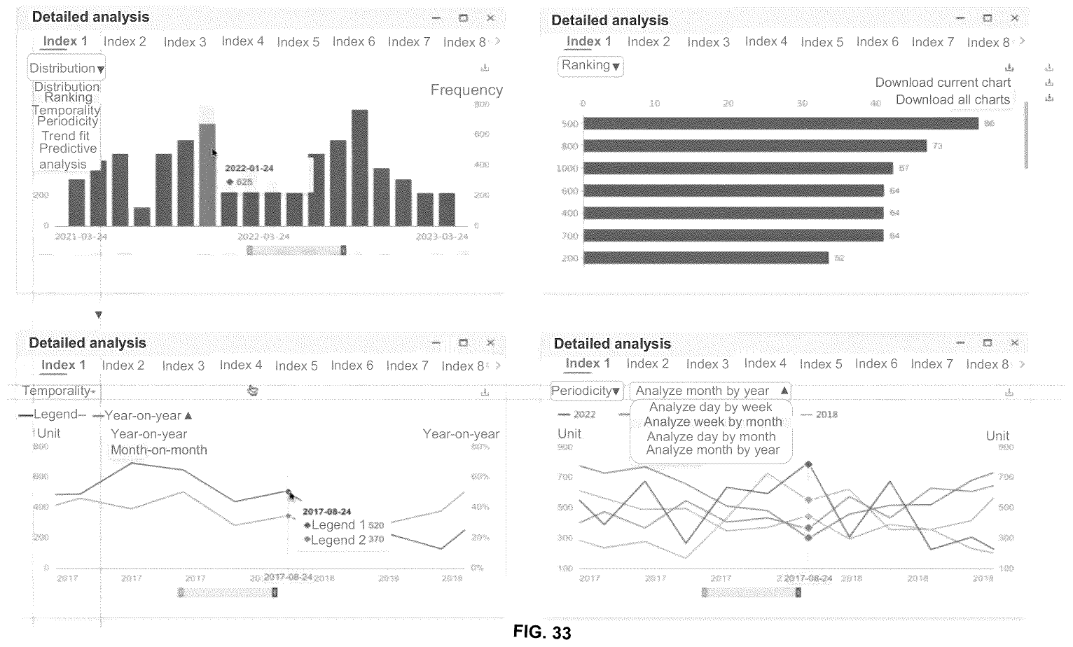

FIG. 32 is a schematic diagram illustrating an exemplary preset icon according to some embodiments of the present disclosure. FIG. 33 is a schematic diagram illustrating an exemplary analysis pop-up window according to some embodiments of the present disclosure.

In some embodiments, a second region may include a preset icon and/or an analysis pop-up window. In some embodiments, in response to receiving the second operation instruction for the preset icon, the processor may enlarge and display a probe graph corresponding to the preset icon. In some embodiments, in response to receiving the second operation instruction for the probe graph, the processor may display the analysis pop-up window.

The preset icon refers to a preset icon used to enlarge the probe graph.

For example, as shown in FIG. 32, each probe graph may have a corresponding preset icon 3210, and in response to receiving a second operation instruction (e.g., clicking, hovering, etc.) for the preset icon 3210, the processor may enlarge and display a probe graph 3220 corresponding to the preset icon 3210.

The analysis pop-up window refers to a pop-up window that may be used to display a detailed analysis of the probe graph. For example, the analysis pop-up window may display more dimensions of analysis data related to the probe graph. For example, as shown in FIG. 33, the analysis pop-up window may include analysis data in dimensions such as a distribution, a ranking, temporality, periodicity, or the like, corresponding to an index 1; and the analysis pop-up window may also include analysis data in a plurality of dimensions corresponding to indexes 2, 3, etc.

In some embodiments, the processor may display the analysis pop-up window in the user interface based on the second operation instruction for the probe graph (e.g., clicking an expand button of the analysis pop-up window). For example, as shown in FIG. 33, after expanding the analysis pop-up window, the analysis pop-up window may include probe graphs of different graph modes with different dimensions generated based on the data to be probed in the first sub-region.

In some embodiments, in response to receiving a single operation on an enlarged probe graph or a double-click operation on a probe graph, the processor may display the analysis pop-up window.

When receiving an operation of clicking to enlarge the probe graph or double-clicking a probe graph in a default reduced state in the second region, the processor may display the analysis pop-up window in the user interface.

In some embodiments of the present disclosure, by receiving the single operation on the enlarged probe graph or the double-click operation on the probe graph, the user can open the analysis pop-up window to view detailed analysis results in a variety of ways, which is convenient for the user.

In some embodiments, the analysis pop-up window may include a data snapshot saved by the user, and in response to recognizing an operation on expanding the analysis pop-up window and the operation of viewing the data snapshot of the user, the processor may display probe graphs corresponding to data to be probed in different time periods and the display state of the data to be probed in the analysis pop-up window, so as to facilitate the user to compare differences. The data snapshot may include a data state saved by the user at a specific moment, or a data state saved by the system by default. In some embodiments, the system may provide a function for the user to manage the data snapshots, so that the user may conveniently manage the data snapshots that have been created, e.g., viewing, restoring, deleting, or the like, and may also be able to export the data state in the data snapshots to different file formats.

In some embodiments of the present disclosure, by enlarging the display of the probe graph corresponding to the preset icon and displaying the analysis pop-up window, the user can further probe and analyze the data by interactively operating on the preset icon and the enlarged probe graph, and the analysis pop-up window provides additional functionality and information, the user can view the data probing result of the probe graph in different graph modes with different dimensions according to preferences, which enhances the user's ability to understand and interpret the data.

FIG. 34 is an exemplary block diagram illustrating a system for visual data analysis and interaction according to some embodiments of the present disclosure.

In some embodiments, the system 3400 for visual data analysis and interaction may include a first display module 3410, a generation module 3420, a processing module 3430, and a second display module 3440.

In some embodiments, the first display module 3410 may be configured to display displaying a visualization region in a user interface. The visualization region may include a set of data.

In some embodiments, the first display module 3410 may also be configured to display a first region; and display at least one probe graph corresponding to one of the probe items in the second region.

In some embodiments, the generation module 3420 may be configured to generate a data graph based on the set of data.

In some embodiments, in response to receiving a third operation instruction from a user, the generation module 3420 may further be configured to determine a data mapping graph in a first state based on a distribution result of data in each of the one or more target regions; display the data mapping graph in the first state in a hot zone of each of the one or more target regions; and in response to receiving a fourth operation instruction from the user, update the data mapping graph in the first state to the data mapping graph in a second state.

In some embodiments, the generation module 3420 may also be configured to update the data mapping graph based on a distribution result of the first target data in the data.

In some embodiments, in response to receiving a fifth operation instruction, the generation module 3420 may also be configured to jump a first page currently displayed on the user interface to a second page; and display the data mapping graph in a hot zone in the second page.

In some embodiments, in response to receiving a first operation instruction from the user, the processing module 3430 may be configured to obtain a data processing result by processing at least a portion of the set of data based on the data graph.

In some embodiments, in response to receiving a second operation instruction from the user, the second display module 3440 may be configured to display the data processing result and update a display state of the visualization region.

In some embodiments, the second display module 3440 may also be configured to display the data analysis result in an identified region corresponding to each of the one or more target regions.

In some embodiments, the second display module 3440 may also be configured to identify an operation position of the fourth operation instruction. In response to a determination that the operation position is located in the hot zone, the second display module 3440 may also be configured to determine second target data corresponding to the fourth operation instruction based on a positional matching relationship between the operation position and a mapping object in the data mapping graph; and display the data analysis result of the second target data in the identified region based on the second target data.

In some embodiments, the second display module 3440 may also be configured to adjust a display of mapping statistic points in the data mapping graph based on a user requirement; or determine a type of the mapping statistic point displayed in the data mapping graph based on at least one of a user business scenario or a display rule.

In some embodiments, the second display module 3440 may also be configured to determine a distribution concentration level of the data based on a position relationship of the mapping markers corresponding to the median value and the average value in the data mapping graph.

In some embodiments, in response to a determination that the data includes the null value, the second display module 3440 may also be configured to highlight a mapping marker corresponding to the null value.

In some embodiments, the second display module 3440 may also be configured to identify the operation position of the fourth operation instruction. In response to a determination that the operation position is matched with a position of a target mapping data point in a target textual mapping graph among the one or more textual mapping graphs, the second display module 3440 may also be configured to display intersection data corresponding to the target mapping data point in a textual mapping graph other than the target textual mapping graph among the one or more textual mapping graphs.

In some embodiments, the second display module 3440 may also be configured to identify an operation mode of the fourth operation instruction. In response to a determination that the operation position of the fourth operation instruction is located in one of a plurality of mapping intervals and the operation mode is a hover mode, the second display module 3440 may also be configured to display an expansion panel on the user interface. In response to a determination that the operation position of the fourth operation instruction is located on a piece of data, among the data in each of the one or more target regions or the set of data, located within the expansion panel, the second display module 3440 may also be configured to display a data page where the piece of data is located and a data strip corresponding to the piece of data on the user interface.

In some embodiments, the second display module 3440 may further be configured to determine whether a count of a plurality of pieces of data among the data in each of the one or more target regions or the set of data is less than a threshold. In response to a determination that the count of the plurality of pieces of the data is less than the threshold, the second display module 3440 may further be configured to determine that the hot zone includes a plurality of sub-hot zones, the plurality of sub-hot zones dispersed in the target region in an area where the plurality of pieces of the data are located. In response to a determination that the count of the plurality of pieces of the data is greater than the threshold, the second display module 3440 may further be configured to determine that the hot zone is centrally located in the target region.

In some embodiments, in response to a determination that the operation position is located in the fixation region, the second display module 3440 may also be configured to switch a target data strip from a first display state to a second display state on the user interface; and display a target data analysis result of one of the plurality of pieces of the first target data corresponding to each of the target regions in an identified region corresponding to the each of the target regions.

In some embodiments, in response to a determination that the operation position is located in at least one of the target regions and outside of the hot zone, the second display module 3440 may further be configured to switch a target data block from the first display state to the second display state, the target data block corresponding to a region where at least one piece of the plurality of first target data outside of the hot zone is located and in the at least one of the target regions; and display a target data analysis result of at least one piece of the plurality of the first target data in an identification region corresponding to the at least one of the target regions.

In some embodiments, in response to receiving the fourth operation instruction from the user, the second display module 3440 may also be configured to adapt a display range of each of the target regions and/or a second target region; and/or predict the display range of each of the target regions and/or the second target region based on user historical operation data and current operation data.

In some embodiments, the second display module 3440 may also be configured to receive the second operation instruction for one of the first region and the second region from the user; display a data probing result of the second operation instruction; and update a display state of another of the second region and the first region.

In some embodiments, the second display module 3440 may also be configured to determine a probing target corresponding to the second operation instruction; and update and display, based on a third display state, at least one probe sub-graph corresponding to the second operation instruction and/or a first sub-region corresponding to the probing target in the first region.

In some embodiments, the second display module 3440 may also be configured to identify an operation mode of the second operation instruction. In response to receiving a sixth operation instruction, the second display module 3440 may also be configured to determine whether to update the third display state based on the operation mode of the second operation instruction.

In some embodiments, if the operation mode of the second operation instruction is a hover mode, the second display module 3440 may also be configured to update the third display state to a fourth display state in response to receiving the sixth operation instruction. In some embodiments, if the operation mode of the second operation instruction is a selection mode, the second display module 3440 may also be configured to maintain a display state of the at least one probe sub-graph and the first region corresponding to the second operation instruction unchanged in response to receiving the sixth operation instruction.

In some embodiments, in response to a determination that the operation mode of the second operation instruction is the selection mode and the second operation instruction corresponds to a plurality of probe sub-graphs, the second display module 3440 may also be configured to display the second region and the first region based on a reference display mode.

In some embodiments, in response to receiving a seventh operation instruction, the second display module 3440 may also be configured to change an acreage and a count of parts of the part tree graph.

In some embodiments, the second display module 3440 may also be configured to generate the seventh operation instruction by controlling a change control; and change the acreage and the count of parts of the part tree graph based on the seventh operation instruction.

In some embodiments, the second display module 3440 may also be configured to determine whether the data in the first sub-regions includes an outlier. In response to a determination that the data in the first sub-regions includes the outlier, the second display module 3440 may also be configured to display mark information of the outlier on a probe sub-graph on a side of the numerical distribution graph.

In some embodiments, the second display module 3440 may also be configured to identify the operation mode of the second operation instruction. In response to a determination that the operation mode of the second operation instruction is a hover mode, and an operation position of the second operation instruction is matched with a position of the auxiliary marking line, the second display module 3440 may also be configured to display the reference result.

In some embodiments, the second display module 3440 may also be configured to display a range control strip of the one or more probe graphs in the second region. In response to receiving an eighth operation instruction for the range control strip, the second display module 3440 may also be configured to dynamically update a display state of the one or more probe graphs and/or the first region.

In some embodiments, in response to receiving the second operation instruction for a preset icon, the second display module 3440 may also be configured to display a probe graph in the one or more graphs corresponding to the preset icon. In some embodiments, in response to receiving the second operation instruction for the probe graph, the second display module 3440 may also be configured to display an analysis pop-up window.

In some embodiments, the second display module 3440 may also be configured to control a display mode of the at least one probe graph in the second region through a preset control marker.

In some embodiments, the second display module 3440 may also be configured to display a first portion of a preset count of probe sub-graphs in the second region. In response to receiving a display switching instruction from the user, the second display module 3440 may also be configured to update and display a second portion of the preset count of probe sub-graphs in the second region.

In some embodiments, in response to receiving a ninth operation instruction from the user, the second display module 3440 may also be configured to trigger a hide control to adjust a display state of the data in the first region; and/or trigger a move control to adjust a display order of the first region and the second region.

In some embodiments, in response to receiving a tenth operation instruction from the user, the second display module 3440 may also be configured to trigger a memory control; and identify a target history operation corresponding to the tenth operation instruction, switching the display state of the first region and the second region to a target display state corresponding to the target history operation.

For more descriptions regarding the above modules may be found in FIGS. 2-33 and related descriptions thereof.

It should be understood that the system 3400 for visual data analysis and interaction and modules thereof may be implemented using a variety of approaches. It should be noted that the above descriptions of the system for visual data analysis and interaction and the modules thereof may be provided only for descriptive convenience, and do not limit the present disclosure to the scope of the embodiments cited. It may be to be understood that for those skilled in the art, after understanding the principle of the system, it may be possible to arbitrarily combine individual modules or form a subsystem to connect with other modules without departing from this principle. In some embodiments, the first display module 3410, the generation module 3420, the processing module 3430, and the second display module 3440 disclosed in FIG. 34 may be different modules in a single system, or it may be a single module that implements the functions of two or more of the modules described above. For example, the modules may share a common storage module, and the modules may each have their own storage module. Such deformations are within the scope of protection of the present disclosure.

One or more embodiments of the present disclosure further provide a system for visual data analysis and interaction. The system may include a storage device storing a set of instructions; and at least one processor configured to communicate with the storage device. When executing the set of instructions, the at least one processor may be configured to: display a visualization region in a user interface, the visualization region including a set of data; generate a data graph based on the set of data; in response to receiving a first operation instruction from a user, obtain a data processing result by processing at least a portion of the set of data based on the data graph; and in response to receiving a second operation instruction from the user, display the data processing result and updating a display state of the visualization region. More description regarding the system for visual data analysis and interaction may be found in FIGS. 1-34 and related descriptions thereof.

One or more embodiments of the present disclosure further provide a non-transitory computer-readable storage medium storing computer instructions. When reading the computer instructions in the storage medium, a computer may be configured to: display a visualization region in a user interface, the visualization region including a set of data; generate a data graph based on the set of data; in response to receiving a first operation instruction from a user, obtain a data processing result by processing at least a portion of the set of data based on the data graph; and in response to receiving a second operation instruction from the user, display the data processing result and updating a display state of the visualization region. Further description of the system for visual data analysis and interaction may be found in FIGS. 1-34 and related descriptions thereof.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A method for visual data analysis and interaction, comprising:
displaying a visualization region in a user interface, the visualization region including a set of data;
generating a data graph based on the set of data;
in response to receiving a first operation instruction from a user, obtaining a data processing result by processing at least a portion of the set of data based on the data graph; and
in response to receiving a second operation instruction from the user, displaying the data processing result and updating a display state of the visualization region.

2. The method of claim 1, wherein the visualization region includes one or more target regions, the data graph includes at least one data mapping graph, and the data processing result includes a data analysis result;
the generating a data graph based on the set of data includes:
in response to receiving a third operation instruction from the user,
determining the data mapping graph in a first state based on a distribution result of data in each of the one or more target regions; and
displaying the data mapping graph in the first state in a hot zone of each of the one or more target regions;
in response to receiving a fourth operation instruction from the user, updating the data mapping graph in the first state to the data mapping graph in a second state; and
the displaying the data processing result includes:
displaying the data analysis result in an identified region corresponding to each of the one or more target regions.

3. The method of claim 2, further comprising:
updating the data mapping graph in the first state to the data mapping graph in the second state based on a distribution result of first target data in the data; wherein the first target data is determined based on an analytical requirement of the user for the data.

4. The method of claim 2, wherein each of the one or more target regions includes a plurality of target sub-regions distributed in a plurality of data pages, the data mapping graph reflecting a distribution result of data in the plurality of target sub-regions, and the method further comprises:
in response to receiving a fifth operation instruction, jumping a first page displayed on the user interface to a second page; and
displaying the data mapping graph in a hot zone in the second page, wherein a display state of the data mapping graph in the first page is the same as a display state of the data mapping graph in the second page, and a position of the hot zone in the second page is matched with a position of the hot zone in the first page.

5. The method of claim 2, further comprising:
identifying an operation position of the fourth operation instruction;
in response to a determination that the operation position is located in the hot zone, determining second target data corresponding to the fourth operation instruction based on a positional matching relationship between the operation position and a mapping object in the data mapping graph; and
displaying the data analysis result of the second target data in the identified region based on the second target data.

6. The method of claim 5, wherein the mapping object includes at least one of a mapping marker point or one or more mapping intervals; and the mapping marker point includes at least one of a mapping statistic point or a mapping data point.

7. The method of claim 6, wherein the mapping statistic point includes at least one of an anomaly mapping marker, a null mapping marker, or mapping markers corresponding to a maximum value, a minimum value, an upper quartile, a lower quartile, a median value, and an average value.

8. The method of claim 7, further comprising:
adjusting a display of the mapping statistic point in the data mapping graph based on a user requirement; or
determining a type of the mapping statistic point displayed in the data mapping graph based on at least one of a user business scenario or a display rule.

9. The method of claim 7, wherein the data mapping graph includes one or more mapping segments, a length of each of the mapping segments is determined based on an amount of a portion of the data whose values are between the upper quartile and the lower quartile; a position distribution of the mapping segments on the data mapping graph reflects a distribution concentration level of the data.

10. The method of claim 7, further comprising:
determining a distribution concentration level of the data based on a position relationship of the mapping markers corresponding to the median value and the average value in the data mapping graph.

11. The method of claim 7, wherein the anomaly mapping marker includes at least one of mapping markers corresponding to a biased large outlier and a biased small outlier, at least one of the biased large outlier or the biased small outlier is determined based on a rule type, and the rule type includes at least one of determining the biased large outlier based on a biased large threshold or determining the biased small outlier based on a biased small threshold.

12. The method of claim 7, wherein the null mapping marker is a mapping marker corresponding to a null value, and the method further comprises:
in response to a determination that the data includes the null value, highlighting the mapping marker corresponding to the null value.

13. The method of claim 7, wherein the data mapping graph includes at least one of a numerical mapping graph or one or more textual mapping graphs,
the numerical mapping graph in the first state includes the anomaly mapping marker and the null mapping marker, and the numerical mapping graph in the second state includes the mapping marker point and the mapping intervals, the mapping intervals being displayed by an area display graph; and/or
each of the one or more textual mapping graphs in the first state includes the mapping data point; and each of the one or more textual mapping graphs in the second state includes the mapping data point and a data analysis result of the mapping data point.

14. The method of claim 13, further comprising:
in response to a determination that the operation position is matched with a position of a target mapping data point in a target textual mapping graph among the one or more textual mapping graphs, displaying intersection data corresponding to the target mapping data point in a textual mapping graph other than the target textual mapping graph among the one or more textual mapping graphs; wherein
the target textual mapping graph corresponds to the fourth operation instruction, and the target mapping data point is a mapping data point in the target textual mapping graph corresponding to the fourth operation instruction.

15. The method of claim 6, further comprising:
identifying an operation mode of the fourth operation instruction;
in response to a determination that the operation position of the fourth operation instruction is located in one of a plurality of mapping intervals and the operation mode is a hover mode, displaying an expansion panel on the user interface, the expansion panel including a portion of the data reflected by the mapping interval corresponding to the fourth operation instruction; and
in response to a determination that the operation position of the fourth operation instruction is located on a piece of data, among the data in each of the one or more target regions or the set of data, located within the expansion panel, displaying a data page where the piece of data is located and a data strip corresponding to the piece of data on the user interface.

16. The method of claim 2, further comprising:
determining whether a count of a plurality of pieces of data among the data in each of the one or more target regions or the set of data is less than a threshold;
in response to a determination that the count of the plurality of pieces of the data is less than the threshold, determining that the hot zone includes a plurality of sub-hot zones, the plurality of sub-hot zones dispersed in the target region in an area where the plurality of pieces of the data are located; or
in response to a determination that the count of the plurality of pieces of the data is greater than the threshold, determining that the hot zone is centrally located in the target region.

17. The method of claim 5, wherein the user interface includes a fixation region independent of the target regions at the user interface; and the method further comprises:
in response to a determination that the operation position is located in the fixation region;
switching a target data strip from a first display state to a second display state on the user interface, the target data strip including a plurality of pieces of first target data, the plurality of pieces of first target data being in one-to-one correspondence with the target regions, the target regions where the plurality of pieces of first target data are located and the operation position satisfy a preset condition; and
displaying a target data analysis result of one of the plurality of pieces of the first target data corresponding to each of the target regions in an identified region corresponding to the each of the target regions.

18. The method of claim 17, further comprising:
in response to a determination that the operation position is located in at least one of the target regions and outside of the hot zone,
switching a target data block from the first display state to the second display state, the target data block corresponding to a region where at least one piece of the plurality of first target data outside of the hot zone is located and in the at least one of the target regions; and
displaying a target data analysis result of at least one piece of the plurality of the first target data in an identification region corresponding to the at least one of the target regions.

19. The method of claim 2, further comprising:
in response to receiving the fourth operation instruction from the user, adapting a display range of each of the target regions and/or a second target region; and/or
predicting the display range of each of the target regions and/or the second target region based on user historical operation data and current operation data.

20. The method of claim 1, wherein the data graph includes one or more probe graphs, the visualization region includes a first region and a second region, and displaying the visualization region includes:
displaying the first region, the first region including a plurality of first sub-regions, different first sub-regions displaying different portions of the set of data of a probe object for different probe items; and
displaying at least one probe graph corresponding to one of the probe items in the second region.

21. The method of claim 20, wherein the data processing result includes a data probing result, and the in response to receiving a second operation instruction from the user, displaying the data processing result and updating a display state of the visualization region includes:
in response to receiving the second operation instruction for one of the first region and the second region from the user;
displaying the data probing result; and
updating a display state of another of the second region and the first region.

22. The method of claim 21, wherein the probe graph includes at least one probe sub-graph, the at least one probe sub-graph corresponding to at least one categorization result of the data; and
the receiving the second operation instruction from the user for one of the first region and the second region, updating a display state of another of the second region and the first region includes:
determining a probing target corresponding to the second operation instruction, the probing target including a target probe object and/or a target categorization result; and
updating and displaying, based on a third display state, at least one probe sub-graph corresponding to the second operation instruction and/or a first sub-region corresponding to the probing target in the first region.

23. The method of claim 22, wherein the updating and displaying, based on a third display state, at least one probe sub-graph corresponding to the second operation instruction and/or a first sub-region corresponding to the probing target in the first region includes:
identifying an operation mode of the second operation instruction; and
in response to receiving a sixth operation instruction, determining whether to update the third display state based on the operation mode of the second operation instruction.

24. The method of claim 23, wherein the in response to receiving a sixth operation instruction, determining whether to update the third display state based on the operation mode of the second operation instruction includes:
if the operation mode of the second operation instruction is a hover mode, updating the third display state to a fourth display state in response to receiving the sixth operation instruction; or
if the operation mode of the second operation instruction is a selection mode, maintaining a display state of the at least one probe sub-graph and the first region corresponding to the second operation instruction unchanged in response to receiving the sixth operation instruction.

25. The method of claim 24, further comprising:
in response to a determination that the operation mode of the second operation instruction is the selection mode and the second operation instruction corresponds to a plurality of probe sub-graphs, displaying the second region and the first region based on a reference display mode; wherein
the reference display mode includes one of an intersection display mode, a concatenation display mode, or a complementary display mode; the reference display mode is determined based on a data relationship and/or a user operation, and the data relationship is a relationship between the data of the different first sub-regions of the first region.

26. The method of claim 21, wherein the one or more probe graphs are generated based on the data, including:
determining a graph mode of each of the one or more probe graphs based on a type and/or a distribution of the data.

27. The method of claim 21, further comprising:
when a count of categorization results of the data is greater than a preset value, the one or more probe graphs including a part tree graph; and
in response to receiving a seventh operation instruction, changing an acreage and a count of parts of the part tree graph.

28. The method of claim 27, wherein the part tree graph includes a change control, and the in response to receiving a seventh operation instruction, changing an acreage and a count of parts of the part tree graph includes:
generating the seventh operation instruction by controlling the change control; and
changing the acreage and the count of parts of the part tree graph based on the seventh operation instruction.

29. The method of claim 21, wherein the one or more probe graphs include a numerical distribution graph, and the method further comprises:
determining whether the data in the first sub-regions includes an outlier;
in response to a determination that the data in the first sub-regions includes the outlier, displaying mark information of the outlier on a probe sub-graph on a side of the numerical distribution graph.

30. The method of claim 29, wherein the numerical distribution graph includes an auxiliary marking line, the auxiliary marking line characterizing a reference result of a data analysis result of the data; the receiving the second operation instruction from the user for one of the first region and the second region, displaying the data probing result includes:
identifying an operation mode of the second operation instruction; and
in response to a determination that the operation mode of the second operation instruction is a hover mode, and an operation position of the second operation instruction is matched with a position of the auxiliary marking line, displaying the reference result.

31. The method of claim 21, further comprising:
displaying a range control strip of the one or more probe graphs in the second region; and
in response to receiving an eighth operation instruction for the range control strip, dynamically updating a display state of the one or more probe graphs and/or the first region.

32. The method of claim 21, wherein the second region includes a preset icon and an analysis pop-up window, and the method further comprises:
in response to receiving the second operation instruction for the preset icon, enlarging and displaying a probe graph in the one or more graphs corresponding to the preset icon; and
in response to receiving the second operation instruction for the probe graph, displaying the analysis pop-up window.

33. The method of claim 21, further comprising:
controlling a display mode of the at least one probe graph in the second region through a preset control marker.

34. The method of claim 20, wherein the probe graph includes a plurality of probe sub-graphs corresponding to categorization results of the data; the displaying at least one probe graph corresponding to each of the probe items in the second region includes:
displaying a first portion of a preset count of probe sub-graphs in the second region; and
in response to receiving a display switching instruction from the user, updating and displaying a second portion of the preset count of probe sub-graphs in the second region.

35. The method of claim 21, wherein the second region includes a hide control and a move control; the receiving the second operation instruction from the user for one of the first region and the second region; displaying the data probing result; and updating a display state of another of the second region and the first region includes:
in response to receiving a ninth operation instruction from the user,
triggering the hide control to adjust a display state of the data in the first region; and/or
triggering the move control to adjust a display order of the first region and the second region.

36. The method of claim 21, wherein the second region includes a memory control, the memory control integrates history operations and history display states of a user at different times, the history display states include a display state of the first region and the second region corresponding to the history operations; and the method further comprises:
in response to receiving a tenth operation instruction from the user, triggering the memory control; and
identifying a target history operation corresponding to the tenth operation instruction, switching the display state of the first region and the second region to a target display state corresponding to the target history operation.

37. A system for visual data analysis and interaction, comprising:
a storage device storing a set of instructions; and
at least one processor configured to communicate with the storage device, wherein when executing the set of instructions, the at least one processor is configured to:
display a visualization region in a user interface, the visualization region including a set of data;
generate a data graph based on the set of data;
in response to receiving a first operation instruction from a user, obtain a data processing result by processing at least a portion of the set of data based on the data graph; and
in response to receiving a second operation instruction from the user, display the data processing result and updating a display state of the visualization region.

38. A non-transitory computer-readable storage medium storing computer instructions, wherein when reading the computer instructions in the storage medium, a computer is configured to:
display a visualization region in a user interface, the visualization region including a set of data;
generate a data graph based on the set of data;
in response to receiving a first operation instruction from a user, obtain a data processing result by processing at least a portion of the set of data based on the data graph; and
in response to receiving a second operation instruction from the user, display the data processing result and updating a display state of the visualization region.
